(19) United States
(12) Patent Application Publication
(10) Pub. No.: US 2026/0357010 A1
(43) Pub. Date: Nov. 12, 2026

(54) SULFONE CONTAINING DIAMMONIUM-DICARBOXYLATE SUPRAMOLECULAR SALTS AND METHODS OF USE THEREOF

(71) Applicants: ARIZONA BOARD OF REGENTS ON BEHALF OF ARIZONA STATE UNIVERSITY, Scottsdale, AZ (US); VIRGINIA POLYTECHNIC INSTITUTE AND STATE UNIVERSITY, Blacksburg, VA (US)

(72) Inventors: Cody Wayne Weyhrich, Phoenix, AZ (US); Timothy Long, Phoenix, AZ (US); Christopher Bryant Williams, Blacksburg, VA (US); John William Will, Christiansburg, VA (US)

(21) Appl. No.: 19/104,806

(22) PCT Filed: Aug. 21, 2023
(86) PCT No.: PCT/US2023/030732

§ 371 Date: Feb. 19, 2025

Related U.S. Application Data
(60) Provisional application No. 63/399,459, filed on Aug. 19, 2022.

(51) Int. Cl. C08G 73/02; C08K 5/20; C08K 5/3415; C08K 5/41; C08K 5/5397

(52) U.S. Cl. CPC C08G 73/026; C08K 5/20; C08K 5/3415; C08K 5/41; C08K 5/5397

(57) ABSTRACT

The invention encompasses polysalt compositions, methods of use, and materials thereof.

This application claims priority from U.S. Provisional Application No. 63/399,459 filed on Aug. 19, 2022, the entire contents of which are incorporated herein by reference.

### GOVERNMENT INTERESTS

This invention was made with government support under DE-NA0002839 awarded by the Department of Energy. The government has certain rights in the invention.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF THE INVENTION

The present invention relates to polysalt compositions, methods of use, and materials thereof.

### BACKGROUND OF THE INVENTION

Fully aromatic polyimides exhibit some of the most impressive thermomechanical properties of any polymeric materials available. However, their rigid structure and high intermolecular interactions make processing difficult and limit these materials primarily to 2D form factors, such as films and tapes.

### SUMMARY OF THE INVENTION

Aspects of the invention are drawn towards a polysalt comprising a dicarboxylic acid neutralized with an aromatic diamine according to Formula I

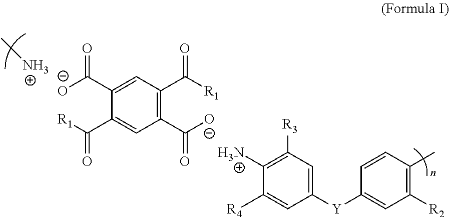

wherein, Y is an electron withdrawing group; R₁ is an acrylate, a methacrylate, —O-alkenyl, —S-alkyl, S-alkenyl, —S-alkynyl, or —O-alkynyl; R₂ is selected from the group consisting of H, F₃C,

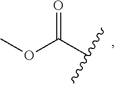 [SMILES: *C(=O)OC]

Br, F, and Cl; R₃ is selected from the group consisting of H, F₃C,

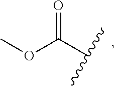 [SMILES: *C(=O)OC]

Br, F, and Cl; and R₄ is selected from the group consisting of H, F₃C,

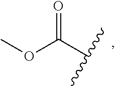 [SMILES: *C(=O)OC]

Br, F, and Cl. In embodiments, Y is SO₂, PHO, a phosphine oxide, a ketone, C(CX₃)₂, CX₂, or a nitro group, wherein X is Cl, F, or Br. In embodiments, R₁ is

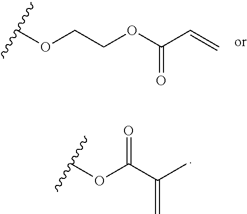

In embodiments, the dicarboxylic acid is

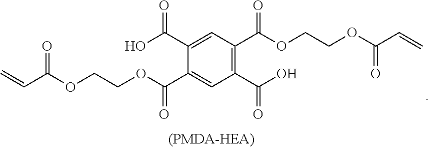 [SMILES: C=CC(=O)OCCOC(=O)c1cc(C(=O)O)c(C(=O)OCCOC(=O)C=C)cc1C(=O)O]

In embodiments, the aromatic diamine is

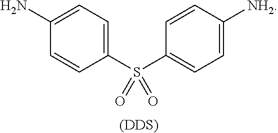

In embodiments, the polysalt is

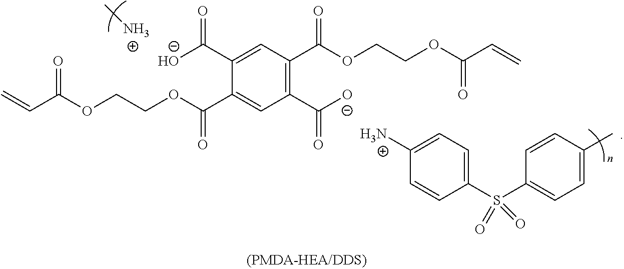

In embodiments, the polysalt described herein does not undergo an acrylate-amine step-growth polymerization.

Aspects of the invention are drawn towards a mixed polysalt comprising a dicarboxylic acid and a dicarboxylic acid-dialkyl ester neutralized with an aromatic diamine according to Formula II,

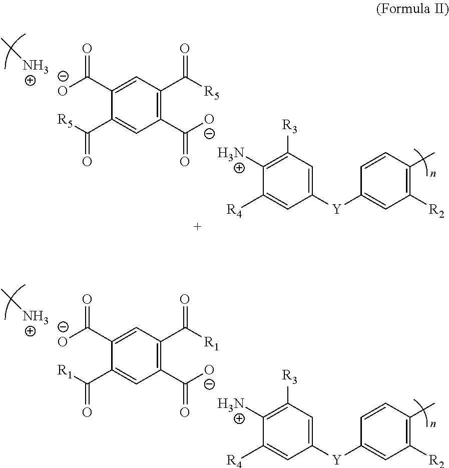

wherein, Y is an electron withdrawing group; R₁ is an acrylate, a methacrylate, —O-alkenyl, —S-alkyl, S-alkenyl, —S-alkynyl, or —O-alkynyl; R₂ is selected from the group consisting of H, F₃C,

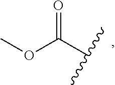 [SMILES: *C(=O)OC]

Br, F, and Cl; R₃ is selected from the group consisting of H, F₃C,

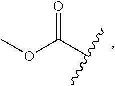 [SMILES: *C(=O)OC]

Br, F, and Cl; R₄ is selected from the group consisting of H, F₃C,

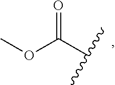 [SMILES: *C(=O)OC]

Br, F, and Cl; and R₅ is an alkyl ester, a thioalkyl, or non-photoreactive functional group. In embodiments, Y is SO₂, O, a ketone, a phosphine oxide, C(CX₃)₂, CX₂, or a nitro group, wherein X is Cl, F, or Br. In embodiments, R₁ is

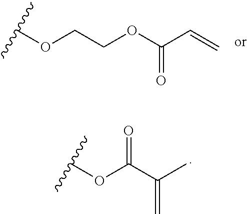

In embodiments, the alkyl ester is selected from the group consisting of a methyl ester, an ethyl ester, a propyl ester, or an isopropyl ester. In embodiments, the dicarboxylic acid-dialkyl ester is

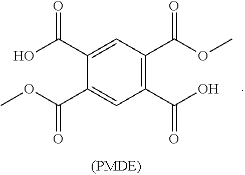

In embodiments, the dicarboxylic acid is

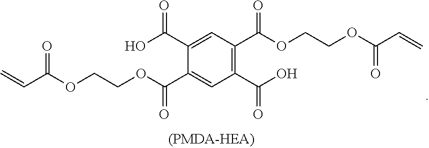 [SMILES: C=CC(=O)OCCOC(=O)c1cc(C(=O)O)c(C(=O)OCCOC(=O)C=C)cc1C(=O)O]

In embodiments, aromatic diamine is

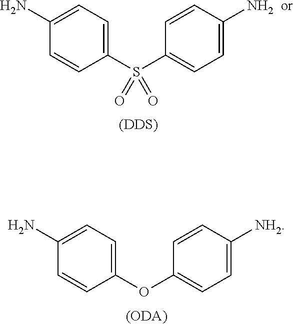

In embodiments, the mixed polysalt is

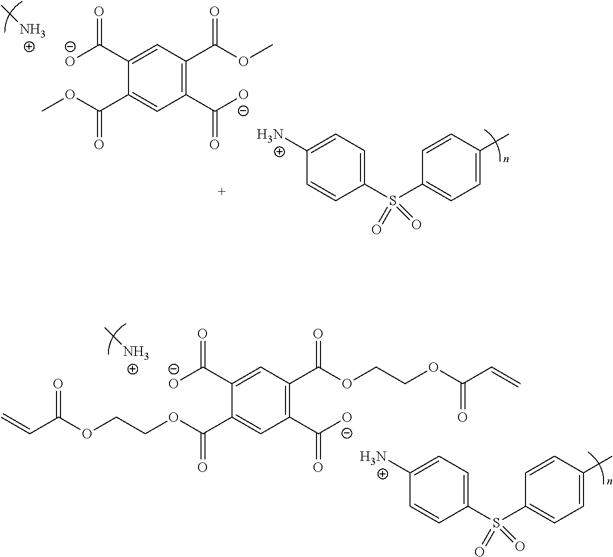

(XX % PMDA-HEA/DDS, wherein XX % comprises about 1%, about 5%, about 10%, about 20%, about 30%, about 40%, about 50%, about 60%, about 70%, about 80%, about 90%, about 95%, or about 99%).

In embodiments, the mixed polysalt is about 20% PMDA-HEA/DDS, about 30% PMDA-HEA/DDS, about 40% PMDA-HEA/DDS, about 50% PMDA-HEA/DDS, about 60% PMDA-HEA/DDS, about 70% PMDA-HEA/DDS, or about 80% PMDA-HEA/DDS. In embodiments, the mixed polysalt is

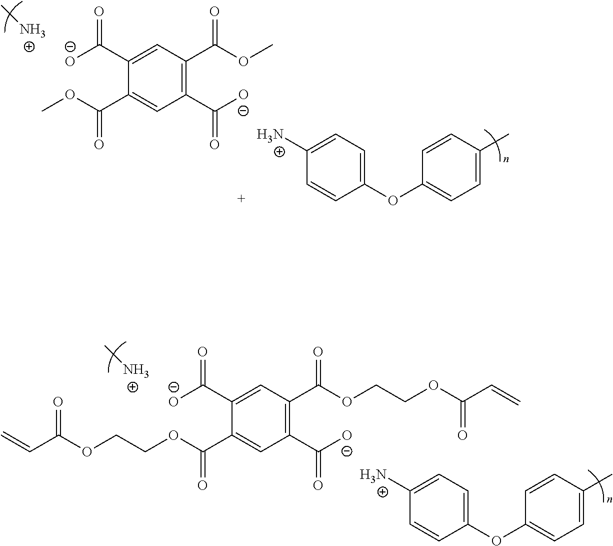

(XX % PMDA-HEA/ODA, wherein XX % comprises 1%, about 5%, about 10%, about 20%, about 30%, about 40%, about 50%, about 60%, about 70%, about 80%, about 90%, about 95%, or about 99%).

In embodiments, the mixed polysalt is about 20% PMDA-HEA/ODA, about 30% PMDA-HEA/ODA, about 50% PMDA-HEA/ODA, about 60% PMDA-HEA/ODA, about 70% PMDA-HEA/ODA, or about 80% PMDA-HEA/ODA. In embodiments, the mixed polysalt does not undergo an acrylate-amine step-growth polymerization.

Aspects of the invention are drawn towards a copolysalt comprising a dicarboxylic acid and at least two aromatic diamines, wherein the first aromatic diamine comprises an electron withdrawing group para to the amine and the second diamine comprises an electron donating group para to the amine according to Formula III,

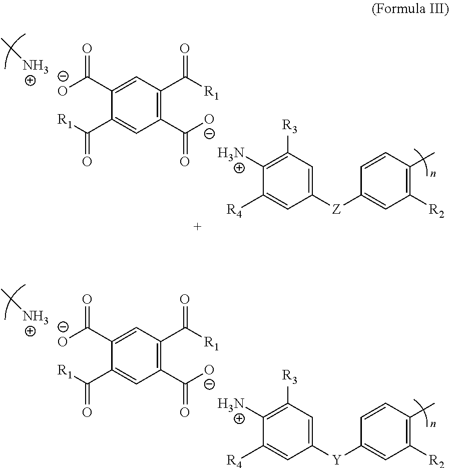

wherein, Y is an electron withdrawing group; Z is an electron donating group; R₁ is an acrylate, a methacrylate, —O-alkenyl, —S-alkyl, S-alkenyl, —S-alkynyl, or —O-alkynyl; R₂ is selected from the group consisting of H, F₃C,

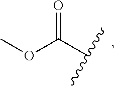 [SMILES: *C(=O)OC]

Br, F, and Cl; R₃ is selected from the group consisting of H, F₃C,

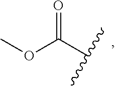 [SMILES: *C(=O)OC]

Br, F, and Cl; and R₄ is selected from the group consisting of H, F₃C,

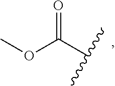 [SMILES: *C(=O)OC]

Br, F, and Cl. In embodiments, R₁ is

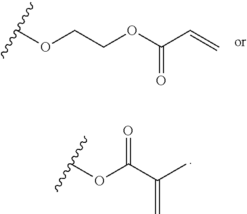

In embodiments, the electron withdrawing group is SO₂ or a phosphine oxide. In embodiments, the electron donating group is O. In embodiments, the dicarboxylic acid is

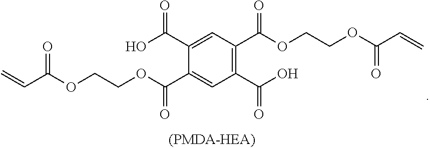 [SMILES: C=CC(=O)OCCOC(=O)c1cc(C(=O)O)c(C(=O)OCCOC(=O)C=C)cc1C(=O)O]

In embodiments, the aromatic diamine comprising an electron withdrawing group para to the amine is

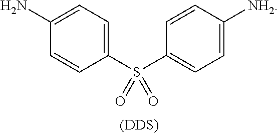

In embodiments, the aromatic diamine comprising an electron donating group para to the amine is

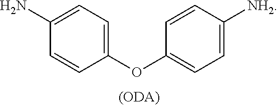

In embodiments, the copolysalt is

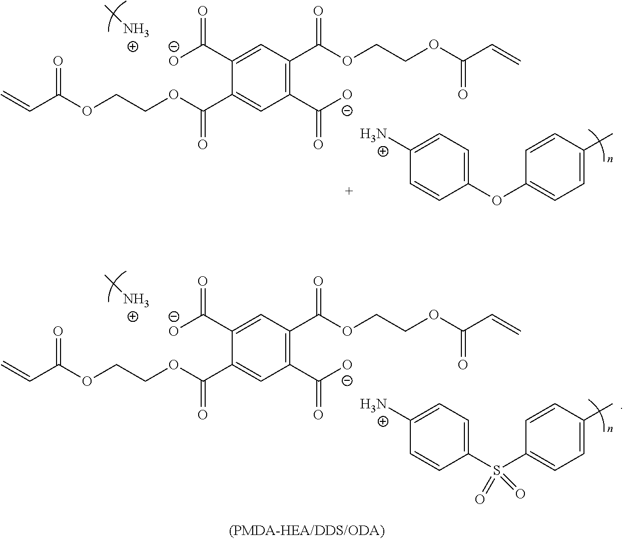

In embodiments, the copolysalt is PMDA-HEA/50DDS/50ODA.

Aspects of the invention are drawn towards a polymer resin comprising: a polysalt, a mixed polysalt, or a copolysalt described herein; a photoinitiator; and a solvent. In embodiments, the photoinitiator comprises a radical photoinitiator. In embodiments, the radical photoinitiator comprises 2, 4, 6-trimethylbenzoyldiphenyl phosphine oxide (TPO) or phenylbis(2,4,6-trimethylbenzyol)-phosphine oxide (BAPO). In embodiments, the polysalt, the mixed polysalt, or the copolysalt is present in an amount of about 10 weight % to about 80 weight %. In embodiments, the polysalt, the mixed polysalt, or the copolysalt is present in an amount of about 30 weight % to about 50 weight %. In embodiments, the photoinitiator is present in an amount from about 0.5% to about 5% by weight based upon the total weight of the polymer resin. In embodiments, the photoinitiator is present in an amount of about 2 weight % to about 2.5 weight % based upon a total weight of the polymer resin.

The polymer resin of claim 29, wherein the solvent comprises a polar aprotic solvent.

The polymer resin of claim 36, wherein the polar aprotic solvent comprises dimethyl sulfoxide, dimethylformamide, dimethylacetamide, N-methyl-2-pyrrolidone, or a combination thereof. In embodiments, the polymer resin undergoes vat polymerization. In embodiments, the polysalt is

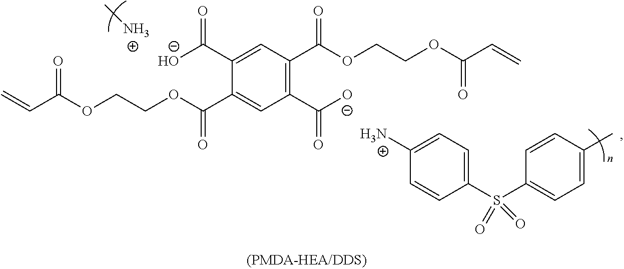

and wherein the polymer resin achieves a plateau storage modulus over about G′=1×10⁶ Pa at about 21 °C for at at least 120 hours. In embodiments, the mixed polysalt is

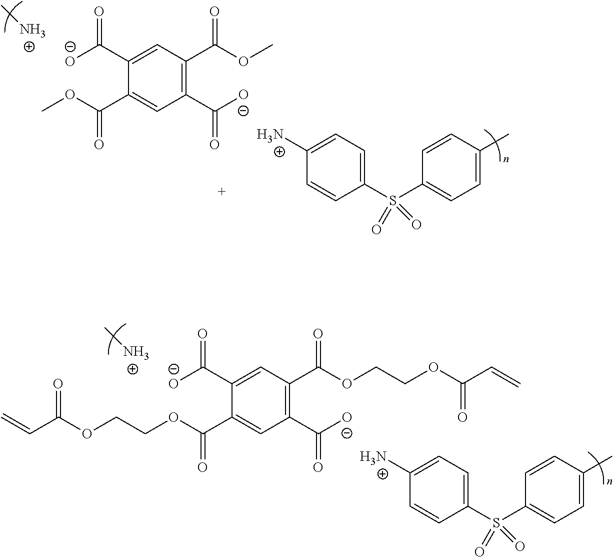

(XX % PMDA-HEA/DDS, wherein XX % is about 10%, about 20%, about 30% about 40%, about 50%, about 60%, about 70%, about 80%, about 90%, or about 99%); or

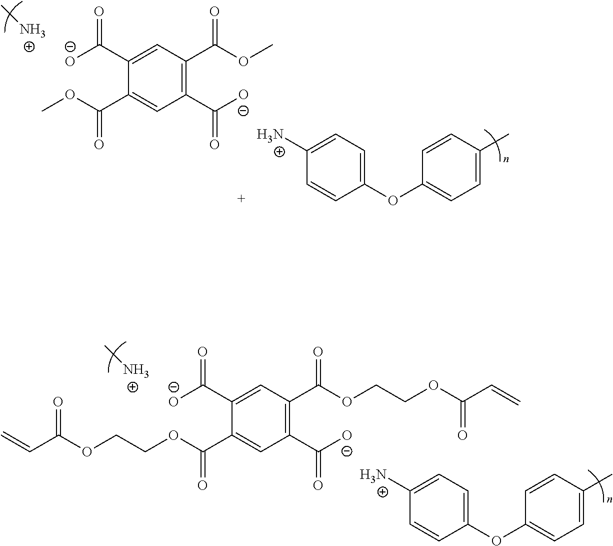

(XX % PMDA-HEA/ODA, wherein XX % is about 10%, about 20%, about 30% about 40%, about 50%, about 60%, about 70%, about 80%, about 90%, or about 99%).
In embodiments, the copolysalt comprises

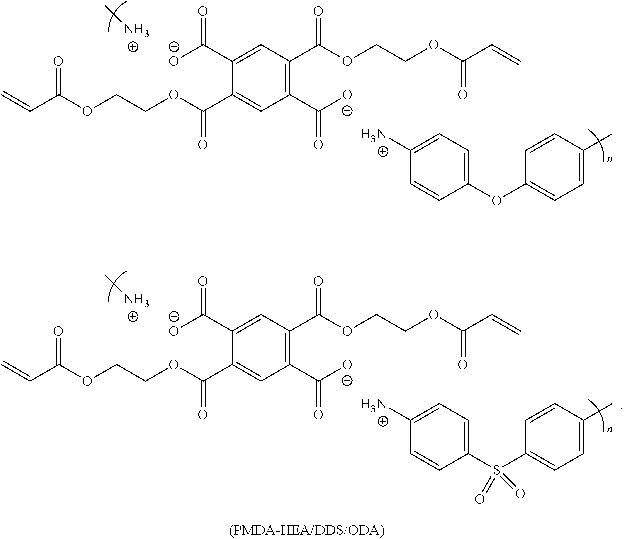

In embodiments, the copolysalt is PMDA-HEA/50DDS/50ODA. In embodiments, the resin described herein comprises about 60 wt. % solids and maintains a solution viscosity of <10 Pa·s.

Aspects of the invention are drawn towards a method of tuning polysalt polymer resin properties, the method comprising: decreasing a diacrylate ester-dicarboxylic acid concentration to increase thermomechanical performance, increase cure time, and decrease high plateau G′, wherein the decreasing acrylate concentration comprises increasing a concentration of dialkylester-dicarboxylic acid; and/or adjusting a ratio of electron withdrawing aromatic diamines to electron donating aromatic diamines to about 1:1, wherein the adjusting comprises: increasing the concentration of an electron withdrawing aromatic diamine if the concentration of an electron donating aromatic diamine is greater than the initial concentration of the electron withdrawing aromatic diamine; or increasing the concentration of an electron donating aromatic diamine if the concentration of an electron withdrawing aromatic diamine is greater than the initial concentration of the electron donating aromatic diamine.

Aspects of the invention are drawn towards a method of manufacturing a fully aromatic polyimide material, the method comprising: mixing a polymer resin described herein; printing the polymer resin to produce a polymer material; and subjecting the polymer material to post-processing to produce a fully aromatic polyimide material. In embodiments, method further comprises producing a working curve prior to printing the polymer resin. In embodiments, the subjecting the polymer material to post-processing comprises rinsing the polymer material with a solvent; drying the polymer material; and subjecting the polymer material to imidization. In embodiments, the solvent comprises a polar aprotic solvent. In embodiments, the drying comprises subjecting the polymer material to 25-80 °C, reduced atmospheric pressure, or combination thereof. In embodiments, subjecting the polymer material to imidization comprises heating the polymer material from about 25 °C to about 250 °C at about 0.1 °C to about 1 °C/min and performing an isothermal hold at 250 °C for about 1 hour to about 8 hours. In embodiments, the post-processing further comprises pyrolyzing the polyimide material, wherein the pyrolyzing comprises heating the polyimide material to about 400 °C at about 0.1 °C to about 1 °C/min under inert atmosphere; and performing an isothermal hold at about 400 °C for about 1 hour to about 8 hours.

Aspects of the invention are drawn towards a method of manufacturing a fully aromatic polyimide material via vat photopolymerization, the method comprising: dipping a platform into a polymer resin described herein to a specified layer depth; exposing the polymer resin to an effective wavelength and irradiance to cure the resin; repeating the process to generate a 3D part; rinsing the 3D part in a solvent; drying the 3D part; and exposing the dried 3D part to subsequent thermal treatment providing a polyimide part. In embodiments, the drying comprises drying under reduced atmosphere at about 80 °C for about 1 day, about 2 days, or about 3 days; and drying in vacuo with a temperature ramp of about 0.5 °C, wherein the temperature is held for about 4 hours at about 240 °C. In embodiments, the layer is about 25 μm to about 250 μm in thickness. In embodiments, the wavelength comprises about 300 nm to about 500 nm. In embodiments, the wavelength comprises about 365 nm, about 385 nm, or about 405 nm. In embodiments, the irradiance comprises about 5 mW/cm² to about 100 mW/cm². The method of claim 57, wherein the irradiance comprises about 20 mW/cm² for bottom up manufacturing. In embodiments, the irradiance comprises about 38 mW/cm² for top down manufacturing. In embodiments, the solvent comprises a polar aprotic solvent. In embodiments, the polar aprotic solvent comprises dimethyl sulfoxide, N-methyl-2-pyrrolidone, dimethylacetamide, or a combination thereof. In embodiments, the material has a minimum feature size of about 27 μm to about 50 μm.

Aspects of the invention are drawn towards a material manufactured from the method of any one of the methods described herein.

Aspects of the invention are drawn towards a PMDA-DDS film lattice produced by the method of claim 45, wherein the lattice comprises: a density of

$$0.41 \frac{g}{c {m}^{3}} ;$$

a bounding box dimension of 1.59 cm³; an octet truss unit cell topology; a unit cell size of 5.3 mm³; a unit cell array of 3×3×3; a strut diameter of 0.9 mm.

Other objects and advantages of this invention will become readily apparent from the ensuing description.

### BRIEF DESCRIPTION OF THE FIGURES

FIG. 1 shows digital photographs of polysalt solutions. Panel A) 50 wt. % PMDA-HEA/ODA (left) and 50 wt. % PMDA-HEA/DDS (right) aged for 0 days. Panel B) 50 wt. % PMDA-HEA/ODA (left) and 50 wt. % PMDA-HEA/DDS (right) aged for 7 days.

FIG. 2 shows non-limiting, exemplary photorheology data of the 50 wt. % PMDA-HEA/ODA polysalt. Plateau storage modulus (G′) decreases with increasing polysalt age. Aged in solution at room temperature.

FIG. 3 shows non-limiting, exemplary in-situ IR of 50 wt. % PMDA-HEA/ODA polysalt. Amine and acrylate signals decrease as the Aza-Michael addition proceeds.

FIG. 4 shows non-limiting, exemplary photorheology of 30 wt. % PMDA-HEA/ODA polysalt. Plateau storage modulus decreases with increasing polysalt age. Aged in solution at room temperature.

FIG. 5 shows non-limiting, exemplary in-situ IR of 50 wt % PMDA-HEA/ODA and PMDA-HEA/DDS polysalts. Signals corresponding to the DDS polysalt remain constant indicating the absence of the Aza-Michael addition mechanism.

FIG. 6 shows non-limiting, exemplary photorheology of 50 wt. % PMDA-HEA/DDS polysalt. Plateau storage modulus remains constant with increasing polysalt age. Aged in solution at room temperature.

FIG. 7 shows non-limiting, exemplary solution rheology of the ODA polysalt shows and increase in solution viscosity over time. The DDS polysalt maintains a constant viscosity.

FIG. 8 shows non-limiting, exemplary working curves relating UV exposure with the thickness of cured profiles for PMDA-HEA/DDS resin after 0 days (solid black) and after 7 days (dashed black) and PMDA-HEA/ODA resin after 0 days (red).

FIG. 9 shows images of organogels of PMDA-HEA/ODA and PMDA-HEA/DDS the same day as mixed and seven days later.

FIG. 10 shows a digital photograph of a 3D printed part imidized to 400 °C and complimentary SEM micrographs showcasing micron-scale features.

FIG. 11 shows non-limiting, exemplary digital photographs of organogels of Panel A) PMDA-HEA/ODA, Panel B) PMDA-HEA/DDS, and Panel C) a multi-material print with alternating polysalt compositions (rook divided into 5 equal parts vertically).

FIG. 12 shows a representative compressive testing curve showcases the compressive strength of 3D printed polyimide lattices.

FIG. 13 shows representative in situ FTIR spectroscopy of a 50% PMDA-HEA mixed polysalt solution. The solution displayed retention of acrylate and amine functionality as a function of polysalt solution age.

FIG. 14 shows representative photorheology of mixed polysalt solutions across a compositional range. Plateau storage modulus (G′) decreased as the relative mol. %. Aged in solution at room temperature.

FIG. 15 shows representative photo-calorimetry of 50 wt. % mixed polysalt solutions and experimentally determined enthalpy and calculated acrylate conversion values from photo-calorimetry. The solutions displayed acrylate conversation that was dependent on polysalt composition.

FIG. 16 shows representative photorheology and photo-calorimetry of 50 wt. % mixed polysalt solutions. Plateau G′ values increase with acrylate content while conversion remained constant until 100% PMDA-HEA incorporation.

FIG. 17 shows representative merged SAXS/MAXS/WAXS profiles of polyimides of polysalt solutions that were photocured and processed to 400 °C. Scattering profiles were collected at ambient temperature.

FIG. 18 shows representative working curves for fully acrylate functionalized polysalt resin (black) and 50% mixed polysalt resin (red) relating cure depth to the natural log of UV exposure.

FIG. 19 shows digital photographs of printed organogels comprised of PMDA-HEA/DDS mixed polysalt.

FIG. 20 shows digital photographs of Printed 50 wt. %, 50% PMDA-HEA/DDS mixed polysalt organogels dried in ambient conditions. The rectangular sample was rolled and unrolled without damage (Panel A). A printed octet lattice was compressed multiple times and returned to the original shape without permanent deformation (Panel B).

FIG. 21 shows digital photographs of 50% PMDA-HEA/DDS organogel molded to glass tube (Panel A), treated to 100 °C (Panel B), and 200 °C (Panel C).

FIG. 22 shows a non-limiting, representative copolysalt chemical composition.

FIG. 23 shows non-limiting, representative photorheology of 50/50 DDS/ODA copolysalt solutions fresh and aged.

FIG. 24 shows a representative graph of plateau G′ plotted versus polysalt solution age. An exponential fit provides the rate of G′ decline as a function of time. The plateau storage modulus decay rate is concentration dependent for the ODA while the DDS polysalt shows a temporally constant plateau storage modulus.

FIG. 25 shows a representative graph of plateau G′ plotted versus polysalt solution age. An exponential fit provides the rate of G′ decline as a function of time.

FIG. 26 shows a representative graph of polysalt solution exponential decay rate plotted as a function of polysalt solution composition.

FIG. 27 shows non-limiting, exemplary photorheology data (TA DHR-3 Rheometer w/photoaccessory, 20 mm parallel plate, 500 μm gap, 1 Hz, 0.1% strain, 50 wt % in DMSO, 2.5 wt % TPO) for a mixed polysalt described herein.

FIG. 28 shows non-limiting, exemplary data (TA DHR-3 Rheometer w/photoaccessory, 20 mm parallel plate, 500 μm gap, 1 Hz, 0.1% strain, 50 wt % in DMSO, 2.5 wt % TPO) of the effect of PMDA-HEA concentration (Mol %) on Storage Modulus (Pa).

FIG. 29 shows non-limiting, exemplary electron withdrawing diamines of the disclosure.

FIG. 30 shows a non-limiting, exemplary graph of the storage modulus (E′) of poly(amic acid) derived PMDA-DDS control as a function of temperature. The sample retained >1 GPa modulus to 400 °C.

FIG. 31 shows representative 1H NMR spectra for polysalt components, DDS (Panel A) and PMDA-HEA (Panel B), separately and mixed at 1:1 mol ratio in anhydrous DMSO-d₆, yielding the PMDA-HEA/DDS (Panel C) polysalt solution.

FIG. 32 shows representative FITR-ATR measurements. FTIR-ATR measurements enable quantification of relative imidization percentage at increasing imidization temperatures.

FIG. 33 shows representative TGA data. TGA showcases similar thermal stability of PMDA-DDS polyimide derived from the conventional poly(amic acid) approach and the polysalt approach. The lower T_{d,5%} of the polysalt derived PI (440 °C) compared to the conventional approach (494 °C) corresponds to the loss of poly(2-hydroxyethyl acrylate) scaffold.

FIG. 34 shows digital photographs of the representative results of polysalt printing trials. Panel A shows the results of a trial with a 16 sec burn in and 0.5 mm raft with 2 mm supports. Panel B shows the results of trail with a 16 sec burn in and no supports where the parts were printed directly on the build plate. Panel C shows the results of going from a 16 burn in to a 1 second burn in with no supports where the parts were printed directly on the build plate.

FIG. 35 shows digital photographs of the representative results of tuning exposure to 250 msec (Panel A), 350 msec (Panel B), and 250-350 msec (Panel C).

FIG. 36 shows digital photographs of the results of benchtop drying and imidized to 250 °C in N₂ (Panel A) and 60 °C drying in N₂ and imidized to 250 °C in N₂ (Panel B).

FIG. 37 shows a digital photograph of representative results of imidization to 250 °C after drying at 60 °C in N₂.

FIG. 38 shows a digital photograph of PMDA DDS PS parts developing porosity upon imidization to 400 °C.

FIG. 39 shows digital photographs of the degradation of PMDA DDS polysalt resins.

FIG. 40 shows digital photographs of the difference in lack of cracking upon drying in a PMDA DDS 50% mixed polysalt gel as compared to the PMDA DDS polysalt counterpart.

FIG. 41 shows a representative TGA curve of PMDA DDS mixed polysalt degradation.

FIG. 42 shows non-limiting, representative results of cure stress and thermal stability of PMDA DDS polysalt materials.

FIG. 43 shows non-limiting, representative digital photographs of printed half acrylate functionalized and fully acrylate functionalized mixed polysalt.

FIG. 44 shows non-limiting, representative graphs of PMDA DDS mixed polysalt storage modulus (Pa) vs. step time(s) and Crossover Time.

FIG. 45 shows non-limiting exemplary graphs of average plateau modulus (Pa) and Gap (um) vs. step time(s) for PMDA/DDS mixed polysalts and PMDA/ODA mixed polysalts.

FIG. 46 shows non-limiting, representative charts of polysalt and mixed polysalt % composition calculations.

### DETAILED DESCRIPTION OF THE INVENTION

Previous academic works have aimed to provide photocurable polyimide precursors, which would allow for additive manufacturing of 3D polyimide shapes. This invention yields the first temporally stable, polysalt resin for the facile additive manufacturing of polyimide parts. Earlier polysalts exhibited instability thus limiting their utility. The discovery of diamines with appropriate basicity and nucleophilicity resulted unexpected polysalt stability, providing predictive printing and shelf life.

Aspects described herein provide polysalt compositions, methods of use, and materials thereof.

Detailed descriptions of one or more embodiments are provided herein. It is to be understood, however, that the invention can be embodied in various forms. Therefore, specific details disclosed herein are not to be interpreted as limiting, but rather as a basis for the claims and as a representative basis for teaching one skilled in the art to employ the invention in any appropriate manner.

The singular forms “a”, “an” and “the” include plural reference unless the context clearly dictates otherwise. The use of the word “a” or “an” when used in conjunction with the term “comprising” in the claims and/or the specification can mean “one,” but it is also consistent with the meaning of “one or more,” “at least one,” and “one or more than one.”

Wherever any of the phrases “for example,” “such as,” “including” and the like are used herein, the phrase “and without limitation” is understood to follow unless explicitly stated otherwise. Similarly, “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b and c. Wherever the terms “a” or “an” are used, “one or more” is understood, unless such interpretation is nonsensical in context.

As used herein, the term “about” can refer to approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower). In embodiments, the term “about” can be denoted by “~”.

As used herein, the term “substantially the same” or “substantially” can refer to variability typical for a particular method is taken into account.

The terms “sufficient” and “effective”, as used interchangeably herein, can refer to an amount (e.g., mass, volume, dosage, concentration, and/or time period) needed to achieve one or more desired result(s).

Before explaining at least one embodiment of the disclosure in detail, it is to be understood that the disclosure is not necessarily limited in its application to the details set forth in the following description or exemplified by the examples. The disclosure can be used for other embodiments or of being practiced or carried out in various ways. Other compositions, compounds, methods, features, and advantages of the disclosure will be or become apparent to one having ordinary skill in the art upon examination of the following drawings, detailed description, and examples. All such additional compositions, compounds, methods, features, and advantages can be included within this description, and be within the scope of the disclosure.

The term “alkyl” refers to the radical of saturated aliphatic groups, including straight-chain alkyl groups, branched-chain alkyl groups, cycloalkyl (alicyclic) groups, alkyl-substituted cycloalkyl groups, and cycloalkyl-substituted alkyl groups.

In some embodiments, a straight chain or branched chain alkyl has 30 or fewer carbon atoms in its backbone (e.g., C1-C30 for straight chains, C3-C30 for branched chains), 20 or fewer, 12 or fewer, or 7 or fewer. Likewise, in some embodiments cycloalkyls have from 3-10 carbon atoms in their ring structure, e.g., have 5, 6 or 7 carbons in the ring structure. The term “alkyl” (or “lower alkyl”) as used throughout the specification, examples, and claims can include both “unsubstituted alkyls” and “substituted alkyls”, the latter of which refers to alkyl moieties having one or more substituents replacing a hydrogen on one or more carbons of the hydrocarbon backbone. Such substituents include, but are not limited to, halogen, hydroxyl, carbonyl (such as a carboxyl, alkoxycarbonyl, formyl, or an acyl), thiocarbonyl (such as a thioester, a thioacetate, or a thioformate), alkoxyl, phosphoryl, phosphate, phosphonate, a hosphinate, amino, amido, amidine, imine, cyano, nitro, azido, sulfhydryl, alkylthio, sulfate, sulfonate, sulfamoyl, sulfonamido, sulfonyl, heterocyclyl, aralkyl, or an aromatic or heteroaromatic moiety.

Unless the number of carbons is otherwise specified, “lower alkyl” as used herein can refer to an alkyl group, as defined herein, but having from one to ten carbons, or from one to six carbon atoms in its backbone structure. Likewise, “lower alkenyl” and “lower alkynyl” have similar chain lengths. In some embodiments, alkyl groups are lower alkyls. In some embodiments, a substituent described herein as alkyl can be a lower alkyl.

It will be understood by those skilled in the art that the moieties substituted on the hydrocarbon chain can themselves be substituted, if appropriate. For instance, the substituents of a substituted alkyl can include halogen, hydroxy, nitro, thiols, amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF3, —CN and the like. Cycloalkyls can be substituted in the same manner.

The term “heteroalkyl”, as used herein, refers to straight or branched chain, or cyclic carbon-containing radicals, or combinations thereof, containing at least one heteroatom. Suitable heteroatoms include, but are not limited to, O, N, Si, P, Se, B, and S, wherein the phosphorous and sulfur atoms are optionally oxidized, and the nitrogen heteroatom is optionally quaternized. Heteroalkyls can be substituted as defined herein for alkyl groups.

The term “alkylthio” refers to an alkyl group, as defined herein, having a sulfur radical attached thereto. In some embodiments, the “alkylthio” moiety is represented by one of —S-alkyl, —S-alkenyl, and —S-alkynyl. Representative alkylthio groups include methylthio, and ethylthio. The term “alkylthio” also encompasses cycloalkyl groups, alkene and cycloalkene groups, and alkyne groups. “Arylthio” refers to aryl or heteroaryl groups. Alkylthio groups can be substituted as defined herein for alkyl groups.

The terms “alkenyl” and “alkynyl”, refer to unsaturated aliphatic groups analogous in length and possible substitution to the alkyls described herein, but that contain at least one double or triple bond respectively. For example,

The terms “alkoxyl” or “alkoxy” as used herein refers to an alkyl group, as defined herein, having an oxygen radical attached thereto. Representative alkoxyl groups include methoxy, ethoxy, propyloxy, and tert-butoxy. An “ether,” for example, can be two hydrocarbons covalently linked by an oxygen. Accordingly, the substituent of an alkyl that renders that alkyl an ether is or resembles an alkoxyl, such as can be represented by one of —O-alkyl, —O-alkenyl, and —O-alkynyl. Aroxy can be represented by —O-aryl or O-heteroaryl, wherein aryl and heteroaryl are as defined herein. The alkoxy and aroxy groups can be substituted as described herein for alkyl.

The terms “amine” and “amino” are art-recognized and refer to both unsubstituted and substituted amines, e.g., a moiety that can be represented by the general formula:

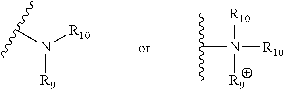

wherein R₉, R₁₀, and R_{10′} each independently represent a hydrogen, an alkyl, an alkenyl, —(CH₂)ₘ—Rs or R₉ and R₁₀ taken together with the N atom to which they are attached complete a heterocycle having from 4 to 8 atoms in the ring structure; Rs represents an aryl, a cycloalkyl, a cycloalkenyl, a heterocycle or a polycycle; and m is zero or an integer in the range of 1 to 8. In some embodiments, only one of R₉ or Rio can be a carbonyl, e.g., R₉, R₁₀ and the nitrogen together do not form an imide. In still other embodiments, the term “amine” does not encompass amides, e.g., wherein one of R₉ and R₁₀ represents a carbonyl. In additional embodiments, R₉ and R₁₀ (and optionally R_{10′}) each independently represent a hydrogen, an alkyl or cycloalkyl, an alkenyl or cycloalkenyl, or alkynyl. Thus, the term “alkylamine” as used herein can refer to an amine group, as defined herein, having a substituted (as described hereinfor alkyl) or unsubstituted alkyl attached thereto, i.e., at least one of R₉ and R₁₀ is an alkyl group.

As used herein, the term “imide” can refer to —C(O) NR′R″, wherein R′ and R″ are each independently hydrogen, or a substituted or unsubstituted alkyl, cycloalkyl, alkenyl, alkynyl, aryl aralkyl, heterocyclyl or heterocyclylalkyl group as defined herein.

As used herein, the term “halogen” can refer to —F, —Cl, —Br or —I; the term “sulfhydryl” can refer to —SH; the term “hydroxyl” can refer to —OH; and the term “sulfonyl” can refer to —SO₂—.

The term “substituted” as used herein, refers to permissible substituents of the compounds described herein. In the broadest sense, the permissible substituents include acyclic and cyclic, branched and unbranched, carbocyclic and heterocyclic, aromatic and nonaromatic substituents of organic compounds. Illustrative substituents include, but are not limited to, halogens, hydroxyl groups, or any other organic groupings containing any number of carbon atoms, for example 1-14 carbon atoms, and optionally include one or more heteroatoms such as oxygen, sulfur, or nitrogen grouping in linear, branched, or cyclic structural formats. Representative substituents include alkyl, substituted alkyl, alkenyl, substituted alkenyl, alkynyl, substituted alkynyl, phenyl, substituted phenyl, aryl, substituted aryl, heteroaryl, substituted heteroaryl, halo, hydroxyl, alkoxy, substituted alkoxy, phenoxy, substituted phenoxy, aroxy, substituted aroxy, alkylthio, substituted alkylthio, phenylthio, substituted phenylthio, arylthio, substituted arylthio, cyano, isocyano, substituted isocyano, carbonyl, substituted carbonyl, carboxyl, substituted carboxyl, amino, substituted amino, amido, substituted amido, sulfonyl, substituted sulfonyl, sulfonic acid, phosphoryl, substituted phosphoryl, phosphonyl, substituted phosphonyl, polyaryl, substituted polyaryl, C3-C20 cyclic, substituted C3-C20 cyclic, heterocyclic, substituted heterocyclic, amino acid, peptide, and polypeptide groups. As used herein in reference to an “R” group, the name used to describe said “R” group can be the chemical name prior to the removal of a hydrogen. For example, wherein “R” is described as an “alkane” can refer to an “alkyl” group.

Heteroatoms such as nitrogen can have hydrogen substituents and/or any permissible substituents of organic compounds described herein which satisfy the valences of the heteroatoms. It is understood that “substitution” or “substituted” includes the implicit proviso that such substitution is in accordance with permitted valence of the substituted atom and the substituent, and that the substitution results in a stable compound, i.e., a compound that does not spontaneously undergo transformation such as by rearrangement, cyclization, elimination, etc.

In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. The heteroatoms such as nitrogen can have hydrogen substituents and/or any permissible substituents of organic compounds described herein which satisfy the valencies of the heteroatoms.

In various aspects, the substituent is selected from alkoxy, aryloxy, alkyl, alkenyl, alkynyl, amide, amino, aryl, arylalkyl, carbamate, carboxy, cyano, cycloalkyl, ester, ether, formyl, halogen, haloalkyl, heteroaryl, heterocyclyl, hydroxyl, ketone, nitro, phosphate, sulfide, sulfinyl, sulfonyl, sulfonic acid, sulfonamide, and thioketone, each of which optionally is substituted with one or more suitable substituents. In some embodiments, the substituent is selected from alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone, wherein each of the alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone can be further substituted with one or more suitable substituents.

Examples of substituents include, but are not limited to, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, thioketone, ester, heterocyclyl, —CN, aryl, aryloxy, perhaloalkoxy, aralkoxy, heteroaryl, heteroaryloxy, heteroarylalkyl, heteroaralkoxy, azido, alkylthio, oxo, acylalkyl, carboxy esters, carboxamido, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, aminocarboxamidoalkyl, cyano, alkoxyalkyl, perhaloalkyl, arylalkyloxyalkyl, and the like. In some embodiments, the substituent is selected from cyano, halogen, hydroxyl, and nitro.

The term “copolymer” as used herein, can refer to a single polymeric material that is comprised of two or more different monomers. The copolymer can be of any form, such as random, block, graft, etc. The copolymers can have any end-group, including capped or acid end groups.

### Polysalts and Polysalt Resins

Aspects of the invention are drawn towards a polysalt comprising repeat units having a structure according to Formula I, Formula II, or Formula III:

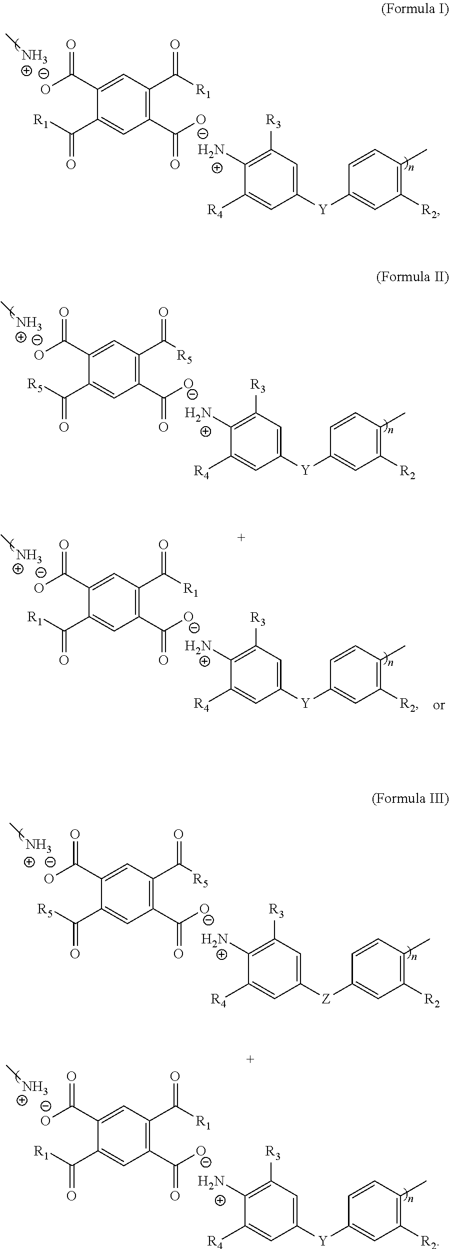

In embodiments, Y can comprise an electron withdrawing group; Z can comprise an electron donating group; R₁ can comprise an acrylate, a methacrylate, —O-alkenyl, —S-alkyl, S-alkenyl, —S-alkynyl, —O-alkynyl, an acrylamide, alkenyl, alkynyl,

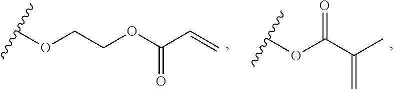

OCH₃, or a combination thereof; R₂ can comprise H, F₃C,

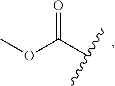 [SMILES: *C(=O)OC]

Br, F, and Cl; R₃ can comprise H, F₃C,

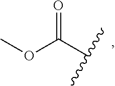 [SMILES: *C(=O)OC]

Br, F, and Cl; R₄ can comprise H, F₃C,

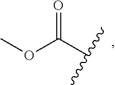 [SMILES: *C(=O)OC]

Br, F, and Cl; and R₅ can comprise an alkyl ester or a non-photochemically reactive functional group. For example, Y is SO₂, a ketone, C(CX₃)₂, CX₂, a phosphine oxide, PHO, or a nitro group, wherein X is Cl, F, or Br. For example, Z can be O. For example, R₁ can form a thioester. For example, R₁ can be a C1-C30 straight chain alkenyl, a C1-C30 branched chain alkenyl, a C1-C30 a straight chain alkynyl, or a C1-C30 branched chain alkynyl. For example, R₁ can be

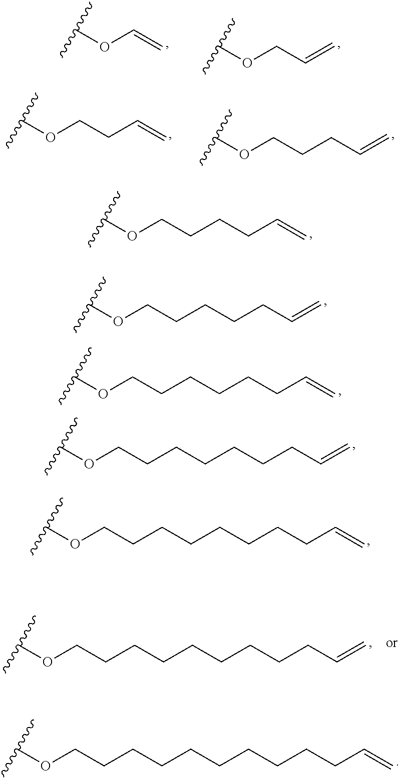

For example, R₁ can be

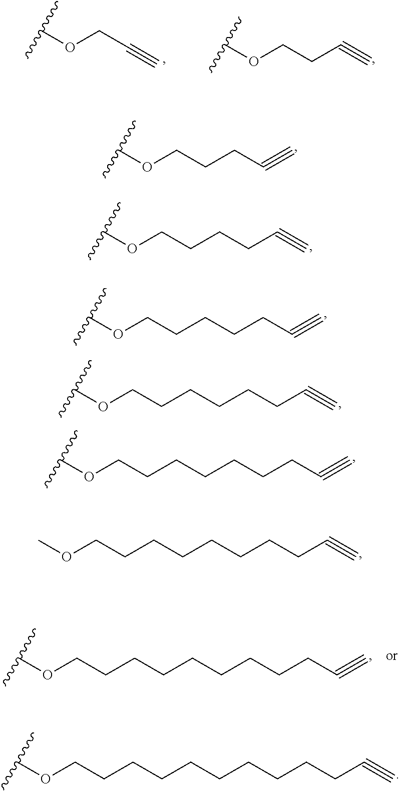

As used herein, the term “polysalt” can refer to a repeating unit wherein the ionic sites are located within the main chain of a macromolecule and wherein at least two dynamic cation-anion pairs form from a supramolecular macromolecular structure. In embodiments, the polysalt can be organized through dynamic interactions to form a macromolecule with a doubly charged repeat unit. For example, the dynamic interaction is a dicarboxylate-diammonium interaction. As used herein, the term “polysalt” and “polymeric salt” can be used interchangeably.

A surprising finding regarding the polysalts and polysalt resins described herein, is that they do not undergo an acrylate-amine step-growth polymerization. As used herein, the term “step-growth polymerization” can refer to a stepwise reaction between bi-functional or multifunctional monomers.

A variety of compositions are provided suitable for additive manufacturing, e.g., stereolithographic printing, resin printing, 3D printing, or vat photopolymerization as the terms are used essentially interchangeably herein. In particular a variety of polymeric resins, e.g., polysalt resins, are provided suitable for the stereolithographic printing of thermoplastics, e.g., aromatic and insoluble thermoplastics with exceptional thermal stability and mechanical properties.

Aspects of the invention are drawn towards a polysalt resin comprising the polysalt of Formula I, a mixed polysalt of Formula II, a copolysalt of Formula III, or a combination thereof. As used herein, the term “polysalt resin” can refer to a photo-reactive resin comprising a polysalt and a photoinitiator. In embodiments, the polymer resin can further comprise a low molecular weight multifunctional molecule. As used herein, terms “polymer resin” and “polysalt resin” can be used interchangeably.

As described herein, the polymer resin can comprise the polysalt of Formula I, the mixed polysalt of Formula II, the copolysalt of Formula III, or a combination there of; a photoinitiator; and a solvent. For example, the photoinitiator comprises any suitable radical photoinitiator. For example, the radical photoinitiator comprises 2, 4, 6-trimethylbenzoyldiphenyl phosphine oxide (TPO) and/or phenylbis(2,4,6-trimethylbenzyol)-phosphine oxide (BAPO).

In embodiments, the polysalt resin can comprise less than about 1 weight %, about 1 weight %, about 5 weight %, about 10 weight %, about 15 weight %, about 20 weight %, about 25 weight %, about 30 weight, about 40 weight %, about 50 weight %, about 60 weight %, about 70 weight %, about 75 weight %, about 80 weight %, about 90 weight %, or greater than about 90 weight % of a polysalt, mixed polysalt, copolysalt, or a combination thereof. For example, the polysalt is present in an amount of about 30 weight %.

In embodiments, the photoinitiator is present in an amount of about 0.1%, about 0.25%, about 0.5%, about 1%, about 1.5%, about 2%, about 2.5%, about 3%, about 3.5%, about 4%, about 4.5%, about 5%, about 7.5%, about 10%, or about 15% by weight based upon the total weight of the polymer resin. For example, photoinitiator is present in an amount of about 2.5 weight % based upon a total weight of the polymer resin.

In embodiments, the solvent of the polymer comprises any polar aprotic solvent. For example, the polar aprotic solvent comprises dimethyl sulfoxide, dimethylformamide, dimethylacetamide, N-methyl-2-pyrrolidone, or any combination thereof.

Aspects of the invention are drawn towards a polymer resin that undergoes vat polymerization. As used herein, the term “vat polymerization” can refer to an additive manufacturing technique wherein 3-dimensional objects are formed by photopolymerization. For example, the polymer resin comprises the polysalt of Formula I, wherein R₁ is

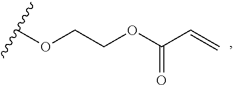 [SMILES: *OCCOC(=O)C=C]

and wherein the polymer resin achieves a plateau storage modulus over about G′=1×10⁶ Pa at about 21 °C for about 12 hours, about 24 hours, about 48 hours, about 96 hours, about 120 hours, about one week, about two weeks, about one month, or greater than one month.

Aspects of the invention are drawn towards a mixed polysalt or a copolysalt. As used herein, the term “copolysalt” can refer to a polysalt that comprises at least one dicarboxylic acid and at least two aromatic diamines. For example, the diamines can comprise ODA and DDS. For example, the copolysalt can comprise PMDA-HEA and at least two different diamines. For example, the polysalt can comprise at least 1 PMDA-derivative and at least 2 aromatic diamines. For example, the PMDA-derivative can comprise PMDA-HEA and PMDE. As used herein, the term “mixed polysalt” can refer to a polysalt that comprises at least two dicarboxylic acids and at least one diamine. For example, the polysalt can comprise at least two different PMDA-derivatives and at least one aromatic diamine. For example, the mixed polysalt can comprise PMDA-HEA, PDMA-MeOH, and a diamine. For example, the diamine can comprise DDS.

In embodiments, the copolysalt is

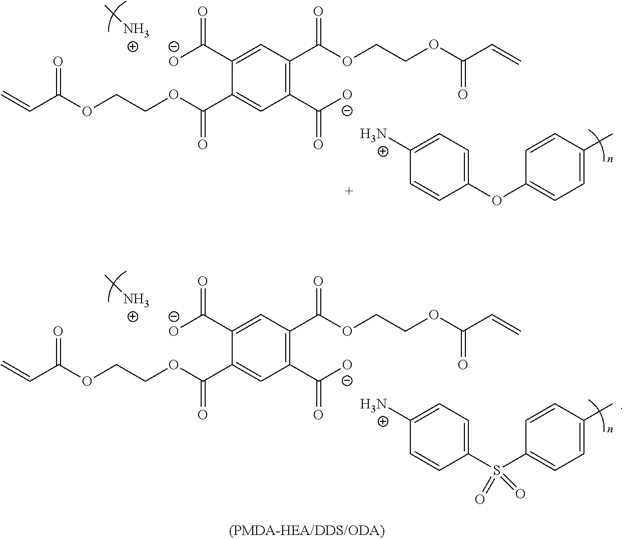

For example, copolysalt is PMDA-HEA/~50DDS/a~50ODA, PMDA-HEA/~40DDS/~60ODA, PMDA-HEA/~30DDS/~700DA, PMDA-HEA/~20DDS/~800DA, PMDA-HEA/~10DDS/~90ODA, PMDA-HEA/~5DDS/~95ODA, PMDA-HEA/~60DDS/~400DA, PMDA-HEA/~70DDS/~300DA, PMDA-HEA/~80DDS/~200DA, PMDA-HEA/~90DDS/~100DA, about PMDA-HEA/~95DDS/~50DA, or any ratio therein.

In embodiments, the mixed polysalt is

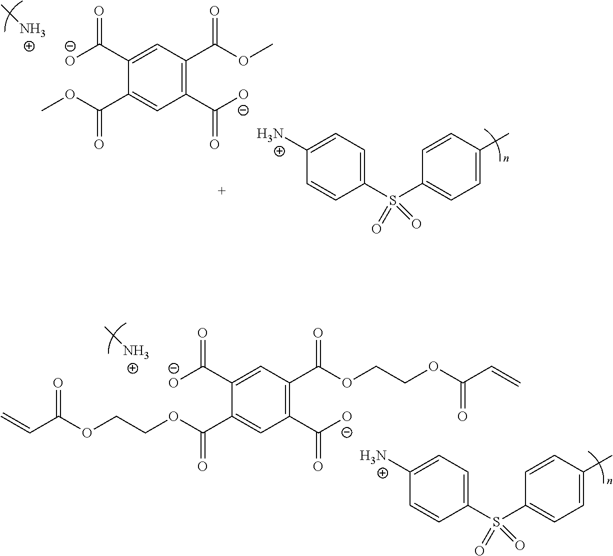

(XX % PMDA-HEA/DDS), wherein XX % can be any number between 0 and 100.

For example, the mixed polysalt can be ~1% PMDA-HEA/DDS, ~5% PMDA-HEA/DDS, ~10% PMDA-HEA/DDS, ~15% PMDA-HEA/DDS, ~20% PMDA-HEA/DDS, ~25% PMDA-HEA/DDS, ~30% PMDA-HEA/DDS, ~35% PMDA-HEA/DDS, ~40% PMDA-HEA/DDS, ~45% PMDA-HEA/DDS, ~50% PMDA-HEA/DDS, ~55% PMDA-HEA/DDS, ~65% PMDA-HEA/DDS, ~70% PMDA-HEA/DDS, ~75% PMDA-HEA/DDS, ~80% PMDA-HEA/DDS, ~85% PMDA-HEA/DDS, ~90% PMDA-HEA/DDS, ~95% PMDA-HEA/DDS, or any ratio therein.

In embodiments, the mixed polysalt is

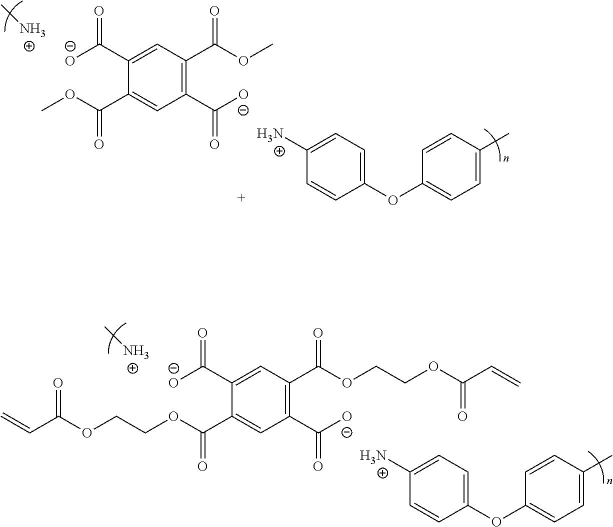

(XX % PMDA-HEA/ODA), wherein XX % can be any number between 0 and 100.

For example, the mixed polysalt can be For example, the mixed polysalt can be ~1% PMDA-HEA/ODA, ~5% PMDA-HEA/ODA, ~10% PMDA-HEA/ODA, ~15% PMDA-HEA/ODA, ~20% PMDA-HEA/ODA, ~25% PMDA-HEA/ODA, ~30% PMDA-HEA/ODA, ~35% PMDA-HEA/ODA, ~40% PMDA-HEA/ODA, ~45% PMDA-HEA/ODA, ~50% PMDA-HEA/ODA, ~55% PMDA-HEA/ODA, ~65% PMDA-HEA/ODA, ~70% PMDA-HEA/ODA, ~75% PMDA-HEA/ODA, ~80% PMDA-HEA/ODA, ~85% PMDA-HEA/ODA, ~90% PMDA-HEA/ODA, ~95% PMDA-HEA/ODA, or any ratio therein.

### Methods of Manufacturing Polysalt, Copolysalt, and Mixed Polysalt Resin Materials

Aspects of the invention are directed towards a method of manufacturing an aromatic polyimide material, the method comprising: mixing a polymer resin described herein, printing the polymer resin to produce a polymer material, and subjecting the polymer material to post-processing to produce a fully aromatic polyimide material.

Aspects of the invention are directed towards methods of manufacturing a material via vat photopolymerization, the method comprising: mixing the polymer resin, printing the polymer resin, and post-processing the resin. Aspects of the invention are directed towards methods of producing a polyimide part, the method comprising: dipping a platform into a polymer resin as described herein to a specified layer depth; exposing the polymer resin to an effective wavelength and IRRADIANCE to cure the resin; repeating the process to generate a 3D part; rinsing the 3D part in a solvent; drying the 3D part; and exposing the dried 3D part to subsequent thermal treatment providing a polyimide part. As used herein, the term “platform” can refer to a substrate that is used as a building platform for 3D printing. As used herein, the terms “intensity” and “irradiance” can be used interchangeably.

In embodiments, printing parameters can comprise: an exposure time: about 0.1 to about 10 seconds (e.g., about 250-about 750 msec depending on acrylate content), irradiance of about 1 mW/cm² to about 40 mW/cm² (e.g., about 20 mW/cm²), burn-in time can comprise about 0.5-to about 50 seconds (e.g., 1-3 sec depending on acrylate content), 1 to 3 burn-in layers (e.g., 1 burn-in layer), a dip/retract distance of about 3 to about 50 mm (e.g., about 3 mm), and a dip/retract speed of about about 0.1 mm/sec to about 10 mm/sec (e.g., about 0.1 mm/sec).

In embodiments, post-processing can comprise rinsing a part with polar aprotic solvent to remove excess uncured resin, drying the part at about 25 °C to about 80° C. (e.g., about 80° C.) under reduced atmosphere for about 1 to about 7 days (e.g., about 3 days), Imidizing the part under vacuum by heating from about 25 to about 250 °C at about 0.1 to about 1 °C/min (e.g., 0.5 °C/min), performing an isothermal hold at about 250 °C for about 1 hour to about 8 hours (e.g., 4 hours), pyrolyzing crosslinker by heating the part in inert atmosphere (e.g., N₂) to up to about 400 °C at about 0.1 °C to about 1 °C/min (e.g., about 0.5 °C/min) and performing an isothermal hold at about 400 °C for about 1 hour to about 8 hours (e.g., 4 hours), or any combination thereof.

In embodiments, the exposure time can comprise about 0.1 to about 10 seconds, the irradiance can comprise about 1 mW/cm² to about 40 mW/cm², the burn-in time can comprise about 0.5 to about 50 seconds, the burn layers can comprise about 1 to about 3, the dip/retract distance can comprise about 3 mm to about 50 mm, and the dip/retract speed can comprise about 0.1 mm/sec to about 10 mm/sec. For example, the exposure time can comprise about 250 msec to about 750 msec, the irradiance can comprise about 20 mW/cm², the number of burn in layers can comprise 1 layer, the dip/retract distance can comprise about 3 mm, and the dip/retract speed can comprise about 0.1 mm/sec.

In embodiments, the exposure time can comprise about 0.1 to about 10 seconds. For example, the exposure time can comprise about 250 msec to about 750 msec depending on acrylate content. In embodiments, exposure time can comprise less than about 75 msec, about 75 msec, about 100 msec, about 150 msec, about 200 msec, about 250 msec, about 300 msec, about 350 msec, about 400 msec, about 450 msec, about 500 msec, about 550 msec, about 600 msec, about 650 msec, about 700 msec, about 750 msec, about 800 msec, about 850 msec, about 900 msec, about 950 msec, about 1 s, about 1.25 s, about 1.5 s, about 1.75 s, about 2 s, about 2.25 s, about 2.5 s, about 2.75 s, about 3 s, about 3.25 s. about 3.5 s, about 3.75 s, about 4 s, about 4.25 s, about 4.5 s, about 4.75 s, about 5 s, about 5.25 s, about 5.5 s, about 5.75 s, about 6 s, about 6.25 s, about 6.5 s, about 6.75 s, about 7 s, about 7.25 s, about 7.5 s, about 7.75 s, about 8 s, about 8.25 s, about 8.5 s, about 8.75 s, about 9 s, about 9.25 s, about 9.5 s, about 9.75 s, about 10 s, about 11 s, about 12 s, about 13 s, about 15 s, or greater than about 15 s.

In embodiments, the specified layer depth the platform is dipped into the polymer resin comprises less than about 5 μm, about 5 μm, about 10 μm, about 15 μm, about 20 μm, about 25 μm, about 30 μm, about 40 μm, about 50 μm, about 75 μm, about 100 μm, about 150 μm, about 200 μm, about 250 μm, about 300 μm, about 500 μm, or greater than about 500 μm.

In embodiments, the drying comprises the drying comprises drying at room temperature for about 2 days; drying in vacuo at room temperature for about 1 day; and drying in vacuo with a temperature ramp of about 1.66 °C, wherein the temperature is held for about 1 hour at about 100 °C, about 200 °C, about 300 °C, or about 400 °C. As used herein, the term “room temperature” can refer to about 19 °C, about 20 °C, about 21 °C, about 22 °C, about 23 °C, about 24 °C, about 25 °C, about 26 °C, or about 27 °C.

In some embodiments, the effective wavelength can comprise about 280 nm, about 285 nm, about 290 nm, about 295 nm, about 300 nm, about 305 nm, about 310 nm, about 315 nm, about 320 nm, 325 nm, about 330 nm, about 335 nm, about 340 nm, about 345 nm, about 350 nm, about 355 nm, about 360 nm, about 365 nm, about 370 nm, about 375 nm, about 380 nm, about 385 nm, about 390 nm, about 395 nm, about 400 nm, about 405 nm, or about 410 nm. In embodiments, the effective wavelength can comprise about 285 nm, about 300 nm, about 310 nm, about 365 nm, about 385 nm, about 395 nm, or about 405 nm.

In embodiments, the irradiance can comprise about less than about 0.5 mW/cm², about 0.5 about 1 mW/cm², about 2 mW/cm², about 3 mW/cm², about 4 mW/cm², about 5 mW/cm², about 6 mW/cm², about 7 mW/cm², about 8 mW/cm², about 9 mW/cm², about 10 mW/cm², about 20 mW/cm², about 30 mW/cm², about 35 mW/cm², 38 mW/cm², about 40 mW/cm², about 45 mW/cm², about 50 mW/cm², about 55 mW/cm², about 60 mW/cm², about 65 mW/cm², about 70 mW/cm², about 75 mW/cm², about 80 mW/cm², about 85 mW/cm², about 90 mW/cm², about 95 mW/cm², about 100 mW/cm², about 105 mW/cm², about 110 mW/cm², about 115 mW/cm², about 120 mW/cm², about 125 mW/cm², about 130 mW/cm², about 135 mW/cm², about 140 mW/cm², about 145 mW/cm², about 150 mW/cm², about 155 mW/cm², about 160 mW/cm², about 165 mW/cm², about 170 mW/cm², about 175 mW/cm², about 180 mW/cm², about 185 mW/cm², about 190 mW/cm², about 195 mW/cm², about 200 mW/cm², about 205 mW/cm², about 210 mW/cm², about 215 mW/cm², about 220 mW/cm², about 225 mW/cm², about 230 mW/cm², about 235 mW/cm², about 240 mW/cm², about 245 mW/cm², about 250 mW/cm², about 255 mW/cm², about 260 mW/cm², about 265 mW/cm², about 270 mW/cm², about 275 mW/cm², about 280 mW/cm², about 285 mW/cm², about 290 mW/cm², about 300 mW/cm², about 305 mW/cm², about 310 mW/cm², about 315 mW/cm², about 320 mW/cm², about 325 mW/cm², about 330 mW/cm², about 335 mW/cm², about 340 mW/cm², about 345 mW/cm², or about 350 mW/cm².

In embodiments, the solvent can comprise a polar aprotic solvent. For example, the polar aprotic solvent can comprise dimethyl sulfoxide, dimethylformamide, dimethylacetamide, N-methyl-2-pyrrolidone, or any combination thereof.

Aspects of the invention are drawn towards made from the compositions and methods described herein. For example, aspects of the invention comprise a polysalt, copolysalt, a mixed polysalt, or resin thereof as described herein. For example, aspects of the invention comprise a method of processing polymer and polysalt resins as described herein. For example, aspects of the invention are drawn towards applying methods described herein to compositions described herein. In embodiments, thermal post-processing of polysalts can produce a homopolymer. In embodiments, thermal post-processing of mixed polysalts can produce a homopolymer. In embodiments, thermal post-processing of copolysalts can produce a copolymer.

In embodiments, the resin formulation can comprise less than about 5 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, or greater than about 95 wt % dissolved solids in a solvent.

In embodiments, the diester-dicarboxylic acid can comprise less than about 1 mol % acrylate, about 1 mol % acrylate, about 2.5 mol % acrylate, about 5 mol % acrylate, about 10 mol % acrylate, about 15 mol % acrylate, about 20 mol % acrylate, about 25 mol % acrylate, about 30 mol % acrylate, about 35 mol % acrylate, about 40 mol % acrylate, about 45 mol % acrylate, about 50 mol % acrylate, about 55 mol % acrylate, about 60 mol % acrylate, about 65 mol % acrylate, about 70 mol % acrylate, about 75 mol % acrylate, about 80 mol % acrylate, about 85 mol % acrylate, about 90 mol % acrylate, about 95 mol % acrylate, or greater than mol % acrylate.

In embodiments, the diamine can comprise less than about 1 mol % electron donating diamine, about 1 mol % electron donating diamine, about 2.5 mol % electron donating diamine, about 5 mol % electron donating diamine, about 10 mol % electron donating diamine, about 15 mol % electron donating diamine, about 20 mol % electron donating diamine, about 25 mol % electron donating diamine, about 30 mol % electron donating diamine, about 35 mol % electron donating diamine, about 40 mol % electron donating diamine, about 45 mol % electron donating diamine, about 50 mol % electron donating diamine, about 55 mol % electron donating diamine, about 60 mol % electron donating diamine, about 65 mol % electron donating diamine, about 70 mol % electron donating diamine, about 75 mol % electron donating diamine, about 80 mol % electron donating diamine, about 85 mol % electron donating diamine, about 90 mol % electron donating diamine, about 95 mol % electron donating diamine, or greater than mol % electron donating diamine.

Aspects of the invention are drawn towards tuning polymer resin properties. For example, ODA yields polymers with a well-characterized compositions but incorporation of DDS provides solutions with unparalleled processing windows and while maintaining similar material properties. Mixed polysalts enable thicker prints as the reduced acrylate content contributes to lower internal stresses during printing and drying. Copolysalts can provide a method for material property control, very similar to traditional polymer synthetic methods. For example, if “Polymer A” has property “x of 100” and “Polymer B” has property “x of 0”, the copolymer (excluding any phase separation) at 50/50 polymer A/B will have property “x at 50”.

Without wishing to be bound by theory, materials produced from methods described herein can possess a dielectric constant of about 3 to about 4 at 1 Hz at room temperature, a heat deflection temp of about 300 °C under about 1.82 MPa load, a heat deflection temperature above 300 °C under about 1.82 MPa load, is classified as HB, V-1, V-0, 5VB, or 5VA by UL-94 (the Standard for Safety of Flammability of Plastic Materials for Parts in Devices and Appliances testing as released by Underwriters Laboratories), possess a char yield of about 30 wt % to about 50 wt %, possess a degradation temperature of about 345 °C, and have a thermal conductivity of about 0.35 W/m°K. For example, the material can be classified as V-1 or V-0 by UL-94.

### EXAMPLES

Examples are provided herein to facilitate a more complete understanding of the invention. The following examples illustrate the exemplary modes of making and practicing the invention. However, the scope of the invention is not limited to specific embodiments disclosed in these Examples, which are for purposes of illustration only, since alternative methods can be utilized to obtain similar results.

### Example 1

Temporally Stable Supramolecular Polymeric Salts Enabling High-Performance 3D all-Aromatic Polyimide Lattices

### Abstract

Vat photopolymerization (VP) Additive Manufacturing (AM), in which UV light is selectively applied to cure photo-active polymers into complex geometries with micron-scale resolution, has a limited selection of aliphatic thermoset materials that exhibit relatively poor thermal performance. Ring-opening dianhydrides with acrylate-containing nucleophiles yielded diacrylate ester-dicarboxylic acids that enabled photo-active polyimide precursors, termed polysalts, upon neutralization with an aromatic diamine in solution. In situ FTIR spectroscopy coupled with solution and photo-rheological measurements revealed a previously unknown time-dependent instability of 4,4′-oxydianiline (ODA) polysalts due to an aza-Michael addition. Replacement of the electron donating ether-containing diamine with an electron withdrawing sulfone-containing monomer, e.g., 4,4′-diaminodiphenyl sulfone (DDS), prohibited the aza-Michael addition of the aromatic amine to the activated acrylate double bond. New DDS polysalt photocurable solutions were similarly analysed and validated long-term stability, which enabled reproducible printing of polyimide organogel intermediates. Subsequent VP AM afforded 3-dimensional (3D) structures of intricate complexity and excellent surface finish, as demonstrated with scanning electron microscopy. In addition, the new PMDA-HEA/DDS solution enabled the production of the first beam latticed architecture comprised of all-aromatic polyimide. The versatility of a polysalt platform for multi-material printing was further demonstrated by printing parts with alternating polysalt compositions.

### Introduction

High-performance engineering plastics derived from highly aromatic monomers display exceedingly high thermomechanical properties, excellent chemical stability, flame resistance, and radiation resistance, which collectively define a high performance engineering polymer.¹ Fully aromatic polyimides (PIs) exhibit a remarkable combination of thermal stability and mechanical strength that address challenges in the automotive, aerospace, and microelectronic industries.²⁻⁴ Traditionally, PIs are synthesized through a conventional step-growth solution polymerization with a dianhydride and diamine in a polar solvent. Extensive availability of diverse dianhydrides and diamines facilitate wide material properties to address the needs of emerging technologies, such as active-matrix organic light emitting displays (AMOLEDs), which demand materials with higher dimensional stability than traditional optical polymer films.⁵ In addition, low dielectric polyimides are readily available through copolymerization with fluorine containing monomers, including 4,4′-(hexafluoroisopropylidene)diphthalic anhydride (6FDA), which effectively suppress cross-talk and resistance-capacitance time delay.⁶ Although the synthetic requirements and difficulty of main-chain diversification is low, processing of polyimides remains a challenge.

Synthesis of highly aromatic polyimides affords rigid polymers with strong intermolecular interactions, which impart remarkably high glass transition temperatures (>300 °C); however, a lack of sufficient viscous polymer flow prohibits conventional melt processing techniques. In addition, thermal cyclodehydration of aromatic poly(amic acid) precursors results in chemically resistant polymers, which further complicates solution processing and limits all-aromatic polyimides to 2-dimensional (2D) form factors.⁷ Poly(4,4′-oxidiphenylene pyromellitimide), recognized as Kapton®, is an impactful commercially available as fully aromatic PI films and tapes. Vespel® presents a path towards molded 3D objects; however, resultant geometries are limited to extrusions of simple shapes and require extreme temperatures and pressures during processing. Furthermore, light-based additive manufacturing of PIs has received less attention in the literature despite a high demand for more complex micron-scale geometries.⁸

Traditional polyimide synthesis for soluble poly(ether imides) (PEI) involves a single-step poly(amic acid) formation and imidization in solution as opposed to the two-step method typically for all-aromatic PIs, which requires poly(amic acid) formation in solution with subsequent casting and chemical/thermal cyclodehydration.⁹⁻¹³ In sharp contrast, earlier polyamide literature indicated an unconventional route for polyimide synthesis, termed polymerization of monomeric reagents (PMR). PMR employed supramolecular dicarboxylate-diammonium interactions between aromatic diamines and the dialkylester from an aromatic tetracarboxylic acid.¹⁴⁻¹⁶ Commercial polyimide PMR methods can be limited to norbornene end capped oligomers that provide reverse Diels-Alder (RDA) systems. These precursors undergo rapid imidization below 230 °C and subsequent crosslinking at temperatures greater than 250 °C.¹⁷ The resultant polyimide networks can exhibit glass transition temperatures (T_{g}) above 350 °C and serve as impregnating resins for high-performance composites.

Vat photopolymerization (VP) additive manufacturing (AM) processes offer exceptional printing speed, and the finest feature resolution and surface finish of all 3D printing modalities. The ability to precisely control UV irradiation and to analytically model and predict the cured layer profile affords the highest accuracy of all AM modalities and enables fabrication of exceptionally complex geometries. This capability enables light weighting of conventional solid objects, which minimizes material use (and later, material waste) and can, in turn, maximize fuel economy. For example, the low earth orbit launch cost per kilogram remains high at $55,000 kg⁻¹ with NASA's space shuttle program and $2,800 kg⁻¹ with the SpaceX Falcon 9.18 However, although it emerged as the first AM process in 1983, the primary application of parts made with VP remains limited to modeling, prototyping, and tooling for investment casting and thermoforming (e.g., personalized orthodontic applications) due to its limited material catalog.^{19,20} Due to advances in printing dual cure chemistries (i.e., in which photocuring is used to establish the printed shape, and a post-process thermal cure is used to set final part properties), the application space has expanded to printing end-use products for athletic apparel and automotive applications. However, due to its reliance on the presence of a photocurable moiety and a corresponding aliphatic oligomer, even VP's most recent resins have limited thermomechanical performance.

The authors' prior research in creating a path to AM of all-aromatic polyimides primarily employed macromolecular approaches to photoactive polyimide precursors with an entirely covalent main chain bonding, i.e., poly(amic diacrylate ester) s (PADE) and a partially covalent system, poly(amic acid) pendant salts (PAAS).^{21,22} The low solution viscosity requirement for VP (i.e., <~8 Pa·s) restricted previous macromolecular photo-reactive solutions to less than 30 wt. % solids. As a result of the low solid content, the organogels exhibited high levels of isotropic shrinkage (~50%) during post-processing thermal imidization. A new printable polyimide precursor, termed polysalts, was disclosed from our laboratories.²³ This approach differed from the previous PADE and PAAS techniques wherein the printed organogel contained the polymer precursors; instead the polyimide precursor self-assembled in the post-process. Specifically, the polysalt platform leveraged learnings from polymerizable monomeric reagents (PMR) s but employed a photo-active diacrylate ester rather than the traditional dialkylester. This approach provided a printable polyimide precursor comprised entirely of low molecular mass diamines and dicarboxylic acids electrostatically joined with dynamic diammonium-dicarboxylate interactions. The resulting solutions exhibited viscosities two orders-of-magnitude lower than previously published literature while increasing solid contents to 50 wt. %. The higher solid content reduced shrinkage (26%) and yielded thermomechanical properties nearing those of conventionally prepared analogs.

Although the polysalt approach proved superior for printing and performance as compared to previous generations of 3D printable all-aromatic polyimides, further investigation revealed 4,4′-oxydianiline (ODA) polysalt solutions exhibited temporal instability and decreased shelf-life, which complicates successful commercial adoption. Polysalt solutions aged and darkened, photo-curing was impeded, and printed part resolution diminished. This disclosure provides insight into ODA-based polysalt solutions, isolates the cause of temporal instability, and describes a solution borne from fundamental nucleophilicity and basicity concepts. Photo-rheology, solution rheology, and in situ FTIR spectroscopy revealed the mechanism of ODA-based polysalt solution degradation. Substitution of the electron rich diamine, i.e., ODA, with a less nucleophilic aromatic diamine, i.e., 4,4′-diaminodiphenyl sulfone (DDS), afforded a polysalt solution with temporally stable chemical composition, photo-curing profiles, and printability.²⁴ This new polysalt platform enabled facile printing with repeatable and consistent process parameters, provided time-independent thermomechanical properties of the resultant polyimide, and established a reliable compositional library for AM of all-aromatic polyimides. This disclosure demonstrates the elimination of the time-dependent chemical structure found in preceding PMDA-HEA/ODA solutions with minimized volumetric shrinkage attributed to the supramolecular polymeric salt approach.

### Materials and Methods

### Materials

Pyromellitic dianhydride (PMDA) (Acros; purity, >99%), 4,4′-oxydianiline (ODA) (Sigma-Aldrich; purity, 97%), 4,4′-diaminodiphenyl sulfone (DDS) (Aldrich; purity, 97%) were sublimed immediately prior to use. Diphenyl(2,4,6-trimethylbenzoyl)phosphine oxide (TPO) (TCI, purity, >98%), 2-hydroxyethyl acrylate (Acros Organics; purity, 97%, stabilized), deuterated dimethyl sulfoxide (DMSO-d₆) (Thermo Scientific, 99.5%), hydrochloric acid (Fisher Chemical, certified ACS), anhydrous dimethyl sulfoxide (DMSO) (Acros Organics, 99.7+%, extra dry over molecular sieves) were used as received. Triethylamine (TEA) was distilled and stored over activated molecular sieves (3 Å).

### Analytical Methods

¹H nuclear magnetic resonance (NMR) spectroscopy was performed in DMSO-d₆ on a Bruker Avance NEO at 500 MHz (23 °C) with a 5 mm iProbe. Thermogravimetric (TGA) analysis was performed on a TA Instruments 5500 with N₂ fill gas with a temperature ramp of 10 °C/min from 25 °C to 800° C. Photo-rheological experiments were performed on a TA Instruments DHR-3 at 25 °C. These measurements were made on a Smart Swap™ geometry with an Omnicure® S2000 high-pressure mercury light source with a 320-500 nm filter, 20 mm disposable aluminum parallel plate, and a 20 mm quartz parallel plate lower geometry with a 500 μm gap. UV irradiance as measured using a Silverline radiometer with a 20 mm attachment. Measurement parameters were set with a sampling frequency of 1 Hz, 0.1% strain, and 250 mW·cm⁻² UV irradiance. The samples were exposed to UV light 30 s into the experiment for 15 s. The data was analyzed using the TA Instruments TRIOS software to identify the storage modulus (G′), loss modulus (G″), and crossover time. Solution rheology was performed on a TA Instruments DHR-3 at 25 °C in DMSO. These measurements were made on a Smart Swap™ concentric cylinder lower geometry with a recessed bob upper geometry and a 2400 μm gap. Shear sweeps from 10-1000 l/s were used. A Thermo Scientific Phenom XL large stage scanning electron microscope provided images of the surfaces and cross sections of the 3D printing specimens. In situ FTIR spectroscopic experiments were performed with a Mettler Toledo React IR-15 with a Si composite probe, 3 min resolution, and 128 scans. ATR-FTIR was performed with a ThermoScientific Nicolet iS10 at 25 °C. Density measurement of PMDA-DDS control film was conducted using a modified version of ISO 1183 immersion method with anhydrous chloroform as the immersion liquid. Compression testing of the 3D printing polyimide structures was performed with an Instron 68™-5 uniaxial testing machine equipped with a 5 kN load cell and 50 mm platens at 1 mm/min.

### Synthesis of Acrylate Ester Dicarboxylic Acid

Pyromellitic dianhydride (100 g, 0.4585 mol) and 2-hydroxyethyl acrylate (200 mL, 1.741 mol), and triethylamine (8.26 mL, 0.05929 mol) were added to a flame-dried two-neck, round-bottomed flask fitted with a glass mechanical stir rod with a Teflon™ paddle. The heterogenous solution was submerged in an oil bath heated to 50 °C for 3 h. The resulting solution was poured into 1 M HCl (4 L) and allowed to stir for 1 h. The acidic solution was decanted, and then the product subsequently was stirred in deionized water (4 L) for 1 h before the white, tacky solid was collected in a fritted glass funnel and allowed to dry for 18 h. This material was dried in vacuo at 40 °C for 18 h. The overall yield was 72%, 1H NMR (400 MHz, DMSO-d₆) δ 13.85 (s, 2H), 8.11 (s, 1H), 8.01 (s, 1H), 7.91 (s, 1H), 6.35 (dd, 4H, J=17.4, 1.6 Hz), 6.18 (dd, 4H, J=17.4, 10.4 Hz), 5.95 (dd, 4H, J=10.4, 1.6 Hz), 4.46 (m, 16H).

### Formation of Photo-Active Polysalt of PMDA-HEA and Aromatic Diamine

For a 50 wt. % solids solution, the diamine, ODA (1.33 g, 0.007 mol) was weighed into a 4-dram vial with anhydrous DMSO (4.33 g) and a magnetic stir bar. The mixture was allowed to stir until the ODA was fully dissolved. PMDA-HEA (3 g, 0.007 mol) was then added and allowed to stir until fully dissolved. Lastly, TPO (0.111 g, 0.0003 mol) was added and stirred until full dissolution while covered with aluminum foil to protect from ambient light.

### Vat Photopolymerization Additive Manufacturing

A custom-built top-down mask projection VP system was used to fabricate three-dimensional parts with various polysalt resin formulations. A Wintech projector equipped with a Texas Instruments PRO4710 digital micromirror device (DMD) and a 385 nm UV LED with a peak irradiance of 38 mW/cm² (at the working distance of the projector) was used to irradiate the resin. At a working distance of 92 mm, this projector exposed a 68 mm×38 mm area with a pixel resolution of 35.5 μm×35.5 μm. A Thorlabs MT S50-Z8 z-stage operated by a Thorlabs KDC101 controller outfitted with a custom machined aluminum build platform was used as an elevator. A 50 mL crystallization dish was used as a resin vat. The vat, elevator, and projector were all mounted to an extruded aluminum frame. All components of the VP system were synchronized and controlled through custom software built in Lab View and Python. BMP images of each part layer contour were input into the projector following digitally ‘slicing’ of the STL files into cross-sections at the desired layer thickness. To print a part, the build platform began at a start height equivalent to the working distance of the projector. The z-stage then lowered the build platform into the resin and returned it to one layer height below the resin surface. This thin film of resin was then exposed to UV light in the shape of the BMP image of the slice of the first layer of the part. This process of dipping followed by UV exposure was then repeated until the completion of the part. Following printing, parts were dried in ambient conditions until no tack remains. Parts were then thermally imidized in a vacuum oven to 100, 150, 200, and 250 °C for 1 h each.

A working curve for each resin was developed by measuring the height of cured profiles when exposed to 385 nm UV light at an irradiance of 20 mW/cm² for various exposure times. These working curves were used to calculate a depth of penetration (Dₚ) of 0.18 mm and a critical exposure (E_{c}) of 5.93 mJ/cm² for the PMDA-HEA/DDS polysalt resin and a Dₚ of 0.27 mm and E_{c} of 45.12 mJ/cm2 for the PMDA-HEA/ODA polysalt resin. These working curves were also used to select exposure times of 0.5 s and 3 s for PMDA-HEA/DDS and PMDA-HEA/ODA polysalt resins respectively at an irradiance of 20 mW/cm² to cure 100 μm layers. The first layer of the print was exposed for a longer time of 10 seconds to promote build plate adhesion. During printing, all build plate travel moves were performed at 0.1 mm/s with 10 s holds at the bottom and top of the dip. This was done to allow time for the resin to flow over cured layers and form a smooth surface without the need for a recoating device. No recoating was required for these prints due to the low viscosity of the resins. A 1 mm dip depth minimized print time while also ensuring resin covered previously cured layers. In addition, lattice structures were printed for subsequent compression testing using an EnvisionTEC EnvisionOne cDLM printer with 100 μm layers, 25 s burn-in time for the first 5 layers, and 5 s exposure for all remaining layers.

### Results and Discussion

Synthesis of a diacrylate ester-dicarboxylic acid provided the foundation for the polysalt platform. An organic base-catalyzed, ring-opening of a dianhydride with 2-hydroxyethyl acrylate afforded the photopolymerizable diacrylate component, termed PMDA-HEA, as shown in Scheme 1.

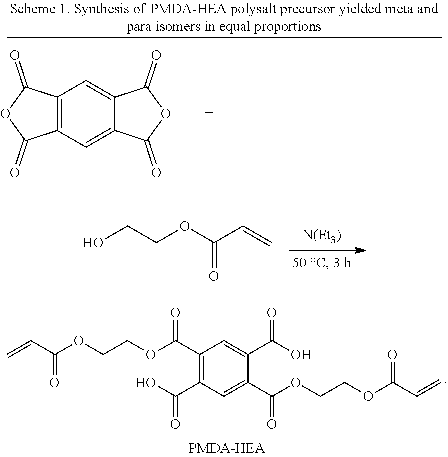

The carboxylic acids were neutralized with an aromatic amine and the ensuing diammonium-dicarboxylate electrostatic interaction provided the polysalt structure, as shown in Scheme 2.

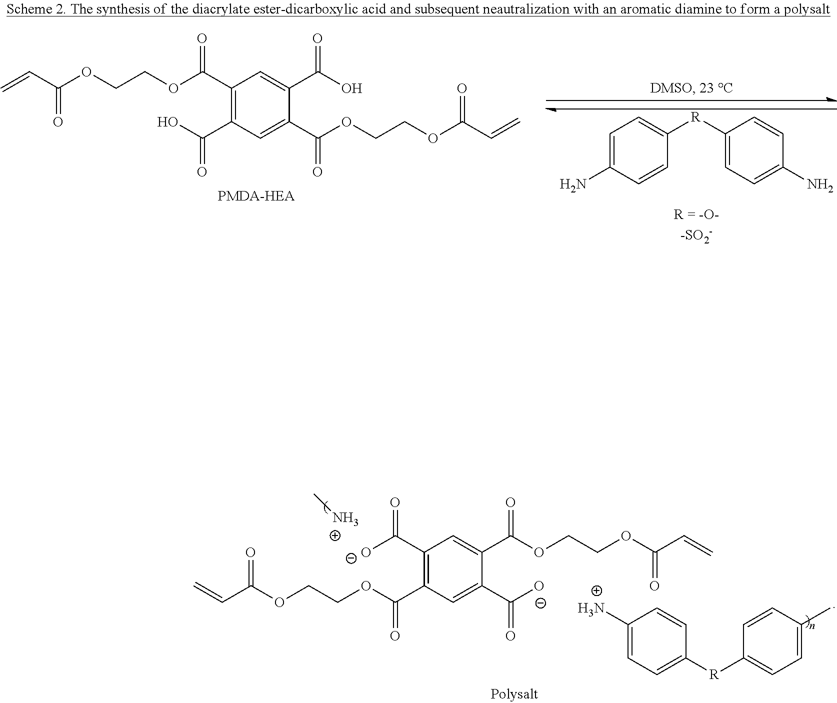

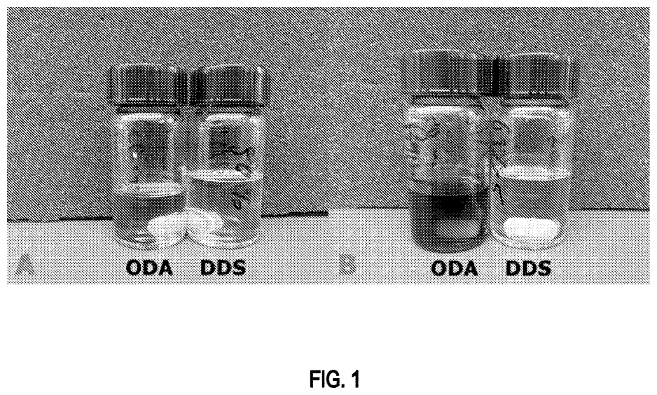

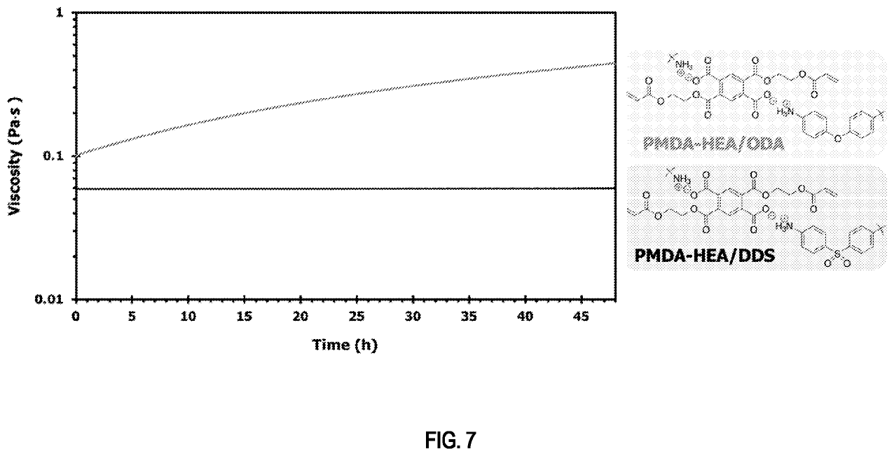

Previous research detailed the preparation of a PMDA-ODA polysalt, printing, and subsequent material property analysis. 3D printed parts from this approach exhibited thermomechanical properties comparable to those of the traditional step-growth PMDA-ODA polymer.²³ However, dynamic solution structure of the polysalt platform remained unexplored. Subsequent solution analysis revealed that PMDA-HEA/ODA polysalt solutions discolored (FIG. 1) and displayed increased solution viscosities as a function of time at ambient conditions (FIG. 7).

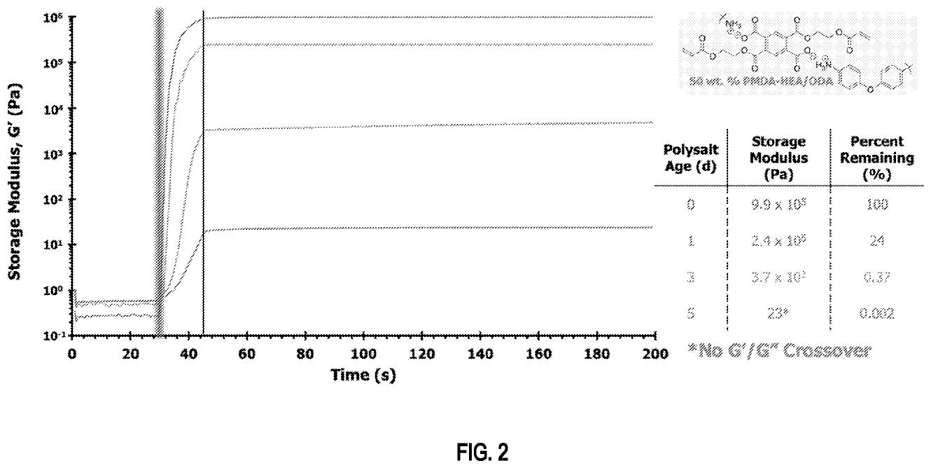

Initial photo-rheological experiments indicated a temporally dependent plateau storage modulus (G′) of the PMDA-HEA/ODA polysalt, shown in FIG. 2. Fresh polysalt (depicted in blue) exhibited fast photo-curing and a plateau storage modulus of 10⁶ Pa. However, as the polysalt solution aged, the plateau storage modulus decreased precipitously and fell below the VP printable limit of 10⁵ Pa after 24 h.²⁵⁻²⁷ From a processing standpoint, this represented a process limitation as PMDA-HEA/ODA polysalt solutions can require immediate printing, which produced extraneous waste of unstable polysalt solutions if not used immediately.

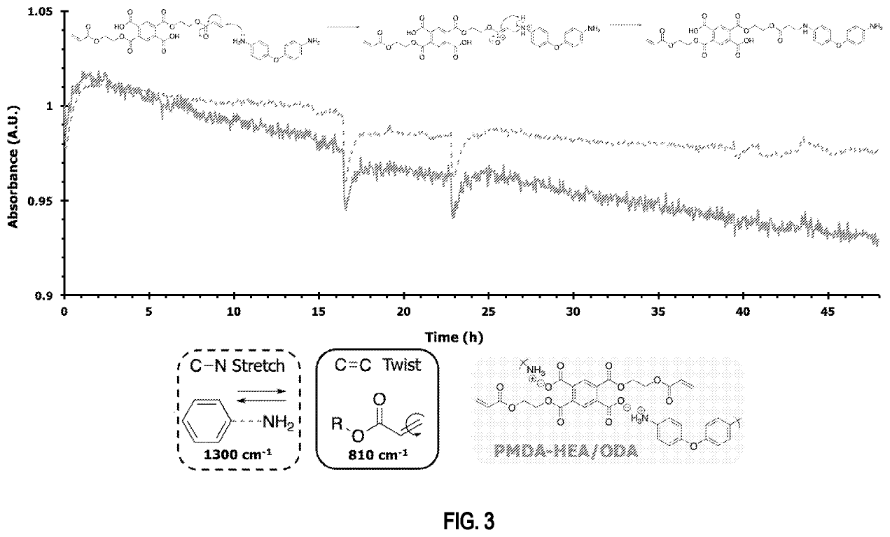

Furthermore, polysalt degradation complicated processing conditions, and, more importantly, the degradation mechanism undoubtedly affects the final polyimide physical properties. Thus, in situ FTIR spectroscopy probed the polysalt aging mechanism. FIG. 3 displays the 1300 cm⁻¹ aromatic amine C—N stretch and the 810 cm⁻¹ acrylate C═C twist absorbance in a PMDA-HEA/ODA polysalt solution for 48 h.²⁸⁻³¹ It is clear that amines and acrylates were consumed, which indicated that the degradation mechanism involved both functional groups. It is proposed that polysalt degradation proceeded through an aza-Michael addition mechanism, which polymerized PMDA-HEA with ODA, thus yielding a poly(β-amino ester). It is apparent that the characteristic C—N stretch and C═C twist decreased unproportionally as the proposed aza-Michael addition consumes one amine and one acrylate. However, both the amine and acrylate can participate in non-covalent associated structures, i.e., ammonium and acrylate carbonyl hydrogen bonding, respectively. In addition, the C═C exists exclusively in the monomer, while the C—N stretch vibrational mode exists in both the monomer and polymeric product. Thus, the disparity in relative absorbances can arise from the equilibrium difference of associated and unassociated states for these functional groups together with a convolution of the monomeric C—N peak and the C—N stretch of the polymeric product.

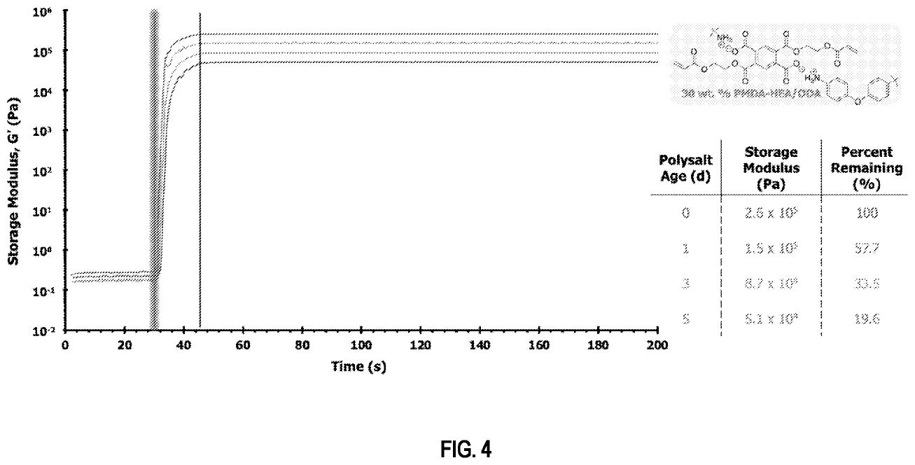

The aza-Michael reaction is bimolecular and as such, presumably will show a concentration dependent reaction rate. As these photo-active polyimide precursors are intended for VP, their ability to photo-cure quickly with a sufficiently high plateau storage modulus is vital for successful processing. Reducing the PMDA-HEA/ODA polysalt concentration had a marked effect on the rate at which the plateau storage modulus decayed, as shown in FIG. 4. Polysalt concentration controlled the degradation rate and the 30 wt. % PMDA-HEA/ODA polysalt exhibited printable characteristics for three days compared to only one day for the 50 wt. % PMDA-HEA/ODA solution. However, increased solvent content created additional post-processing concerns, including increased warpage and shrinkage, which made cracking more likely.

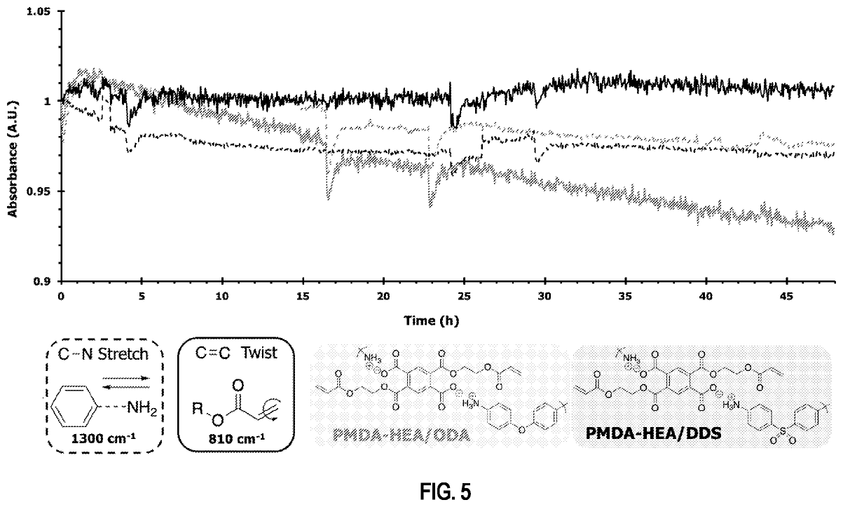

Polysalt degradation is disadvantageous for many reasons, but most concerning is the disruption of the final polyimide chemical structure as the resulting poly(β-amino ester) prohibits cyclodehydration to the intended polyimide. The preparation of a new sulfone-containing polysalt circumvented the degradation mechanism due to reduced amine nucleophilicity. Subsequent in situ FTIR spectroscopy of the sulfone-containing polysalt did not exhibit a change in absorbance over the two-day experiment in FIG. 5 once a homogenous solution was achieved. These data show that the electron-withdrawing sulfone effectively deactivated the aza-Michael addition, in contrast to the more nucleophilic etheric diamine, ODA.

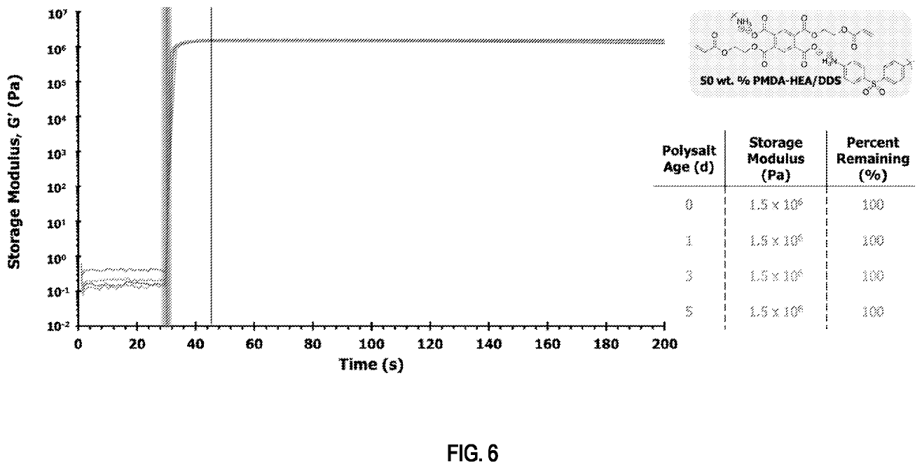

Ensuing photo-rheology corroborated the assertation that PMDA-HEA/DDS polysalt demonstrated temporal stability unattainable with ODA polysalt, as shown in FIG. 6. The PMDA-HEA/DDS polysalt plateau storage modulus remained constant with increased age, unlike the PMDA-HEA/ODA polysalt. Exchanging ether for sulfone provided temporally stable polysalt solutions, which afforded consistent photo-curing and simplified subsequent 3D photo-processing, and increased reproducibility. Most importantly, the lack of degradation ensured that printed parts retained their intended chemical structure, which enabled reproducible thermal post-processing to the all-aromatic polyimide.

Solution rheological measurements showcased the low initial viscosity of both polysalt solutions. In addition, this provided further evidence for the aza-Michael addition mechanism, as shown in FIG. 7. The PMDA-HEA/ODA polysalt exhibited an increase in solution viscosity, which resulted from acrylate-amine step-growth polyaddition. In sharp contrast, PMDA-HEA/DDS polysalt solutions displayed a constant solution viscosity from a stable solution comprised only of low molar mass components. Inconsistent solution viscosities proved problematic for VP efforts as the PMDA-HEA/ODA aza-Michael polymerization complicated layer recoating during processing. In addition, the PMDA-HEA/DDS polysalt exhibited a lower native solution viscosity as the reduced basicity of the sulfone-containing diamine decreased the equilibrium concentration of monomers linked with ionic interactions compared to PMDA-HEA/ODA solutions.²⁴

Photo-rheology, in situ FTIR spectroscopy, and solution rheology probed polysalt solution stability of PMDA-HEA/ODA and PMDA-HEA/DDS. These experiments supported the aza-Michael addition degradation mechanism of PMDA-HEA/ODA solutions and the exceptional stability of PMDA-HEA/DDS solutions. These experiments elucidated two competing processes within PMDA-HEA/ODA solutions: the formation of diammonium-dicarboxylate ionic interactions and the aza-Michael addition across the acrylate double bond. The former templates poly(amic acid) structure while maintaining acylate functionality for 3D printing, and the latter consumes both amine and acrylate to provide an unintended poly(β-amino ester) side product, thus reducing photo-reactivity. Contrarily, PMDA-HEA/DDS solutions only participated in ionic interactions, detailed in Scheme 3, which afforded stable polysalt solutions.

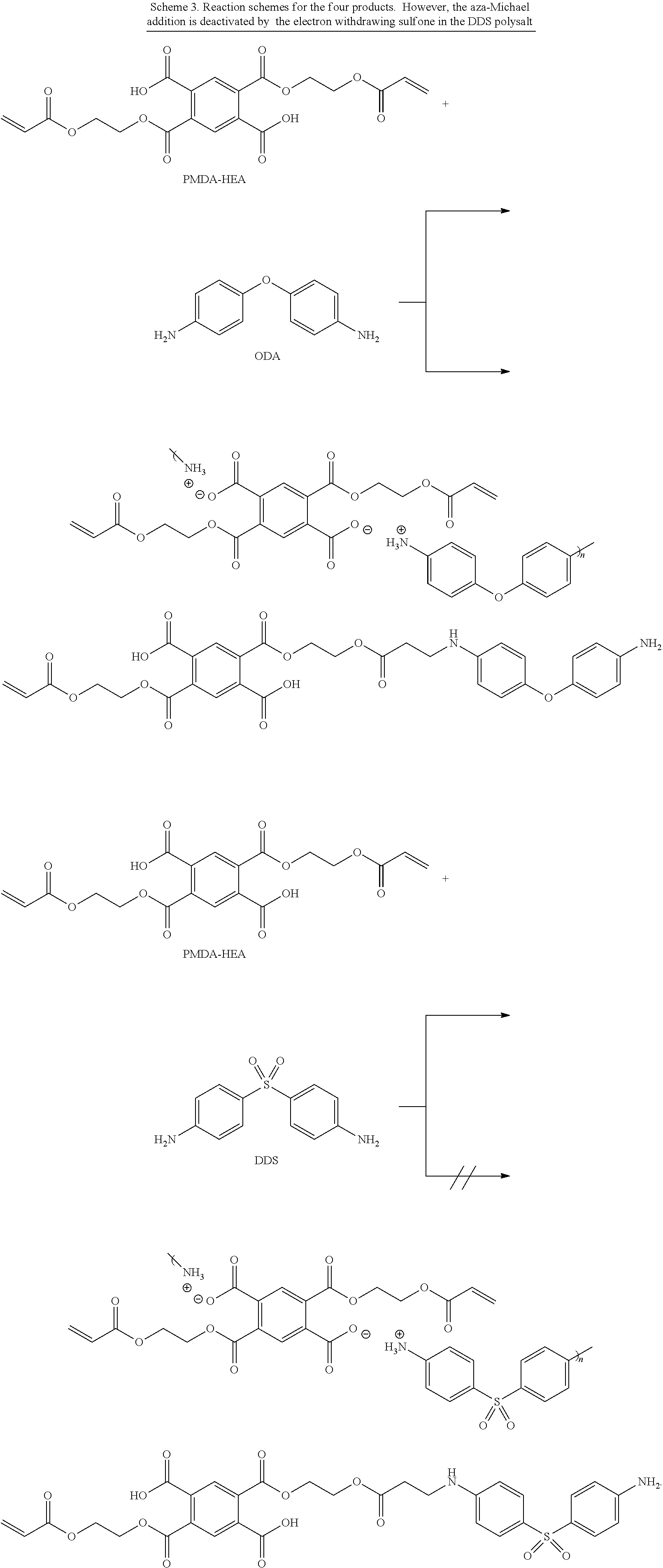

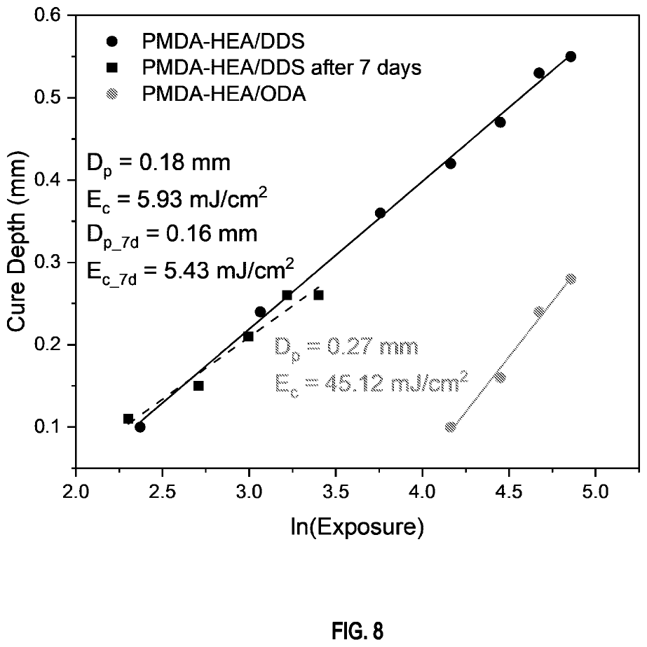

VP provides access to complex geometries with unrivaled surface finish and resolution.³² Carefully controlling UV exposure to cure many very thin layers achieves this desirable high resolution. FIG. 8 depicts working curves for PMDA-HEA/ODA polysalt resin without aging and PMDA-HEA/DDS polysalt resin before and after 7 days of aging. A working curve for PMDA-HEA/ODA polysalt resin after 7 days of aging was not attainable as profiles from aged resin regardless of UV exposure were not achievable. These working curves informed the selection of UV exposure settings during printing. It is notable that the E_{c} and Dₚ values for the aged and unaged PMDA-HEA/DDS polysalt resins remained largely unchanged, which indicated the absence of photo-reactivity loss. In addition, these observations indicated that both aged and unaged PMDA-HEA/DDS polysalt resins were printable using identical exposure parameters.

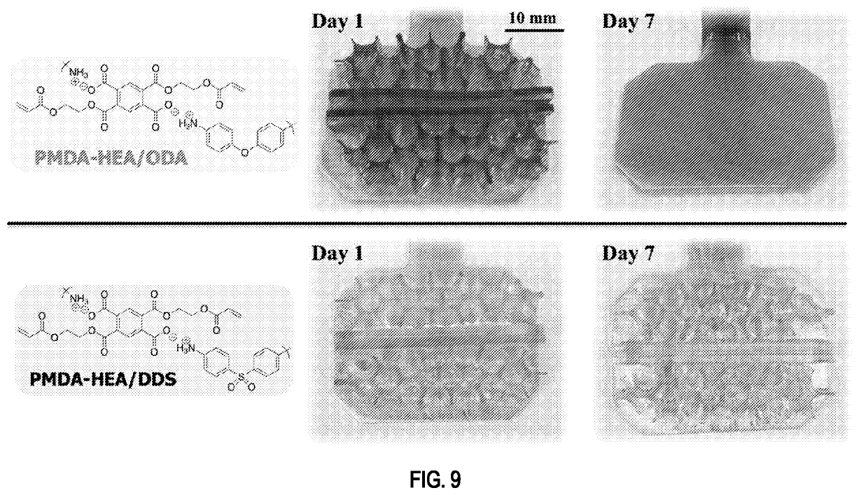

A custom-built VP system printed a solid model of the representative repeating units of the targeted polyimide as a means of qualitatively assessing the printability of the fresh and aged polysalt solutions. FIG. 9 shows that as the aza-Michael addition proceeded, photo-reactivity, and thus printability, of the ODA containing polysalt decreased. Exposure time was adjusted at several intervals from 9 s up to 60 s at the VP system's maximum irradiance of 38 mW/cm2 to account for loss in photo-reactivity. Despite this increase in UV dosage, no parts were obtained after the resin was aged for 7 d. However, the DDS polysalt maintained printability and provided well resolved parts independently of solution age. Furthermore, the initial print parameters of 0.5 s exposure time at an irradiance of 20 mW/cm² that led to successful printing after zero days required no adjustment after the resin was allowed to age for seven days.

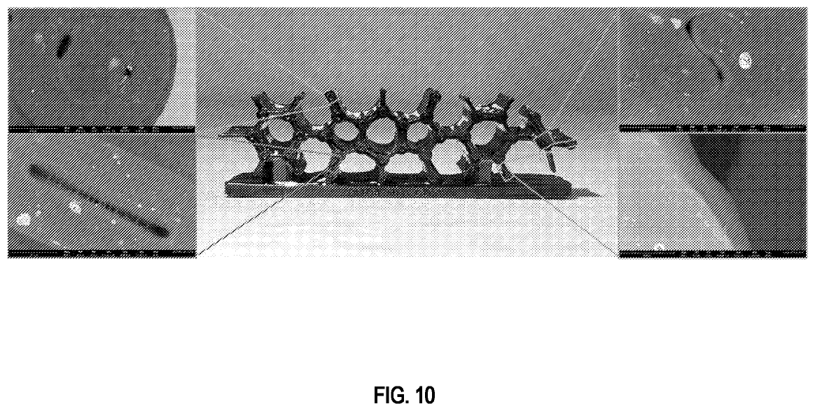

Subsequent thermal imidization of a 3D printed representative organogel yielded the final all-aromatic polyimide, as shown in FIG. 10. This printed object, which represents a solid model of the PMDA-HEA/DDS molecular structure, demonstrates the excellent resolution that is achievable with low-viscosity polyimide precursor polysalt solutions and minimal warpage upon thermal imidization. Imidization was characterized by approximately 22% linear shrinkage parallel to layer boundaries and 17% linear shrinkage in the print direction perpendicular to layer boundaries. These linear shrinkage values are the smallest ever reported for photocurable polyimide printed objects, in part owing to the high solids loading achievable via the polysalt approach. In addition, scanning electron microscopy (SEM) elucidated the retention of fine surface details near 20 μm. The top left and right images show the printed surface labels on the oxygen and sulfur atoms, respectively, while the bottom left shows a carbon-oxygen double bond. Lastly, the bottom right showcases layer coalescence, smooth surface finish, and a lack of delamination or cracking. Printed objects exhibited a darkened color as a result of poly(2-hydroxyethyl acrylate) (PHEA) scaffold degradation.³³

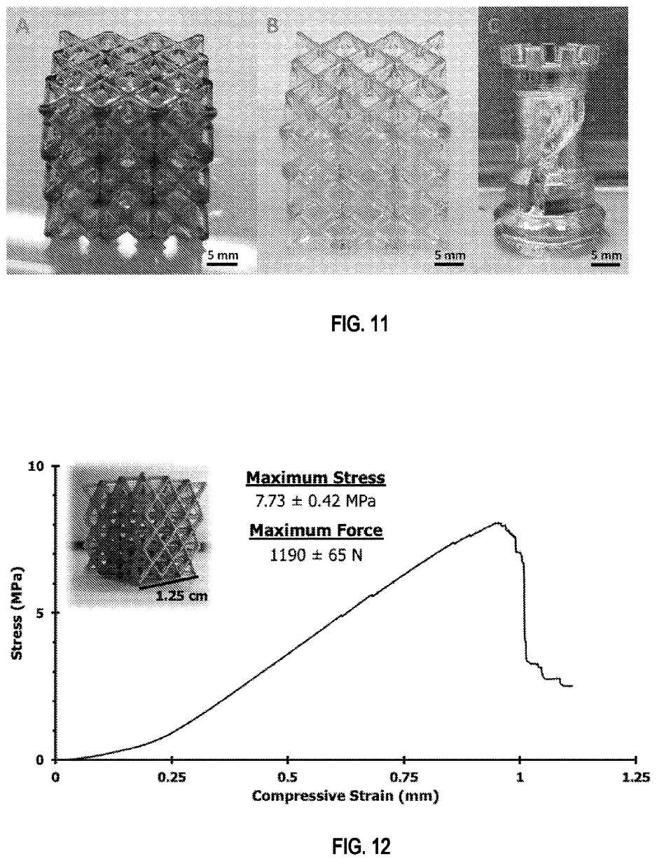

As shown previously, the unaged PMDA-HEA/ODA and PMDA-HEA/DDS polysalt solutions displayed similar photorheology profiles and solution viscosities, which facilitated multi-material printing. This was achieved by preparing two vats of resin, one for each chemistry, and swapping between them during the print. FIG. 11 depicts a variety of printed objects from each polysalt solution and demonstrates that exchanging vats during the printing process did not affect part resolution. This technique shows potential for complex geometries with well-defined gradients of thermomechanical properties.³⁴ In addition, the polysalt solution's high G′ (>10⁶ Pa) affords organogels with sufficient stiffness to withstand the swollen structure mass in a beam latticed architecture. This is the first report of a 3D printed, fully aromatic polyimide beam lattice, as demonstrated in FIG. 11 for both PMDA-HEA/ODA and PMDA-HEA/DDS solutions.

A comparative PMDA-DDS film derived from the conventional poly(amic acid) approach demonstrated a density of

$$1.41 \frac{g}{c {m}^{3}} .$$

Upon imidization to 200 °C, the measured bulk approach demonstrated a density of density of the lattice was

$$0.43 \frac{g}{c {m}^{3}}$$

with a programmed relative lattice void space of 68.4%.

TABLE 1
Printed polysalt lattice array parameters.

| Bounding Box | Unit Cell | Unit Cell | Unit Cell | Strut |
|---|---|---|---|---|
| Dimensions | Topology | Size | Array | Diameter |
| 1.59 cm³ | Octet Truss | 5.3 mm³ | 3 × 3 × 3 | 0.9 mm |

When subjected to a compressive load, PMDA-HEA/DDS lattices displayed high compressive strength, reaching an average maximum force of nearly 1200 N and maximum stress of 7.7 MPa across the three samples. This polyimide octet truss lattice array unit had a mass of only 0.86 g maintained structural integrity while supporting 140,000 times their own mass. Deformation characteristics are largely dependent on lattice architecture with void content, strut angles, strut thickness, and internal geometries contributing to the experimentally determined mechanical properties.³⁵ We can explore diverse lattice architectures and their effect on the strength of polyimide lattices and modes of failure.

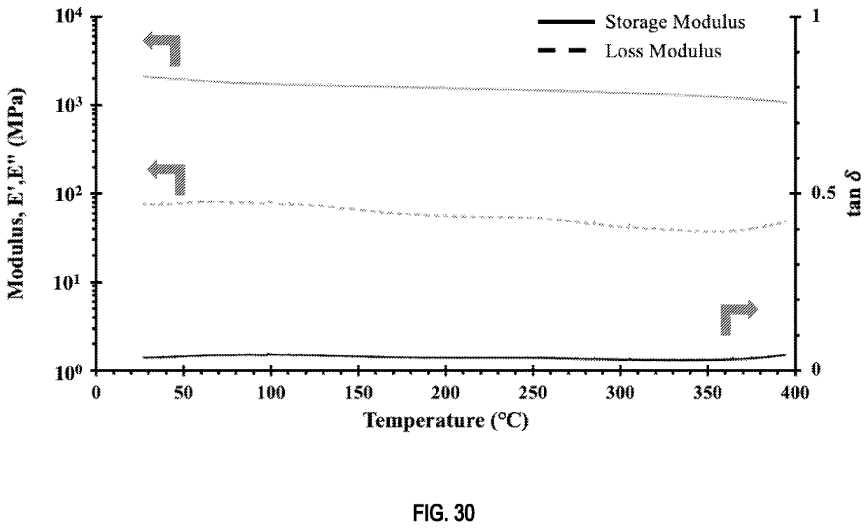

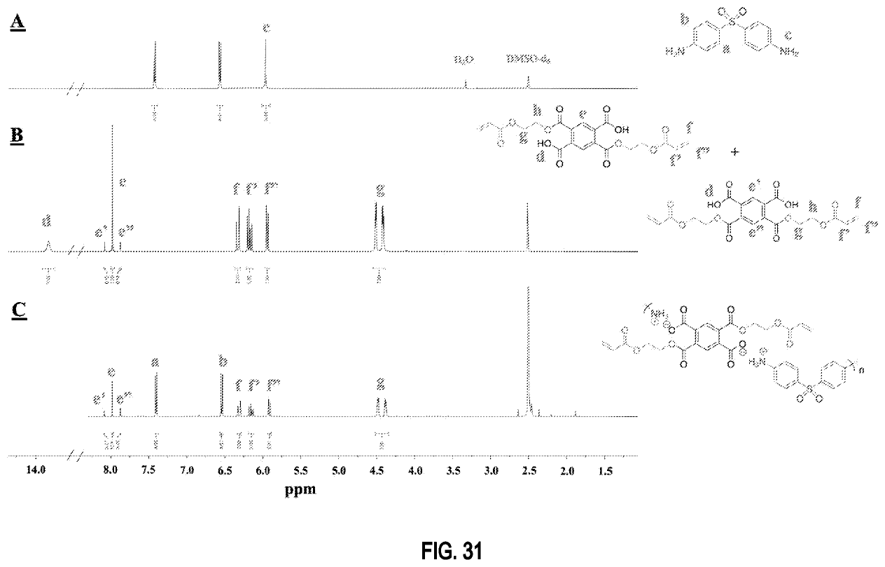

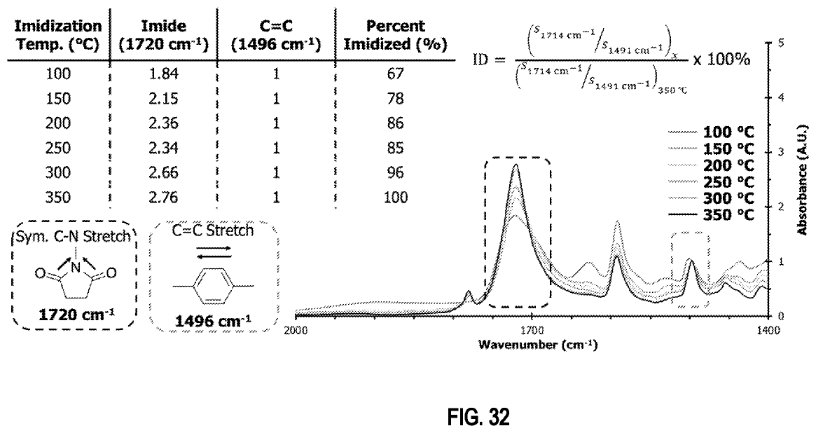

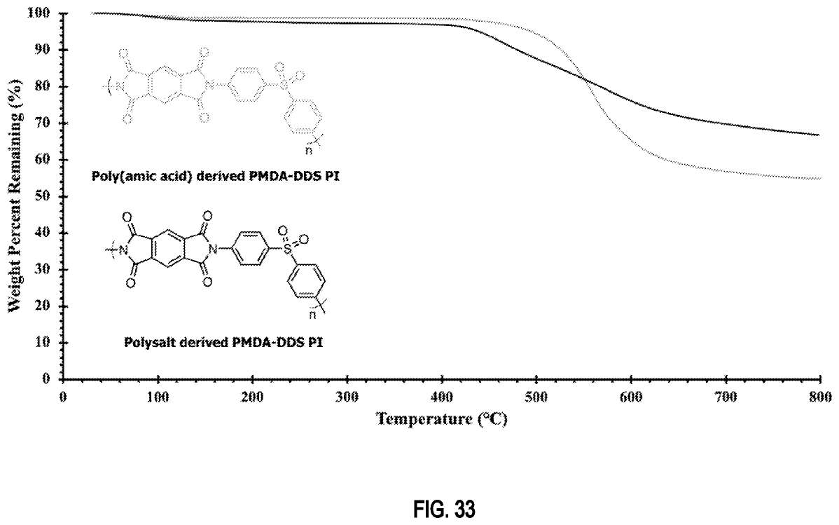

In sharp contrast to earlier literature of printed beam lattice compression studies, these materials exhibit enhanced performance when tested at room temperature.^{36,37} However, as polyimides display excellent mechanical properties up to 400° C. (FIG. 30), further mechanical testing will investigate 3D printing polyimide lattice performance at elevated temperatures. Without wishing to be bound by theory, polysalt-derived 3D polyimides can provide high performance at use temperatures far exceeding those of conventional VP resins.

### Conclusions

All-aromatic polyimides pose considerable processing challenges resulting from high aromatic content and a characteristic lack of viscous flow. This disclosure details the preparation of a new polysalt composition, which served as a facile synthetic method for complex polyimide materials. Previous compositions exhibited time-dependent properties that demanded timely processing to maintain desired chemical composition and material properties due to a rapid aza-Michael addition degradation mechanism. Controlling the amine nucleophilicity increased polysalt solution stability and reliability of the polysalt platform. The temporally independent nature of the PMDA-HEA/DDS polysalt allows for standardized processing procedures as the solution is free from deleterious side reactions. With this, all-aromatic polyimides now benefit fully from vat photopolymerization techniques enabled by the low viscosity (<1 Pa·s) polysalt approach.

### REFERENCES CITED IN THIS EXAMPLE

(1) Hergenrother, P. M. The Use, Design, Synthesis, and Properties of High Performance/High Temperature Polymers: An Overview. High Perform. Polym. 2003, 15, 3-45.
(2) Kausar, A. Holistic Insights on Polyimide Nanocomposite Nanofiber. Polym. Technol. Mater. 2020, 59 (15), 1621-1639.
(3) Govindaraj, B.; Sarojadevi, M. Microwave-Assisted Synthesis of Nanocomposites from Polyimides Chemically Cross-Linked with Functionalized Carbon Nanotubes for Aerospace Applications. Polym. Adv. Technol. 2018, 29 (6), 1718-1726.
(4) Simpson, J. O.; St. Clair, A. K. Fundamental Insight on Developing Low Dielectric Constant Polyimides. Thin Solid Films 1997, 308-309 (1-4), 480-485.
(5) Yi, C.; Li, W.; Shi, S.; He, K.; Ma, P.; Chen, M.; Yang, C. High-Temperature-Resistant and Colorless Polyimide: Preparations, Properties, and Applications. Sol. Energy 2020, 195, 340-354.
(6) Han, S.; Li, Y.; Hao, F.; Zhou, H.; Qi, S.; Tian, G.; Wu, D. Ultra-Low Dielectric Constant Polyimides: Combined Efforts of Fluorination and Micro-Branched Crosslink Structure. Eur. Polym. J. 2021, 143, 110206.
(7) Polyimides; Wilson, D., Stenzenberger, H. D., Hergenrother, P. M., Eds.; Springer Netherlands: Dordrecht, 1990.
(8) Weyhrich, C. W.; Long, T. E. Additive Manufacturing of High-performance Engineering Polymers: Present and Future. Polym. Int. 2022, 71 (5), 532-536.
(9) Hasanain, F.; Wang, Z. Y. New One-Step Synthesis of Polyimides in Salicylic Acid. Polymer (Guildf). 2008, 49 (4), 831-835.
(10) Kim, J.; Kwon, J.; Kim, S.-I.; Kim, M.; Lee, D.; Lee, S.; Kim, G.; Lee, J.; Han, H. One-Step Synthesis of Nano-Porous Monolithic Polyimide Aerogel. Microporous Mesoporous Mater. 2016, 234, 35-42.
(11) Aristizábal, S. L.; Habboub, O. S.; Pulido, B. A.; Cetina-Mancilla, E.; Olvera, L. I.; Forster, M.; Nunes, S. P.; Scherf, U.; Zolotukhin, M. G. One-Step, Room Temperature Synthesis of Well-Defined, Organo-Soluble Multifunctional Aromatic Polyimides. Macromolecules 2021, 54 (23), 10870-10882.
(12) Yao, H.; Zhang, N.; Song, N.; Shen, K.; Huo, P.; Zhu, S.; Zhang, Y.; Guan, S. Microporous Polyimide Networks Constructed through a Two-Step Polymerization Approach, and Their Carbon Dioxide Adsorption Performance. Polym. Chem. 2017, 8 (8), 1298-1305.
(13) Inoue, H.; Sasaki, Y.; Ogawa, T. Comparison of One-Pot and Two-Step Polymerization of Polyimide from BPDA/ODA. J. Appl. Polym. Sci. 1996, 60 (1), 123-131.
(14) Hu, Y. B.; Li, H. G.; Cai, L.; Zhu, J. P.; Pan, L.; Xu, J.; Tao, J. Preparation and Properties of Fibre-Metal Laminates Based on Carbon Fibre Reinforced PMR Polyimide. Compos. Part B Eng. 2015, 69, 587-591.
(15) Zharinov, M. A.; Petrova, A. P.; Babchuk, I. V.; Akhmadieva, K. R. Thermally Stable Polyimide Structural Adhesives. Polym. Sci. Ser. D 2022, 15 (2), 143-149.
(16) Xie, W.; Pan, W.-P.; Chuang, K. C. Thermal Characterization of PMR Polyimides. Thermochim. Acta 2001, 367-368, 143-153.
(17) Wilson, D. PMR-15 Processing, Properties and Problems—a Review. Br. Polym. J. 1988, 20 (5), 405-416.
(18) Jones, H. W. The Recent Large Reduction in Space Launch Cost. In 48th International Conference on Environmental Systems; Albuquerque, NM, 2018.
(19) Govil, K.; Kumar, V.; Pandey, D. P.; Praneeth, R.; Sharma, A. Additive Manufacturing and 3D Printing: A Perspective; 2019; pp 321-334.
(20) Pérez, M.; Carou, D.; Rubio, E. M.; Teti, R. Current Advances in Additive Manufacturing. Procedia CIRP 2020, 88, 439-444.
(21) Herzberger, J.; Meenakshisundaram, V.; Williams, C. B.; Long, T. E. 3D Printing All-Aromatic Polyimides Using Stereolithographic 3D Printing of Polyamic Acid Salts. ACS Macro Lett. 2018, 7 (4), 493-497.
(22) Hegde, M.; Meenakshisundaram, V.; Chartrain, N.; Sekhar, S.; Tafti, D.; Williams, C. B.; Long, T. E. 3D Printing All-Aromatic Polyimides Using Mask-Projection Stereolithography: Processing the Nonprocessable. Adv. Mater. 2017, 29 (31), 1-7.
(23) Arrington, C. B.; Hegde, M.; Meenakshisundaram, V.; Dennis, J. M.; Williams, C. B.; Long, T. E. Supramolecular Salts for Additive Manufacturing of Polyimides. ACS Appl. Mater. Interfaces 2021, 13 (40), 48061-48070.
(24) García, M. G.; Marchese, J.; Ochoa, N. A. Aliphatic-Aromatic Polyimide Blends for H2 Separation. Int. J. Hydrogen Energy 2010, 35 (17), 8983-8992.
(25) Scott, P. J.; Meenakshisundaram, V.; Hegde, M.; Kasprzak, C. R.; Winkler, C. R.; Feller, K. D.; Williams, C. B.; Long, T. E. 3D Printing Latex: A Route to Complex Geometries of High Molecular Weight Polymers. ACS Appl. Mater. Interfaces 2020, 12 (9), 10918-10928.
(26) Scott, P. J.; Meenakshisundaram, V.; Chartrain, N. A.; Sirrine, J. M.; Williams, C. B.; Long, T. E. Additive Manufacturing of Hydrocarbon Elastomers via Simultaneous Chain Extension and Cross-Linking of Hydrogenated Polybutadiene. ACS Appl. Polym. Mater. 2019, 1 (4), 684-690.
(27) Sirrine, J. M.; Meenakshisundaram, V.; Moon, N. G.; Scott, P. J.; Mondschein, R. J.; Weiseman, T. F.; Williams, C. B.; Long, T. E. Functional Siloxanes with Photo-Activated, Simultaneous Chain Extension and Crosslinking for Lithography-Based 3D Printing. Polymer (Guildf). 2018, 152, 25-34.
(28) Millipore Sigma IR Spectrum Table & Chart www.sigmaaldrich.com/US/en/technical-documents/technical-article/analytical-chemistry/photometry-and-reflectometry/ir-spectrum-table.
(29) Volkov, A.; Tourillon, G.; Lacaze, P. C.; Dubois, J. E. Electrochemical Polymerization of Aromatic Amines. IR, XPS and PMT Study of Thin Film Formation on a Pt Electrode. J. Electroanal. Chem. 1980, 115 (2), 279-291.
(30) Socrates, G. Infrared and Raman Characteristic Group Frequencies: Tables and Charts, 3rd ed.; Wiley, 2004.
(31) Kim, H. K.; Ju, H. T.; Hong, J. W. Characterization of UV-Cured Polyester Acrylate Films Containing Acrylate Functional Polydimethylsiloxane. Eur. Polym. J. 2003, 39 (11), 2235-2241.
(32) Nohut, S.; Schwentenwein, M. Vat Photopolymerization Additive Manufacturing of Functionally Graded Materials: A Review. J. Manuf. Mater. Process. 2022, 6 (1), 17.
(33) Arrington, C. B.; Rau, D. A.; Williams, C. B.; Long, T. E. UV-Assisted Direct Ink Write Printing of Fully Aromatic Poly(Amide Imide) s: Elucidating the Influence of an Acrylic Scaffold. Polymer (Guildf). 2021, 212 (December 2020), 123306.
(34) Shaukat, U.; Rossegger, E.; Schlögl, S. A Review of Multi-Material 3D Printing of Functional Materials via Vat Photopolymerization. Polymers (Basel). 2022, 14 (12), 2449.
(35) Hu, J.; Tan, A. T. L.; Chen, H.; Hu, X. Superior Compressive Properties of 3D Printed Plate Lattice Mechanical Metamaterials. Int. J. Mech. Sci. 2022, 231 (March), 107586.
(36) Li, Y.; Gu, H.; Pavier, M.; Coules, H. Compressive Behaviours of Octet-Truss Lattices. Proc. Inst. Mech. Eng. Part C J. Mech. Eng. Sci. 2020, 234 (16), 3257-3269.
(37) Ling, C.; Cernicchi, A.; Gilchrist, M. D.; Cardiff, P. Mechanical Behaviour of Additively-Manufactured Polymeric Octet-Truss Lattice Structures under Quasi-Static and Dynamic Compressive Loading. Mater. Des. 2019, 162, 106-118.

### Example 2

### Incorporation of Dicarboxylate-Dimethyl Esters for Reduced Polysalt-Derived Polyimide Scaffold Content

### Abstract

Vat photopolymerization (VP) Additive Manufacturing (AM) employs the selective application of UV light to cure photo-active precursors into complex geometries with micron-scale resolution but often suffers from a limited selection of aliphatic thermoset materials that exhibit relatively poor thermal performance. Ring-opening dianhydrides with acrylate-containing nucleophiles yielded diacrylate ester-dicarboxylic acids that enabled photo-active polyimide precursors, termed polysalts, upon neutralization with an aromatic diamine in solution. Subsequent photorheology and photo-calorimetry determined that preceding polysalt solutions comprised of PMDA-HEA and a diamine contained unnecessary acrylic scaffold that will only reduce the thermomechanical performance. Replacement of the photoactive PMDA-HEA with a dialkylester reduced the acrylate content while still participating in the dicarboxylate-diammonium PI template. New polysalt solutions containing both PMDA-HEA and PMDE, termed mixed polysalts, were similarly analysed and validated long-term stability, which enabled reproducible printing of polyimide organogel intermediates with only half of the scaffold used previously. In addition, x-ray scattering of mixed polysalt derived PI across a compositional gradient elucidated a marked relationship between scaffold content and morphology. As the scaffold content decreased, the crystalline reflections sharpened and a peak characteristic of the PI interchain distance appeared, thus indicating the production of a material more morphologically similar to the desired PIs.

### Introduction

Critical aerospace, microelectronic, and defense industries demand highly performant materials to meet stringent processing and application conditions. Fully aromatic polyimides (PIs) are often employed as a result of a remarkable combination of thermal stability and mechanical strength that address challenges in these industries.¹⁻³ PIs lengthy residence as the high-performance benchmark is derived from select, desirable traits: chemical inertness, high strength, high flexibility, outstanding dielectric performance, and high durability. Conventionally, PIs are synthesized through a step-growth polyaddition using a dianhydride and diamine dissolved in a polar aprotic solvent. Widely available and structural diverse dianhydride and diamine libraries facilitate broad material properties to address the needs of emerging medical technologies, such as implantable intraneural electrodes, which demand materials with lower moisture sensitivity than traditional PMDA-ODA PI. This was accomplished using readily available monomers, biphenyltetracarboxylic dianhydride (BPDA) and p-phenylenediamine, which effectively suppressed in vivo moisture sensitivity.⁴⁻⁶ Overall, PI monomers are relatively inexpensive and synthetic difficulty is low, but rigorous processing conditions still pose a significant challenge to cost and reasonable application.

Synthetic methods for polyimides yield a macromolecular intermediate, the poly(amic acid) (PAA), which facilitates solution-based processing of PI precursors. In addition, thermal cyclodehydration of aromatic poly(amic acid) precursors results in insoluble and intractable polymers, which further complicates solution processing and limits all-aromatic polyimides to 2-dimensional (2D) form factors.⁷ The resulting rigid polymers benefit from strong intermolecular interactions, which impart remarkably high glass transition temperatures (>300 °C); however, a lack of sufficient viscous polymer flow prohibits conventional melt processing techniques. Poly(4,4′-oxidiphenylene pyromellitimide), known as DuPont's Kapton®, is a commercially available as fully aromatic PI films and tapes. Conversely, Vespel® enables molded 3D objects; however, geometric complexity is relatively low and are limited to extrusions of simple shapes, which require extreme temperatures and pressures during processing. Thus, light-based additive manufacturing of PIs has generated substantial recent research efforts resulting from high demand for more complex micron-scale geometries.⁸

Conventional syntheses for soluble poly(ether imides) (PEI) utilize a single-step poly(amic acid) formation and subsequent imidization in solution as opposed to the two-step method typically for all-aromatic PIs, which requires poly(amic acid) formation in solution followed by casting and chemical/thermal cyclodehydration.⁹⁻¹³ Earlier polyamide literature provided the foundation for an unconventional route for polyimide synthesis, termed polymerization of monomeric reagents (PMR). PMR employed supramolecular dicarboxylate-diammonium interactions between aromatic diamines and the dialkylester from an aromatic tetracarboxylic acid, often provided through the nucleophilic attack of the anhydrides with methanol.¹⁴⁻¹⁶

Of the various additive manufacturing (AM) methodologies, vat photopolymerization (VP) processes benefit from a complement of exceptional printing speed, the finest feature resolution, and surface finish of all 3D printing techniques. Precise UV irradiation control coupled with analytical models to predict the cured layer profile affords the highest accuracy of all AM methods and, thus, enables fabrication of exceptionally complex geometries. Through this technology, light weighting of conventional solid objects, which minimizes material use (and later, material waste), exemplifies the sustainability tenets displayed through AM. Although VP first emerged in 1983, the primary application of VP remains limited to prototyping and tooling for casting and thermoforming due to its inadequate material catalog.^{17,18} Advances in dual cure printing chemistries (i.e., photocuring is used to establish the printed shape and a post-process cure is used to set final part properties), the application space has expanded to printing end-use products for textile and transportation applications. However, due to its reliance on a photocurable moiety, often acrylates or methacrylates, and a corresponding aliphatic oligomer, even the most recent resins exhibit restricted thermomechanical performance.

The authors' prior works developing AM of all-aromatic polyimides employed macromolecular photoactive polyimide precursors with an entirely covalent main chain bonding, i.e., poly(amic diacrylate ester) s (PADE) or a partially covalent system, poly(amic acid) pendant salts (PAAS).^{19,20} As the recoating step is mass transport limited, the low solution viscosity requirement for VP (i.e., ~10 Pa·s) restricted previous macromolecular photo-reactive solutions to less than 30 wt. % solids. The printed organogels exhibited high levels of isotropic shrinkage (~50%) during post-processing thermal imidization as a result of the low solid content. However, new printable polysalt polyimide precursors, are disclosed from our laboratories comprised of PMDA-ODA and PMDA-DDS.²¹ In this approach the polyimide precursor self-assembled in the post-process, whereas in the previous PADE and PAAS techniques the printed organogel contained the PAA PI precursors. The polysalts employ a photo-active diacrylate ester. PI polysalt precursors enabled AM of fully aromatic PIs using an acrylic scaffold with dicarboxylate-diammonium ionic bonds templating the thermally induced PI polymerization. Subsequent thermal treatment facilitated the formation of PI/acrylate composites that display thermomechanical properties closely resembling those of the legacy PMDA-ODA control. However, the thermomechanical performance of the preceding compositions were limited by high incorporation of acrylic scaffold.

Preceding polysalt solutions exhibited photorheological properties amenable to VP and thus, provided a facile route for the AM of highly complex structures. However, the plateau storage modulus (G′) of the polysalts far exceeded the modulus requirement for VP. As the acrylic scaffold displays lesser thermomechanical performance than the PI, it's sole use is to impart photo-crosslinkability, and thus, printability. Further understanding of the acrylic scaffold content's relationship with resultant photokinetics and organogel moduli provided an avenue for removal of unnecessary scaffold while maintaining requisite photocuring. This disclosure provides fundamental insight into polysalt solutions, isolates the effect of acrylate content, and describes a method for printing parts with higher PI content than previously employed polysalt solutions. Photo-rheology and photo-calorimetry revealed the relationship between PMDA-HEA concentration and various photochemical attributes. Substitution of the photopolymerizable diacrylate, PMDA-HEA, with a dialkylester, dicarbomethoxy terephthalic acid (PMDE), afforded polysalt solutions with varied chemical composition, photo-curing profiles, and printability.²² These new polysalt compositions enabled facile printing of complex structures comprised of half of the acrylic content of previously reported polysalt solutions. This expanded the compositional library for AM of all-aromatic polyimides and provides a route for higher PI content of printed polysalt derived PIs.

### Materials and Methods

### Materials

Pyromellitic dianhydride (PMDA) (Acros; purity, >99%), 4,4′-diaminodiphenyl sulfone (DDS) (Aldrich; purity, 97%) were sublimed immediately prior to use. Diphenyl(2,4,6-trimethylbenzoyl)phosphine oxide (TPO) (TCI, purity, >98%), 2-hydroxyethyl acrylate (Acros Organics; purity, 97%, stabilized), deuterated dimethyl sulfoxide (DMSO-d₆) (Thermo Scientific, 99.5%), hydrochloric acid (Fisher Chemical, certified ACS), anhydrous dimethyl sulfoxide (DMSO) (Acros Organics, 99.7+%, extra dry over molecular sieves), anhydrous methanol (Acros Organics, 99.8%, extra dry, SC) were used as received. Triethylamine (TEA) was distilled and stored over activated molecular sieves (3 Å).

### Analytical Methods

¹H nuclear magnetic resonance (NMR) spectroscopy was performed in DMSO-d₆ on a Bruker Avance NEO at 500 MHz (23 °C) with a 5 mm iProbe. Photo-rheological experiments were performed on a TA Instruments DHR-3 at 25 °C. These measurements were made on a Smart Swap™ geometry with an Omnicure® S2000 high-pressure mercury light source with a 320-500 nm filter, 20 mm disposable aluminum parallel plate, and a 20 mm quartz parallel plate lower geometry with a 500 μm gap. UV irradiance intensity as measured using a Silverline radiometer with a 20 mm attachment. Measurement parameters were set with a sampling frequency of 1 Hz, 0.1% strain, and 250 mW·cm⁻² UV irradiance. The samples were exposed to UV light 30 s into the experiment for 15 s. The data was analyzed using the TA Instruments TRIOS software to identify the storage modulus (G′), loss modulus (G″), and crossover time. Photocalorimetry was performed with a TA instruments DSC 2500 coupled with a PCA and an Omnicure® S2000 high-pressure mercury light source with a 320-500 nm filter at 100 mW/cm². In situ FTIR spectroscopic experiments were performed with a Mettler Toledo React IR-15 with a Si composite probe, 3 min resolution, and 128 scans.

### Synthesis of Acrylate Ester Dicarboxylic Acid (PMDA-HEA)

Pyromellitic dianhydride (100 g, 0.4585 mol) and 2-hydroxyethyl acrylate (200 mL, 1.741 mol), and triethylamine (8.26 mL, 0.05929 mol) were added to a flame-dried two-neck, round-bottomed flask fitted with a glass mechanical stir rod with a Teflon™ paddle. The heterogenous solution was submerged in an oil bath heated to 50 °C for 3 h. The resulting solution was poured into 1 M HCl (4 L) and allowed to stir for 1 h. The product was then stirred in deionized water (4 L) for 1 h before the white, tacky solid was collected in a fritted glass funnel and allowed to dry for 18 h. This material was dried in vacuo at 40 °C for 18 h. The overall yield was 72%, 1H NMR (400 MHz, DMSO-d₆) δ 13.85 (s, 2H), 8.11 (s, 1H), 8.01 (s, 1H), 7.91 (s, 1H), 6.35 (dd, 4H, J=17.4, 1.6 Hz), 6.18 (dd, 4H, J=17.4, 10.4 Hz), 5.95 (dd, 4H, J=10.4, 1.6 Hz), 4.46 (m, 16H).

### Synthesis of Dicarbomethoxy Terephthalic Acid (PMDE)

Pyromellitic dianhydride (100 g, 0.4585 mol), anhydrous methanol (69.6 mL, 1.719 mol), and triethylamine (8.26 mL, 0.05929 mol) were added to a flame-dried two-neck, round-bottomed flask fitted with a glass mechanical stir rod with a Teflon™ paddle. The heterogenous solution was submerged in an oil bath heated to 50 °C for 3 h. The resulting solid was dried in vacuo at 25 °C for 18 h. The isomeric mixture was calculated as 87% para and 13% meta. 1H NMR (400 MHz, DMSO-d₆) δ 13.82 (s, 4H), 8.10 (s, 1H), 8.00 (s, 2H), 7.93 (s, 1H), 3.84 (s, 12H).

### Formation of Photo-Active Mixed Polysalt

For a 50 wt. % solids solution of 1:1 PMDA-HEA: PMDE, the diamine, DDS (11.03 g, 0.044 mol) and anhydrous DMSO (27.29 g) was weighed into a 50 mL round-bottomed flask fitted with a glass mechanical stir rod with a Teflon™ paddle. The mixture was allowed to stir until the DDS was fully dissolved. PMDA-HEA (10.00 g, 0.022 mol) and PMDE (6.27 g, 0.022 mol) was then added and allowed to stir until fully dissolved. Lastly, TPO (0.699 g, 0.002 mol) was added and stirred until full dissolution while covered with aluminum foil to protect from ambient light.

### Small-Angle X-Ray Scattering (SAXS)

Small, mid, and wide-angle X-ray scattering (SAXS/MAXS/WAXS) experiments were performed on a Xenocs Xeuss 3.0 SAXS/WAXS equipped with a GeniX 3D Cu HFVLF microfocus X-ray source utilizing Cu K-a radiation (λ=0.154 nm). The samples characterized were photorheology disks post-processed to 400 °C with thicknesses ranging from 0.5 mm to 1.0 mm. All data was collected at ambient temperature. The sample-to-detector distance was 43 mm for WAXS, 370 mm for MAXS, and 900 mm for SAXS, and the q-range was calibrated using lanthanum hexaboride and silver behenate standards. Two-dimensional scattering patterns were obtained using a Dectris EIGER 4M detector with various exposure times (SAXS: 2 hours, MAXS: 1 hour, WAXS: 30 minutes). Data reduction was performed using XSACT software provided by Xenocs, and the 1D profiles were corrected for sample thickness, background, and transmission. The SAXS, MAXS, and WAXS profiles were merged into one dataset and plotted on an absolute intensity scale vs. the scattering vector, q.

### Vat Photopolymerization Additive Manufacturing

An ASIGA MAX X bottom-up mask projection VP system was used to fabricate three dimensional parts with various mixed polysalt resin formulations. This system was equipped with a 385 nm UV LED capable of outputting 21 mW/cm² max irradiance. A working curve experiment was conducted to select the appropriate UV dose to cure 100 μm layers. The first layer of each print was irradiated for 2-3 times the subsequent layers to promote build plate adhesion. The minimum system travel speed of 0.15 mm/sec was used for separation and approach moves to avoid disturbing previous layers. Following printing, parts were dried in ambient conditions until no tack remains. Parts were then thermally imidized in a vacuum oven to 100, 150, 200, and 250 °C for 1 h each. The working curve for each resin was developed by measuring the height of cured profiles when exposed to 385 nm UV light at an irradiance of 20 mW/cm² for various exposure times. These working curves were used to calculate a penetration depth (Dₚ) and a critical exposure (E_{c}) for each formulation. For example, PMDA-HEA/DDS 50 wt. % mixed polysalt at 40 wt. % loading in DMSO was measured to have a Dₚ of 0.147 mm and an E_{c} of 6.87 mJ/cm² indicating an optimal exposure of 13.54 mJ/cm² to cure a 100 μm layer or 677 ms exposure time at 20 mW/cm² irradiance. In addition, lattice structures were printed for subsequent compression testing using an EnvisionTEC EnvisionOne cDLM printer with 100 μm layers, 25 s burn-in time for the first 5 layers, and 5 s exposure for all remaining layers.

### Results and Discussion

Synthesis of a diacrylate ester-dicarboxylic acid provided the foundation for the polysalt platform. An organic base-catalyzed, ring-opening of a dianhydride with 2-hydroxyethyl acrylate afforded the photopolymerizable diacrylate component, termed PMDA-HEA, as shown in Scheme 4.

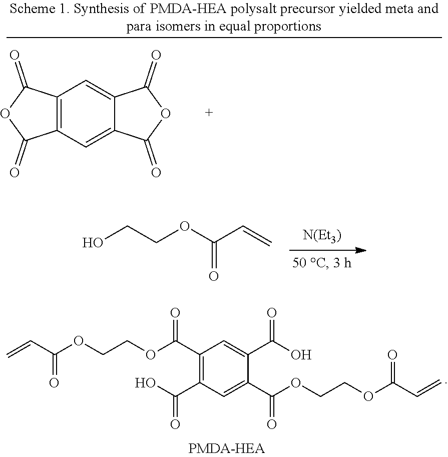

Polysalt solutions entirely comprised of PMDA-HEA and DDS exhibited excellent photocuring kinetics, which facilitated facile 3D printing of supramolecular polyimide precursors. However, the plateau G′ exceeded the organogel stiffness required for multilayer AM. Incorporating non-acrylated dimethoxy-diacids, PMDE, retained the requisite polyimide precursor structure and eliminated unnecessary acrylic scaffold. PMDE was synthesized with a one-pot method for the ring-opening of PMDA with methanol, as shown in Scheme 5.

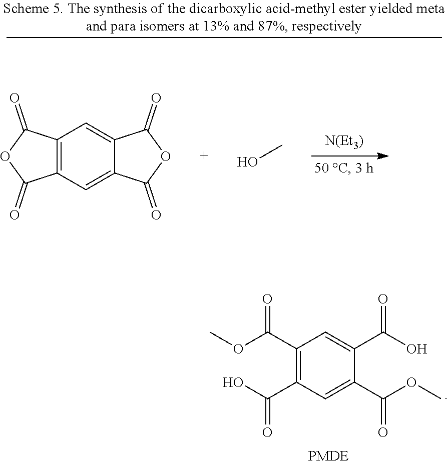

Mixtures of PMDA-HEA and PMDE were neutralized at varied stoichiometric ratios with an aromatic amine, DDS, and the ensuing diammonium-dicarboxylate electrostatic interaction provided the mixed polysalt structure, as shown in Scheme 6. Following discussion will refer to mixed polysalt solutions in terms of their PMDA derivative content, i.e., a solution of 40 mol. % PMDA-HEA, 10 mol. % PMDE, and 50 mol. % DDS is termed 80% PMDA-HEA.

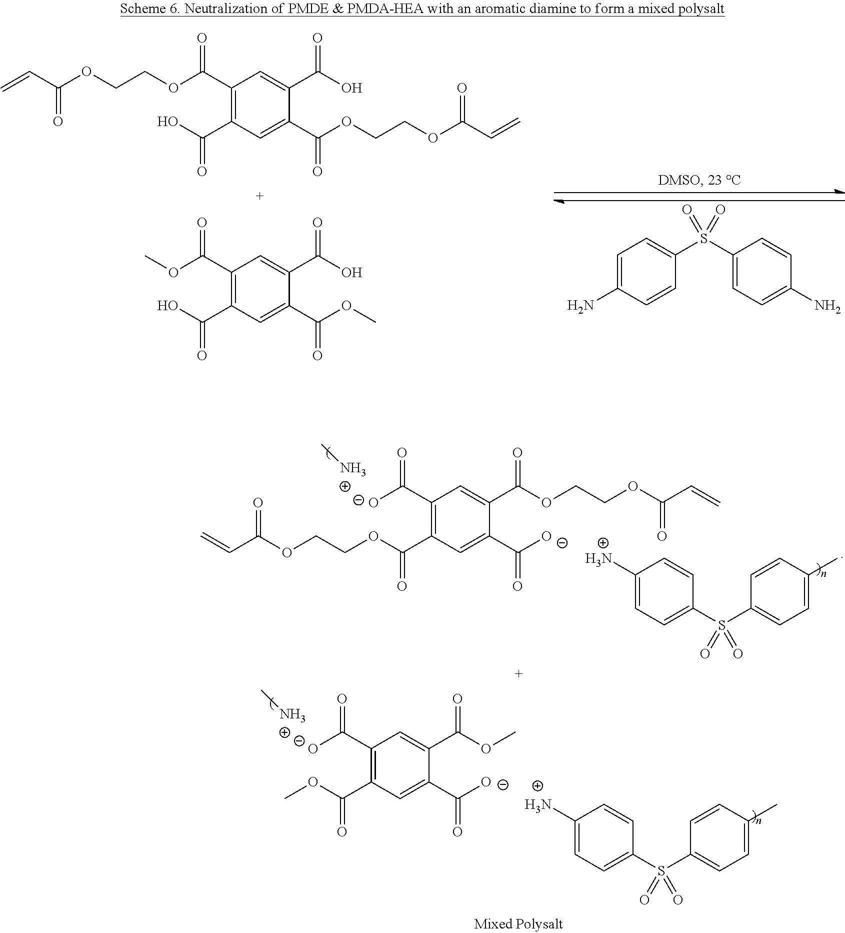

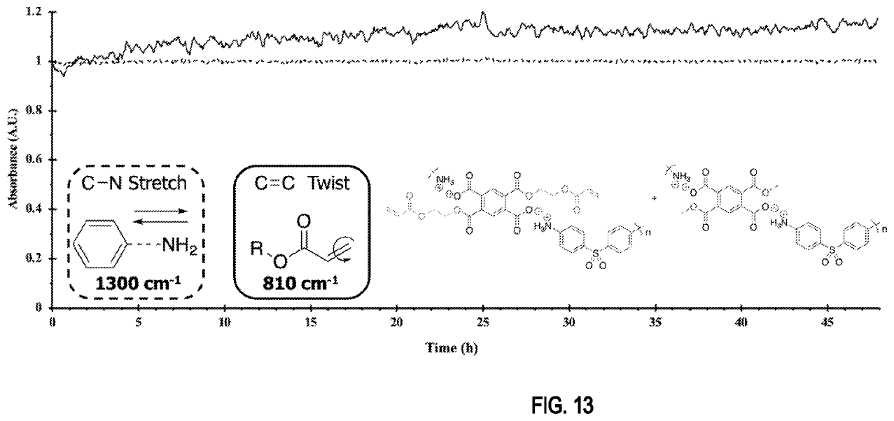

Previous research detailed the preparation of PMDA-ODA polysalt solutions, which further analysis indicated temporally unstable from an unintended aza-Michael addition. Substitution of the electron rich ODA with the electron poor DDS effectively prohibited this degradation mechanism, thus providing stable polysalt solutions with increased shelf life. The PMDA-HEA/DDS compositions were employed for the production of mixed polysalts as their solution stability provides simplified analysis. In addition, the preceding solutions utilized only PMDA-HEA and photorheological analysis demonstrated excessive scaffold content as plateau G′ values surpassed 1×10⁶. Fully aromatic polyimides and polyacrylates are on opposite end of the thermomechanical spectrum and thus, printing parts with higher polyimide content will provide more performant materials. This was tested using multiple mixed polysalt solutions with a compositional range for subsequent analysis. As the degradation proceeded through a reaction with the acrylate and amine, mixed polysalts were expected to display the same stability of PMDA-HEA/DDS polysalt solutions. In situ FTIR spectroscopy, shown in FIG. 13, exhibited the inherent stability provided by the electron-withdrawing sulfone is extended to the mixed polysalt system.

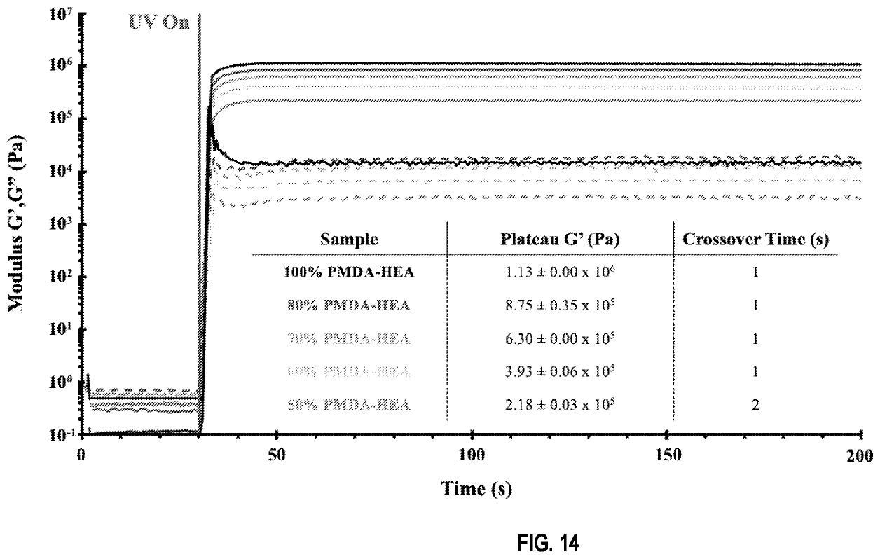

Photorheological analysis indicated an inverse relationship between acrylate content and mixed polysalt derived organogel plateau storage modulus (G′), shown in FIG. 14. From this, it is apparent that the photocuring kinetics remain relatively unchanged as G′/G″ crossover times only increased by one second with half of the scaffold-containing monomer, PMDA-HEA, replaced with PMDE. In addition, all mixed polysalt compositions displayed photorheological properties amenable to VP, which provides an avenue for complex fully aromatic polyimide structures with less polyacrylate filler.

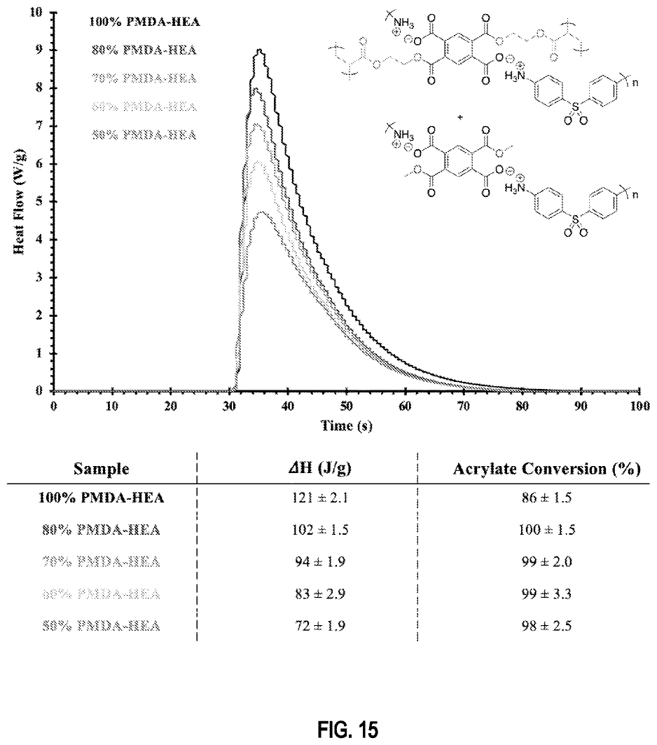

Further assessment of the compositional effect on photo-curing was conducted using a DSC photo-calorimetry attachment. This technique elucidated the relative acrylate conversation of the photo-initiated free radical polymerization using literature values for the heat of polymerization (ΔH_{r×n}) for acrylate homopolymerization (86 kJ mol⁻¹). From this, it was apparent that all compositions, except for 100% PMDA-HEA solutions, displayed complete conversion to polyacrylate, shown in FIG. 15. Solutions comprised of 100% PMDA-HEA reach the gel point before full acrylate conversion, which further evidences the excessive amount of crosslinker present in previously studied 100% PMDA-HEA polysalt solutions.

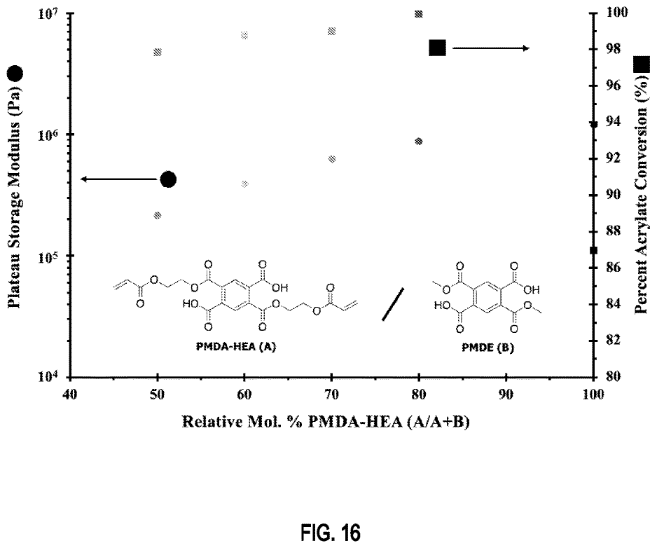

The complement of photorheology and photo-calorimetry provided strong evidence for the benefits offered through the replacement of PMDA-HEA with non-acrylated PMDE. Plotting the results of both experimental methods provide a clear representation of this, as shown in FIG. 16. Reducing the amount of PMDA-HEA in the polysalt solutions provided an avenue for plateau G′ control with all solution compositions exceeding the VP prerequisite 105 Pa. However, conversion remained constant at ~99% across mixed polysalt solutions until 100% PMDA-HEA, which exhibited only 87% acrylate conversion. The lower acrylate conversion of the 100% PMDA-HEA polysalt solutions arises from the rapid formation of the crosslinked gel, which then prohibits acrylate diffusion upon vitrification. Remaining unsaturation in printed organogels pose a significant risk of detrimental side reactions during the thermal post-processing to the final polyimide structure. Substantial literature precedent confirmed the thermal polymerization of acrylates and methacrylates across a temperature range of 100-160 °C, which is exceeding during the thermally induced cyclodehydration steps. Residual unreacted acrylated will form radicals during these steps and uncontrolled radicals can convolute the resulting part chemical composition through radical chain transfer events.

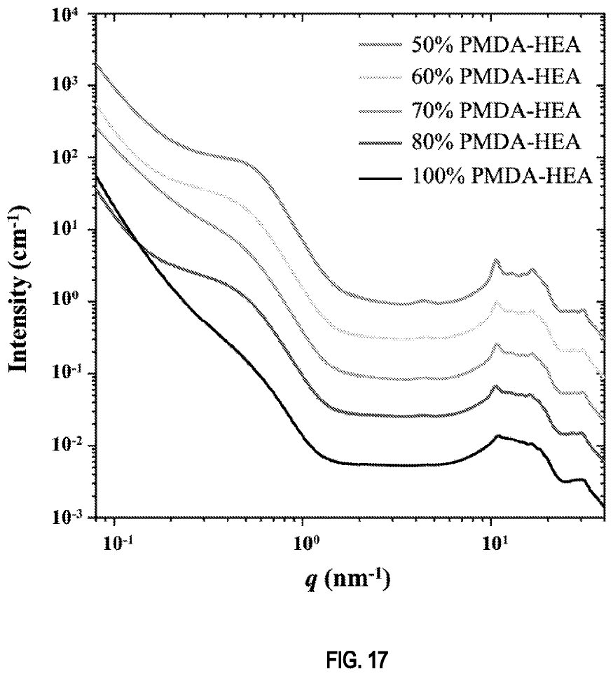

To investigate the effects of the mixed polysalt composition on the resulting polyimide structure, SAXS, MAXS, and WAXS of polyimides prepared from the mixed polysalt solutions were analyzed. The merged SAXS/MAXS/WAXS profiles of polyimides prepared from mixed polysalt solutions ranging from 50% PMDA-HEA to 100% PMDA-HEA are presented in FIG. 17. In the wide-angle region of the scattering profiles (5<q<40 nm⁻¹), the diffraction patterns of the polyimides show crystalline reflections that increase in sharpness with decreasing PMDA-HEA content. This trend indicates that the crystalline order of polyimides increases with decreasing acrylic scaffold content, as the precursor has more polyimide character. In the mid-angle region (2 nm⁻¹<q<8 nm⁻¹) of the scattering profiles, a characteristic scattering peak centered around q≈4 nm⁻¹ begins to appear with decreasing scaffold content. This peak is known to arise from spatial correlations along the polyimide chain axis.²³ Thus, its emergence in polyimides derived from less scaffold further indicates that polyimides prepared with less acrylic scaffold have more ordered polyimide morphologies. Finally, the scattering profiles of all polyimides exhibit a knee-like feature in the small-angle region centered around q≈0.5 nm⁻¹, which is indicative of spatial correlations between crystallites.²⁴ This feature is sharpest in the 50% PMDA-HEA polyimide and broadens with PMDA-HEA content. This reveals that the increased crystalline order in the mixed polysalt-derived polyimides is preserved on longer length scales as well.

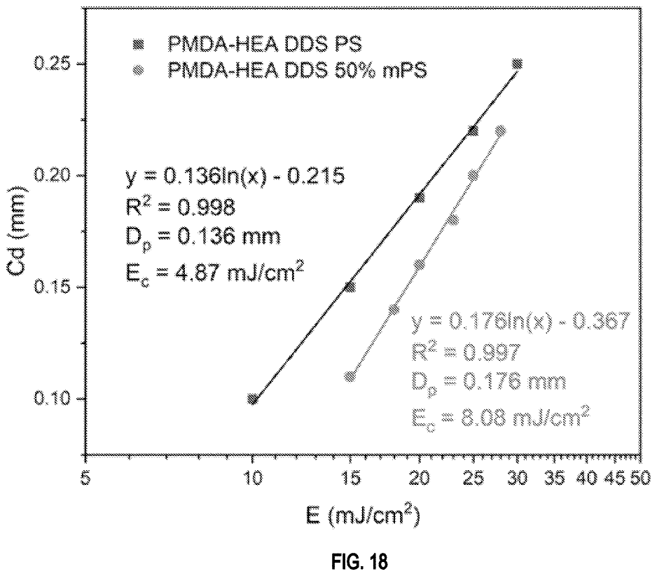

Prior to printing a new resin, a working curve was developed to characterize the relationship between UV exposure and the resulting cured gel thickness. As shown in FIG. 18, the working curve for the mixed polysalt resin was steeper and shifted to the right when compared with its fully acrylate functionalized counterpart. This indicated that the removal of acrylate in the mixed polysalt system resulted in a resin with higher Dₚ and E_{c}. As the removal of the acrylate functionality resulted in an increase in the minimum energy needed to cure a film (higher E_{c}) as well as reduced the ability of that resin to attenuate UV irradiance (higher Dₚ). Furthermore, the working curves for these two resins indicated that at 20 mW/cm², the cure times for a 100 μm layer can be 507 ms and 710 ms for the polysalt and 50% mixed polysalt resins respectively. As acrylate content in the resin is reduced, the cure time at the same irradiance increased. However, it is noted that even at 50% PMDA-HEA mixed polysalt, the cure time is well within the threshold for fast production of parts via VP.

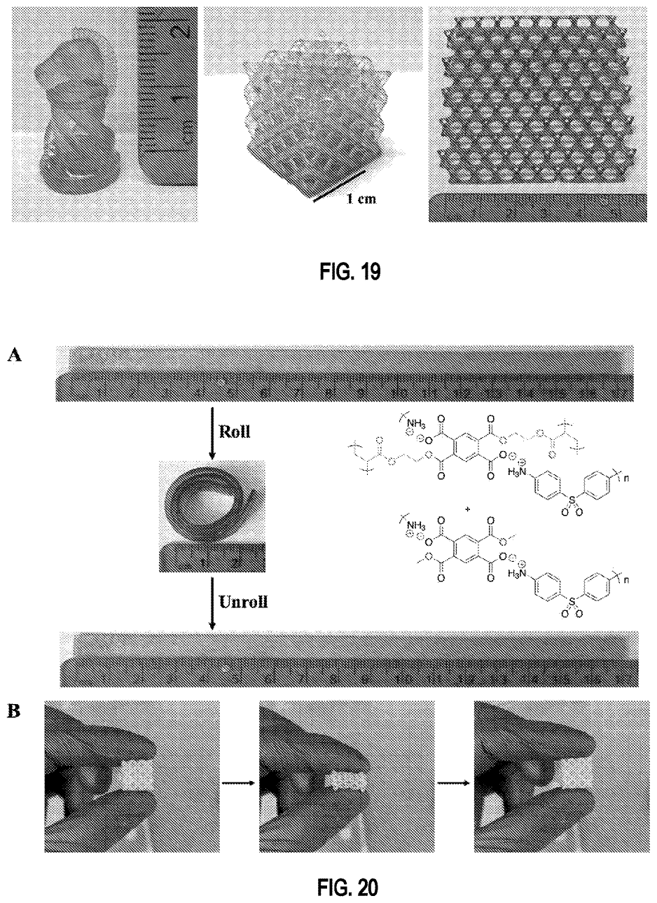

A commercial VP system printed solid models to demonstrate the printability of the mixed polysalt resins with representative organogels shown in FIG. 19. As the mixed polysalt solutions exhibited fast G′/G″ crossover times with substantial plateau G′ values, 3D printed was readily achieved without the need for custom-built VP systems. In addition, printing the same octet lattices previously printed with 100 PMDA-HEA polysalt solutions showcased the ability of the mixed polysalts to produce unsupported organogel structures with half of the acrylic scaffold of preceding polysalts.

Interestingly, mixed polysalt derived organogels displayed exceptional pliability once dried in ambient conditions until no tack remained. A 17 cm rectangle was printed, dried, and once in this state, rolled and unrolled to exhibit this property, as shown in FIG. 20.

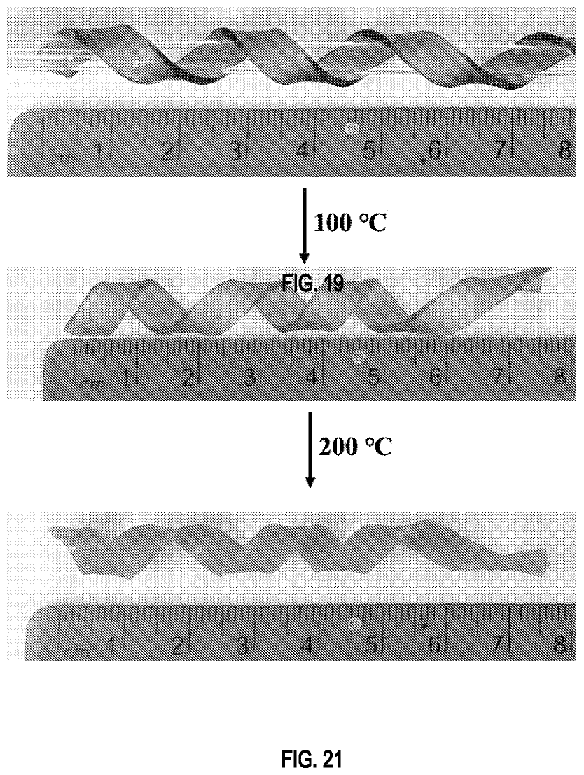

From this, it was apparent that mixed polysalts provided an avenue for the production of moldable polyimide precursors. Specifically, this approach leveraged the complement of facile processing afforded through VP and room temperature flexibility of the dried organogel to fabricate fully aromatic materials shaped to a substrate. To exemplify this, the rectangular sample was wrapped around a glass tube and subjected to the conventional imidization thermal post-processing. This process produced a helical polyimide structure programmed exclusively through the geometry of the chosen substrate, as shown in FIG. 21.

The additional benefits, i.e., organogel flexibility, imparted through the reduction of acrylic scaffold enabled the production of moldable polyimide precursors. With the complement of AM, complex structures were accessible using mixed polysalt solutions and provided a diverse set of structures that can be printed and subsequently molded to the desired shape. This approach showed potential for the fabrication of high-performance encapsulants for electronics that were previously inaccessible using conventional methods and the fully acrylated polysalt solutions.

### Conclusions

Resulting from high aromatic content and a characteristic lack of viscous flow, all-aromatic polyimides pose considerable processing challenges. This disclosure describes the preparation of a new polysalt composition, which replaced non-essential acrylate-bearing monomer with a radical unreactive analogue, PMDE. Previous compositions exhibited excellent photoreactivity, well-defined printing, and facile conversion from the polyacrylate green body to the final PI structure. However, previous solutions employed PMDA-HEA for all of the anhydride PI monomer, which provided unnecessarily high plateau G′ and indicated overuse of the scaffold. The mixed polysalt systems described herein provide a new approach to printable polysalts that produced high resolution 3D prints that mirror those of the preceding systems. However, further analysis indicated that mixed polysalts provided a host of benefits: higher acrylate conversation, morphologies more representative of legacy PIs, and flexible organogels. Traditionally, PI films are used to encapsulate electronics in order to shield them from radiation. The inherent pliability afforded by mixed polysalt organogels offers a new route for functional materials shaped specifically to the application.

### REFERENCES CITED IN THIS EXAMPLE

(1) Kausar, A. Holistic Insights on Polyimide Nanocomposite Nanofiber. Polym. Technol. Mater. 2020, 59 (15), 1621-1639.
(2) Govindaraj, B.; Sarojadevi, M. Microwave-Assisted Synthesis of Nanocomposites from Polyimides Chemically Cross-Linked with Functionalized Carbon Nanotubes for Aerospace Applications. Polym. Adv. Technol. 2018, 29 (6), 1718-1726.
(3) Simpson, J. O.; St. Clair, A. K. Fundamental Insight on Developing Low Dielectric Constant Polyimides. Thin Solid Films 1997, 308-309 (1-4), 480-485.
(4) Ordonez, J.; Schuettler, M.; Boehler, C.; Boretius, T.; Stieglitz, T. Thin Films and Microelectrode Arrays for Neuroprosthetics. MRS Bull. 2012, 37 (6), 590-598.
(5) Sun, Y.; Lacour, S. P.; Brooks, R. A.; Rushton, N.; Fawcett, J.; Cameron, R. E. Assessment of the Biocompatibility of Photosensitive Polyimide for Implantable Medical Device Use. J. Biomed. Mater. Res. Part A 2009, 90A (3), 648-655.
(6) Georgiev, A.; Dimov, D.; Spassova, E.; Assa, J.; Dineff, P.; Danev, G. Chemical and Physical Properties of Polyimides: Biomedical and Engineering Applications. In High Performance Polymers-Polyimides Based—From Chemistry to Applications; InTech, 2012.
(7) Polyimides; Wilson, D., Stenzenberger, H. D., Hergenrother, P. M., Eds.; Springer Netherlands: Dordrecht, 1990.
(8) Weyhrich, C. W.; Long, T. E. Additive Manufacturing of High-performance Engineering Polymers: Present and Future. Polym. Int. 2022, 71 (5), 532-536.
(9) Hasanain, F.; Wang, Z. Y. New One-Step Synthesis of Polyimides in Salicylic Acid. Polymer (Guildf). 2008, 49 (4), 831-835.
(10) Kim, J.; Kwon, J.; Kim, S.-I.; Kim, M.; Lee, D.; Lee, S.; Kim, G.; Lee, J.; Han, H. One-Step Synthesis of Nano-Porous Monolithic Polyimide Aerogel. Microporous Mesoporous Mater. 2016, 234, 35-42.
(11) Aristizábal, S. L.; Habboub, O. S.; Pulido, B. A.; Cetina-Mancilla, E.; Olvera, L. I.; Forster, M.; Nunes, S. P.; Scherf, U.; Zolotukhin, M. G. One-Step, Room Temperature Synthesis of Well-Defined, Organo-Soluble Multifunctional Aromatic Polyimides. Macromolecules 2021, 54 (23), 10870-10882.
(12) Yao, H.; Zhang, N.; Song, N.; Shen, K.; Huo, P.; Zhu, S.; Zhang, Y.; Guan, S. Microporous Polyimide Networks Constructed through a Two-Step Polymerization Approach, and Their Carbon Dioxide Adsorption Performance. Polym. Chem. 2017, 8 (8), 1298-1305.
(13) Inoue, H.; Sasaki, Y.; Ogawa, T. Comparison of One-Pot and Two-Step Polymerization of Polyimide from BPDA/ODA. J. Appl. Polym. Sci. 1996, 60 (1), 123-131.
(14) Hu, Y. B.; Li, H. G.; Cai, L.; Zhu, J. P.; Pan, L.; Xu, J.; Tao, J. Preparation and Properties of Fibre-Metal Laminates Based on Carbon Fibre Reinforced PMR Polyimide. Compos. Part B Eng. 2015, 69, 587-591.
(15) Zharinov, M. A.; Petrova, A. P.; Babchuk, I. V.; Akhmadieva, K. R. Thermally Stable Polyimide Structural Adhesives. Polym. Sci. Ser. D 2022, 15 (2), 143-149.
(16) Xie, W.; Pan, W.-P.; Chuang, K. C. Thermal Characterization of PMR Polyimides. Thermochim. Acta 2001, 367-368, 143-153.
(17) Govil, K.; Kumar, V.; Pandey, D. P.; Praneeth, R.; Sharma, A. Additive Manufacturing and 3D Printing: A Perspective; 2019; pp 321-334.
(18) Perez, M.; Carou, D.; Rubio, E. M.; Teti, R. Current Advances in Additive Manufacturing. Procedia CIRP 2020, 88, 439-444.
(19) Herzberger, J.; Meenakshisundaram, V.; Williams, C. B.; Long, T. E. 3D Printing All-Aromatic Polyimides Using Stereolithographic 3D Printing of Polyamic Acid Salts. ACS Macro Lett. 2018, 7 (4), 493-497.
(20) Hegde, M.; Meenakshisundaram, V.; Chartrain, N.; Sekhar, S.; Tafti, D.; Williams, C. B.; Long, T. E. 3D Printing All-Aromatic Polyimides Using Mask-Projection Stereolithography: Processing the Nonprocessable. Adv. Mater. 2017, 29 (31), 1-7.
(21) Arrington, C. B.; Hegde, M.; Meenakshisundaram, V.; Dennis, J. M.; Williams, C. B.; Long, T. E. Supramolecular Salts for Additive Manufacturing of Polyimides. ACS Appl. Mater. Interfaces 2021, 13 (40), 48061-48070.
(22) Garcia, M. G.; Marchese, J.; Ochoa, N. A. Aliphatic-Aromatic Polyimide Blends for H2 Separation. Int. J. Hydrogen Energy 2010, 35 (17), 8983-8992.
(23) Muto, K.; Fujiwara, E.; Ishige, R.; Ando, S. Analysis of Pressure-Induced Variations in the Crystalline Structures of Polyimides Having Flexible Linkages by Wide-Angle X-Ray Diffraction. J. Photopolym. Sci. Technol. 2020, 33 (5), 583-590.
(24) Ania, F.; Cagiao, M. E.; Baltá Calleja, F. J. Density Fluctuations as Precursors of Crystallization in a Thermoplastic Polyimide. Polym. J. 1999, 31 (9), 735-738.

### Example 3

### Fabrication of Copolysalt PI Precursors

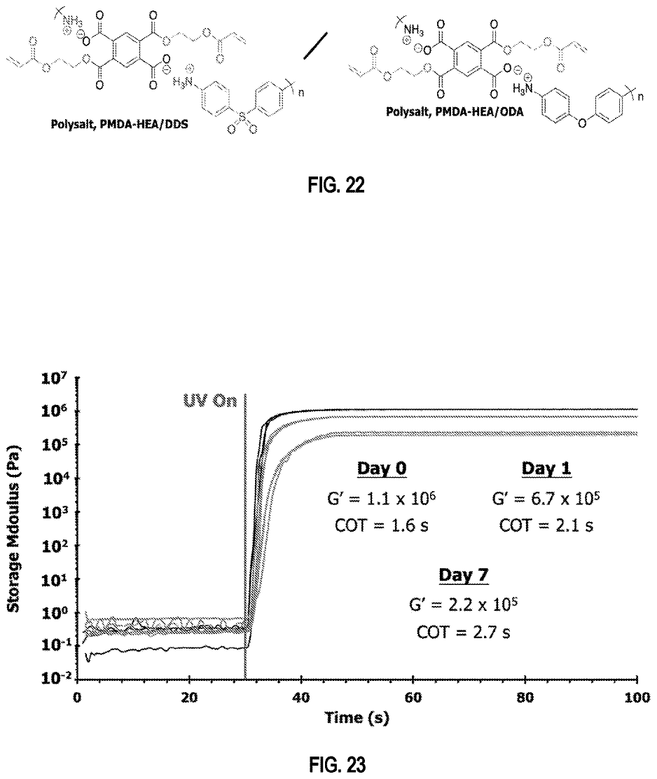

While the mixed polysalts described herein utilized the addition a third compound to enhance the processing and provide higher final PI content, the dianhydride was the single component with multiple derivatives present. As PI synthesis demands only a dianhydride and diamine, and in the case of a polysalt, a dicarboxylic acid and diamine, solutions comprised of multiple aromatic amines are also assessable. Like other polymer families, PIs benefit from copolymerization with varied monomer structure to enable tunable material properties.¹²⁻¹⁷ PMDA-500DA-50DDS (1 equivalent PMDA-HEA, 0.5 equivalent ODA, and 0.5 equivalents DDS) copolyimides displayed distinct advantages over a host of other homo- and copolymers for aqueous/organic mixture seperations.¹⁸ PMDA-ODA is often touted as the pinnacle of HPPs due to its excellent thermal, dielectric, and mechanical properties. However, there can be unintended and deleterious side reactions that occur when PMDA-ODA is synthesized using the polysalt approach and how controlled amine nucleophilicity prohibits the Aza-Michael addition.¹⁹ The new polysalts described served as a precursor for an understudied and mostly unknown analogue, PMDA-DDS, which upon analysis of a PAA-derived PMDA-DDS control, exhibited excellent thermomechanical properties with a T_{g}>400 °C. However, PMDA-ODA, known commercially at Kapton, is a legacy material used across a multitude of industries. As used herein, the term copolysalt can refer to polysalts that include more than one aromatic diamine, for example, ODA and DDS, with the copolysalt composition depicted in FIG. 22.

Experiments within the investigation of copolysalt solution temporally stability elucidated time-dependent photo-kinetics, as the electron rich ODA diamine will still participate in the Aza-Michael addition to the PMDA-HEA. FIG. 23 showcases the results of photorheological analysis, where the solutions maintain G′>10⁵ after seven days of aging in solution, which is >8 orders of magnitude higher than that of ODA polysalt solutions after just five days of aging. In addition, the increase in crossover time further indicates acrylate consumption during the Aza-Michael degradation process.

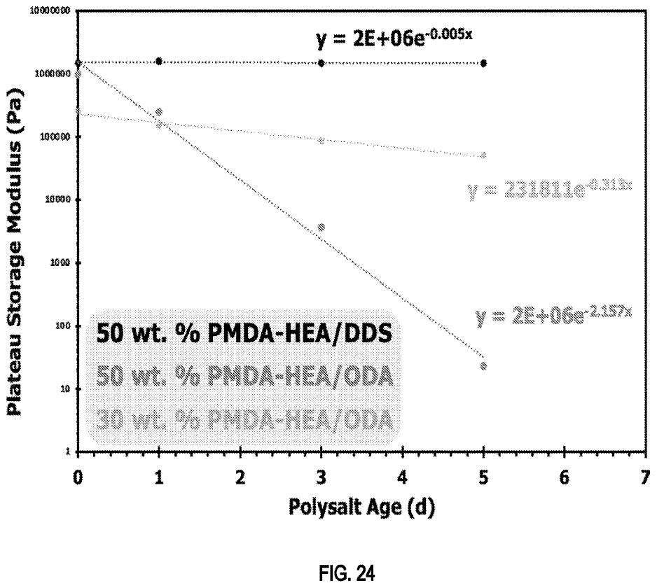

Plotting the plateau G′ of polysalt solutions as a function of age provides the rate of G′ decline over time, which is a measure of network formation, and thus, and indirect analysis of degradation rate in terms of VP amenability, shown in FIG. 24. From this, it is apparent that DDS polysalts lack the relevant degradative mechanism that is the source of the steep G′ decline present in the ODA polysalt solutions.

Plotting the same data with the 50/50 DDS/ODA copolysalt solutions provides insight into the benefits of a copolysalt system, shown in FIG. 24. Interestingly, copolysalt solutions with half the ODA of ODA polysalt solutions display a G′ rate of −0.213 d⁻¹, which is ~10 times lower than that of ODA polysalts. As the Aza-Michael addition consumes both acrylates and ODA amines, it was expected that the degradation rate share a linear relationship with the concentration of ODA in the copolysalt solutions. However, these experiments elucidated a non-linear relationship, which implies an inhibitory effect brought on by the inclusion of DDS in the mixture.

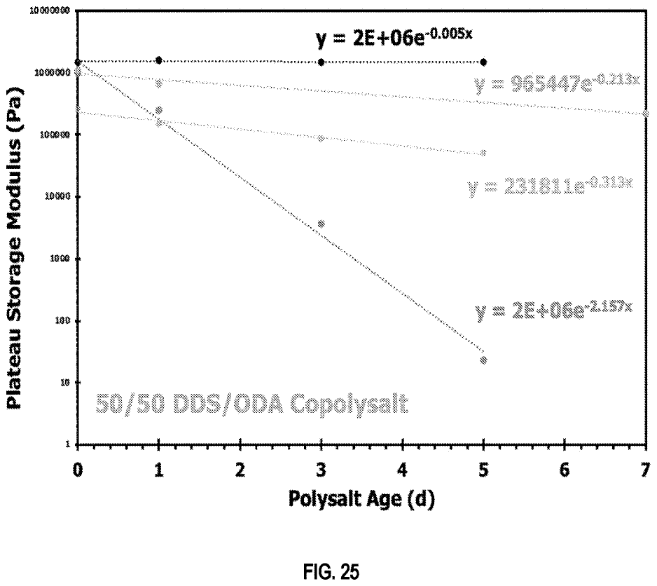

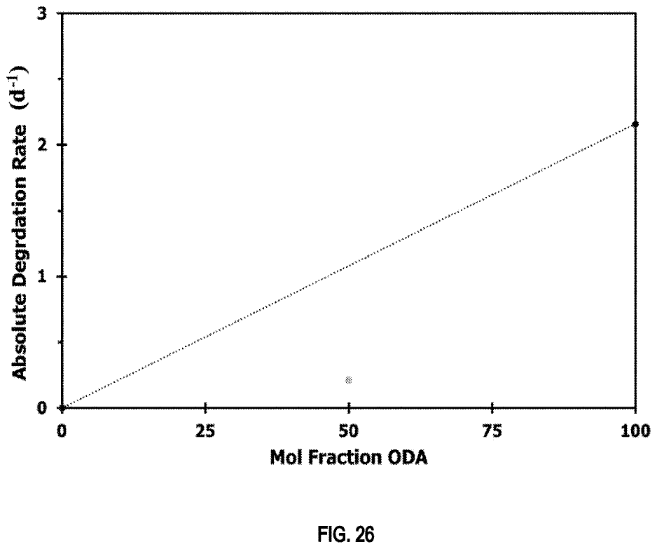

FIG. 25 further exemplifies this effect through plotting the exponential decay rate as a function of polysalt/copolysalt composition. As previously discussed, a linear relationship between plateau G′ decay as a function of ODA content was expected and displayed by a line between 100% DDS polysalt and 100% ODA polysalt solutions. However, the 50/50 DDS/ODA copolysalt solutions fell well below the anticipated rate, which should have been near −1 d⁻¹, but was instead measured at −0.213 d⁻¹, ⅕^{th} the expected value.

Copolysalts display unexpected degradation rates and thus, provide an avenue towards printable PIs with chemical compositions more closely mirroring legacy PMDA-ODA materials with wider processing windows than ODA polysalt solutions. Essentially, the simplicity of compositional variance offered by the polysalt platform enables fine tuning of material properties and 3D printing processing windows. However, it is important to note that all polysalt solution studied thus far comprised of ODA all display temporal instability and must be synthesized just before analysis. This is most easily accomplished by using a two-part method with ODA dissolved separately than the PMDA-HEA and the two solutions mixed just before use.

### Example 4

### Sulfone Containing Diammonium-Dicarboxylate Supramolecular Salts for Additive Manufacturing

Fully aromatic polyimides exhibit some of the most impressive thermomechanical properties of any polymeric materials available. However, their rigid structure and high intermolecular interactions make processing difficult and limit these materials primarily to 2D form factors, such as films and tapes. Academic works have aimed to provide photocurable polyimide precursors, which would allow for additive manufacturing of 3D polyimide shapes. This invention yields the first temporally stable, polysalt resin for the facile additive manufacturing of polyimide parts. Earlier polysalts exhibited instability thus limiting their utility. The discovery of diamines with appropriate basicity and nucleophilicity resulted in unexpected polysalt stability, providing predictive printing and shelf life.

### Introduction

Polyimides can find use in the aerospace, automotive, and microelectronic industries. Fully aromatic polyimides are comprised of rigid repeating units, which provide strong intermolecular interactions, imparting exceptional thermomechanical properties. These materials exhibit glass transition temperatures exceeding 250 °C, high thermal stability (>500 °C in inert atmosphere), and resistance to common organic solvents. However, the same structure derived properties also inhibit industrial processing as fully aromatic polyimides are often insoluble and lack the viscous flow required for typical melt processing methods. Processing limitations commonly restrict all-aromatic polyimides to 2-dimensional form factors, such as films and tapes. There exist limited examples of 3-dimensional fully-aromatic polyimides, but with extremely limited complexity and energy intensive processing requirements, such as high pressures (>10,000 psi) and extended exposure at >400 °C. These materials provide access to 3-dimensional structures with well-defined complex parts through advanced manufacturing techniques. Vat photopolymerization of photoactive polyimide precursors and subsequent facile thermal post-processing provides fully-aromatic polyimides in complex shapes, which exhibit thermomechanical properties that rival those of conventional 2-dimensional polyimides. This invention provides 3D polyimide objects for emerging electronic, automotive, and aerospace technologies.

### Non-Limiting, Exemplary Improvements of the Disclosure

The previous generation (Arrington et al., ACS Appl. Mater. Interfaces 2021, 13, 40, 48061-48070, DOI: 10.1021/acsami.1c13493) exhibits unstable solution properties and is only usable for a short period (<2 days). This invention utilizes chemistry principles to circumvent the degradation mechanism of the previous generation. The structural change provides a photoactive, 3D printable polyimide precursor resin, which exhibits long-term stability. Shelf-life is an important aspect for any commercializable vat photopolymerization resin. The advantages over the previous material is described herein. Dupont manufactures 3D polyimide materials (Vespel), but these are only used for CNC or milling processing to provide fairly simple parts. Additionally, the thermomechanical properties of Vespel are considerably lower than that of the native material. Our invention provides access to more complex geometries through additive manufacturing and thermomechanical properties characteristic of the material. In addition, the polysalt approach provides excellent shelf-life, predictive printing of complex 3D objects with micron-scale resolution, and the highest properties of any 3D polyimide objects.

### Non-Limiting, Exemplary Applications of the Disclosure

This material can be synthesized, bottled, and stored for extended periods of time while producing parts with specific properties. Consumers can take this material and print extremely complex parts with micron-scale resolution using both commercial and custom-built 3D printers. This has implications for material light weighting applications, prototyping, and reduction of manufacturing costs for complex parts already in use. This invention provides unmatched solution stability, solid content, and thermomechanical properties.

### Non-Limiting, Exemplary Disclosure Summary

The properties of fully aromatic polyimides cause it to be too viscous and insoluble for traditional industrial processing and limit them to 2D form factors. The disclosed technology is a temporally stable, polysalt resin that facilitates the additive manufacturing of 3D polyimide shapes/parts. Lack of degradation ensures that printed parts retain their intended chemical structure and allows for thermal post-processing to the polyimide. These qualities allow for the resin's use in vat photopolymerization. This allows for predictive and complex 3D printing and shelf life for commercializability.

### Non-Limiting, Exemplary Surprising Features of the Disclosure

A polysalt (PMDA-HEA/DDS) with a sulfone containing monomer was prepared to overcome instability of previous polysalt resins
Polysalt stability was established from the discovery of diamines with the correct basicity and nucleophilicity to allow for the stability of the polysalt.
Amine nucleophilicity was controlled, preventing the degradation of the polysalt via the Aza-Michael addition.
Long-term shelf life
Allows predictable printing of complex 3D parts
Micron scale printing resolution
High thermomechanical properties
Useable in standard industry processing methods such a vat photopolymerization

Aspects of the invention are drawn towards 3D prints with high fidelity, displaying constant viscosity, and constant storage modulus of the resin described herein over time.

### Example 5

### Non-Limiting Examples of Mixed Polysalts and Materials Thereof

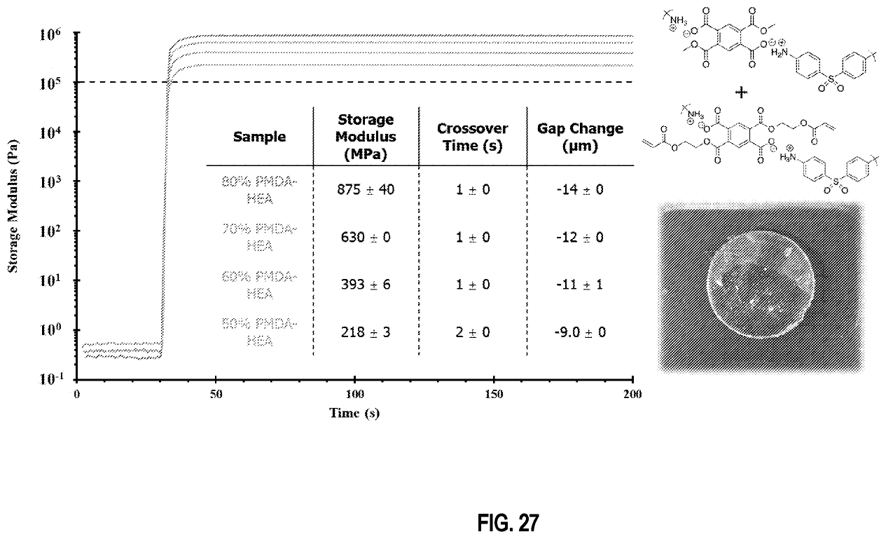

The reduced scaffold polysalt solutions maintain excellent photocuring (FIG. 27).
Substitution of PMDA-HEA w/PMDA-MeOH reduces plateau G′
Fast crossover maintained through scaffold reduction
Lower acrylate concentration provides minimal shrinkage

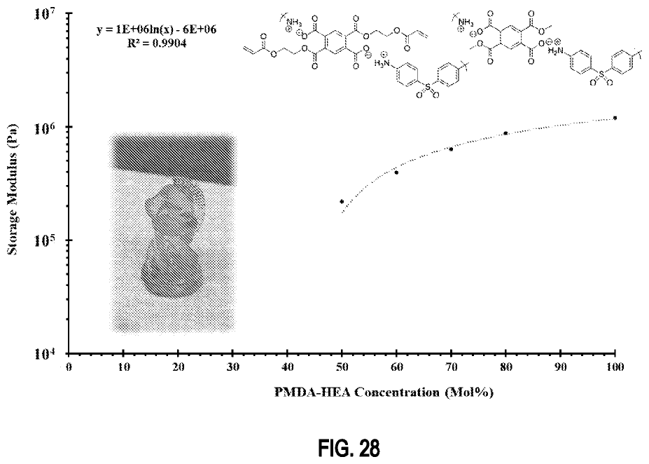

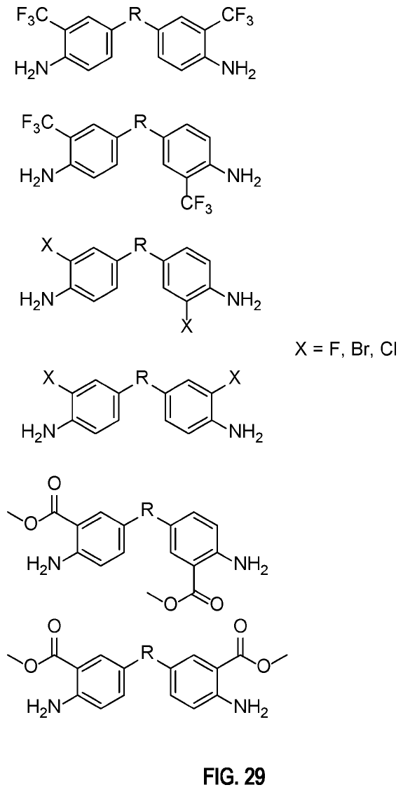

Decrease of acrylic scaffold provides predictable decline of achieved plateau storage modulus (FIG. 28)
All PMDA-HEA concentrations ≥50 mol. % exhibit printability
Storage modulus vs. PMDA-HEA concentration fits well to logarithmic equation
Estimated lower PMDA-HEA concentration limit at 45 mol. % for G′>10⁵ Pa

### In-Situ FTIR Confirms Temporal Stability of Mixed Polysalt Solutions

Reduced acrylate concentration in mixed polysalt solutions decreases FTIR signal/noise ratio

### Non-Limiting, Exemplary Advantages of Mixed Polysalts of the Disclosure

Reduced acrylate concentration will increase printed part toughness
Less scaffold to remove during thermal treatment
Less scaffold char will increase ordered carbon content upon carbonization
Less scaffold leads to less disruption of polyimide charge transfer complexes
More intermolecular interactions will increase printed part mechanical performance.

### Example 6

### Non-limiting, Printing and Post-Processing Examples

### Non-Limiting Printing Examples

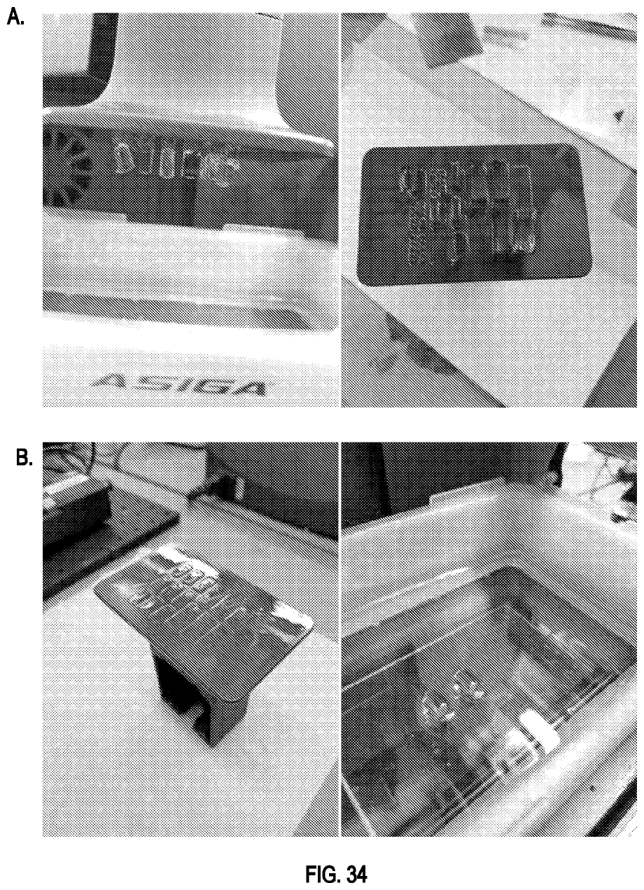

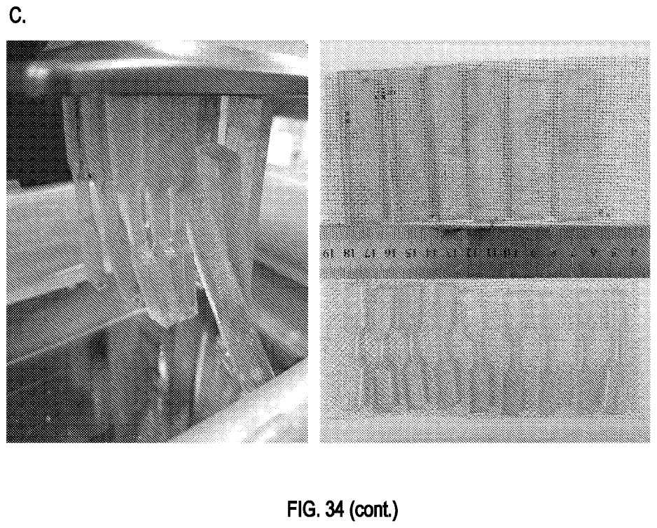

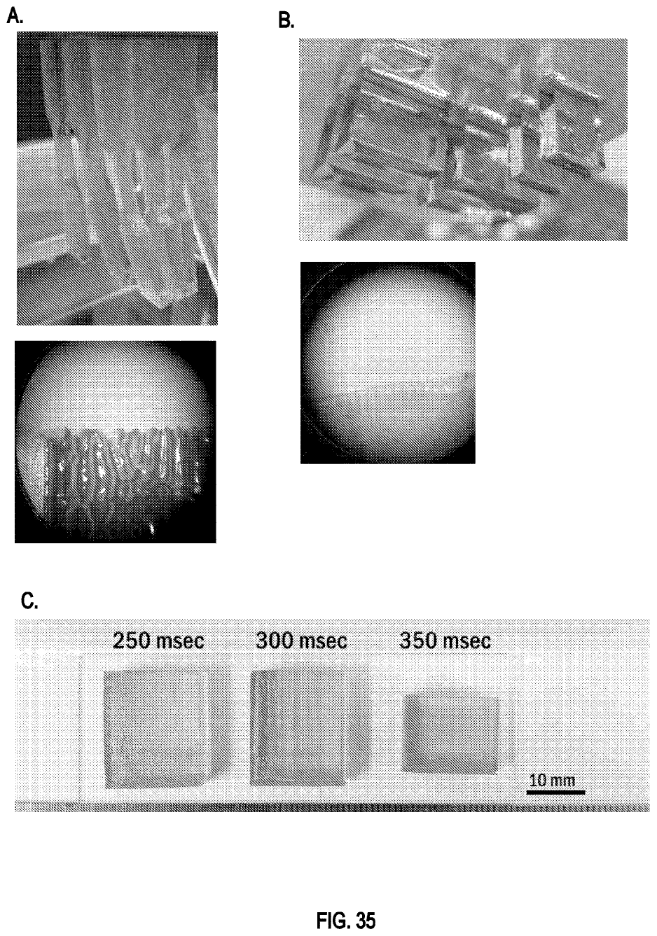

Printing efficiently in bottom-up VP for mechanical testing
Print consists of 9 D638 type V tensile bars and 6-50 mm gap DMA HDT samples
60 mL of resin and 5.5 hour print time
Support breakage can lead to print failure for polysalt parts
Asiga Max X 385, PMDA DDS PS 40 wt % in NMP (FIG. 34 Panel A with 0.5 mm raft with 2 mm supports; Panel B with No supports, parts printed directly on build plate):
40 wt % PMDA DDS in NMP
16 sec burn in (1 layer)
250 msec exposure
21 mW/cm² (100%)
0.156 mm/sec retract
1 mm/sec approach
3 mm separation distance
High burn-in can reduce interlayer adhesion leading to print failure in PS parts
Asiga Max X 385, PMDA DDS PS 40 wt % in NMP
40 wt % PMDA DDS in NMP: No supports, parts printed directly on build plate (FIG. 34 Panel C):
16 sec burn in (1 layer)->1 sec burn in
250 msec exposure
21 mW/cm² (100%)
0.156 mm/sec retract
1 mm/sec approach
3 mm separation distance
Asiga Max X 385, PMDA DDS PS 40 wt % in NMP
can do both top-down and bottom-up printing
Tuning exposure time can improve surface finish in polysalt parts
Asiga Max X 385, PMDA DDS PS 40 wt % in NMP (No supports, printed directly on part):
40 wt % PMDA DDS in NMP
1 sec burn in
21 mW/cm² (100%)
0.156 mm/sec retract
1 mm/sec approach
3 mm separation distance
250 msec exposure (FIG. 35 Panel A), 350 msec exposure (FIG. 35 Panel B), 250 vs. 300 vs. 350 msec (FIG. 35 Panel C)

### Non-Limiting Post-Processing Examples

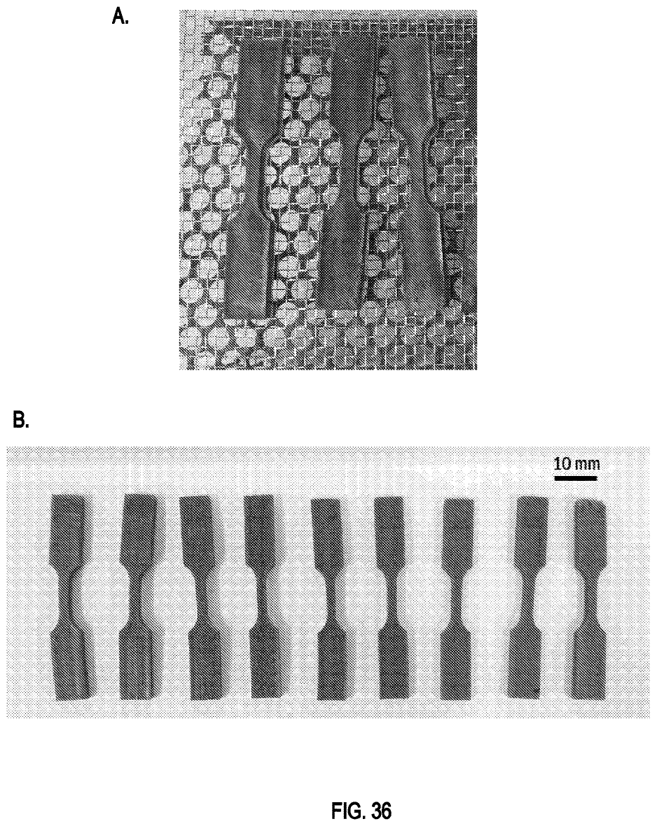

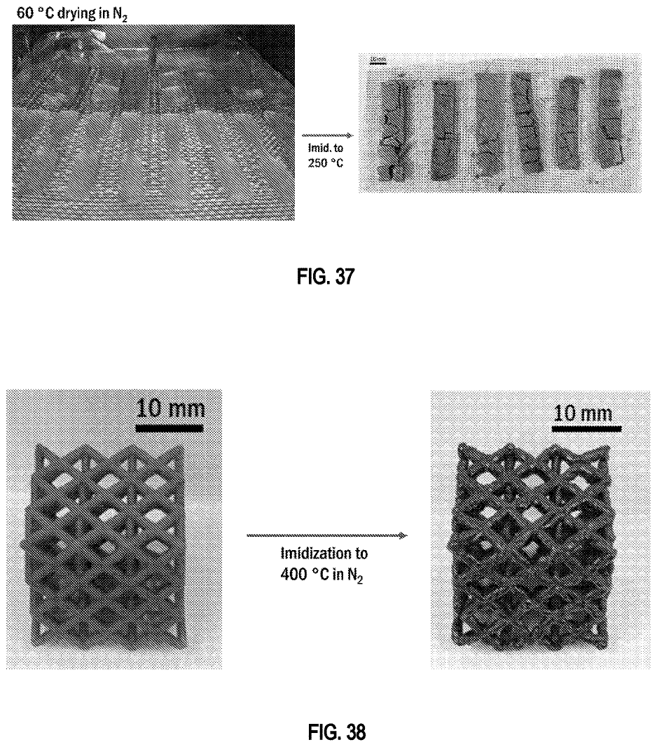

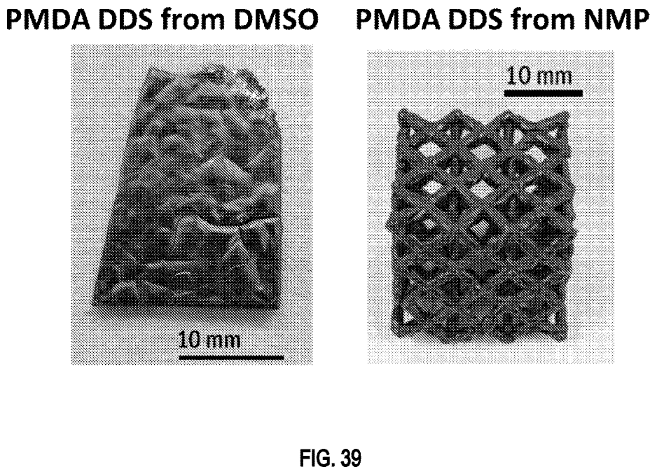

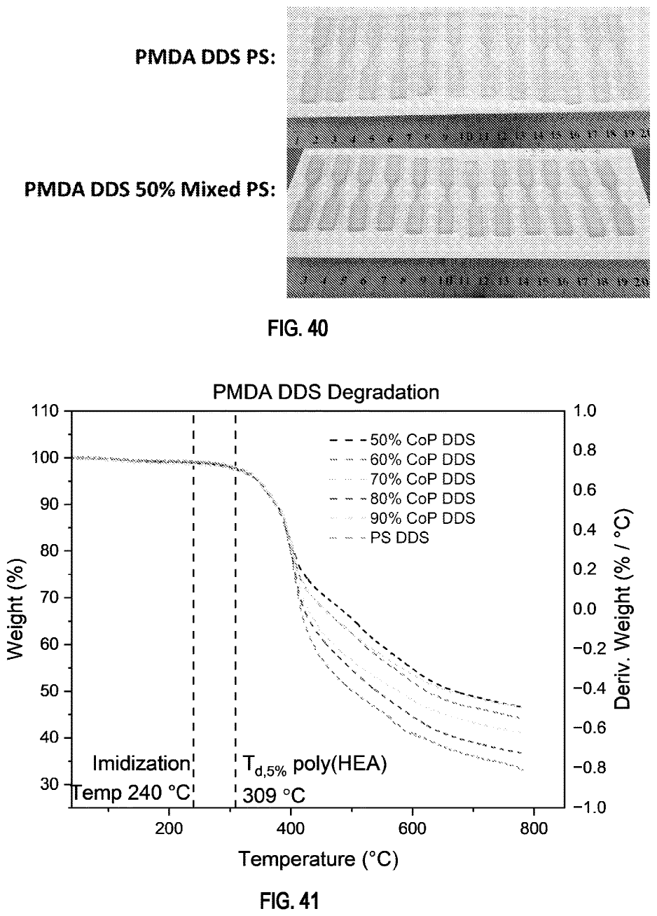

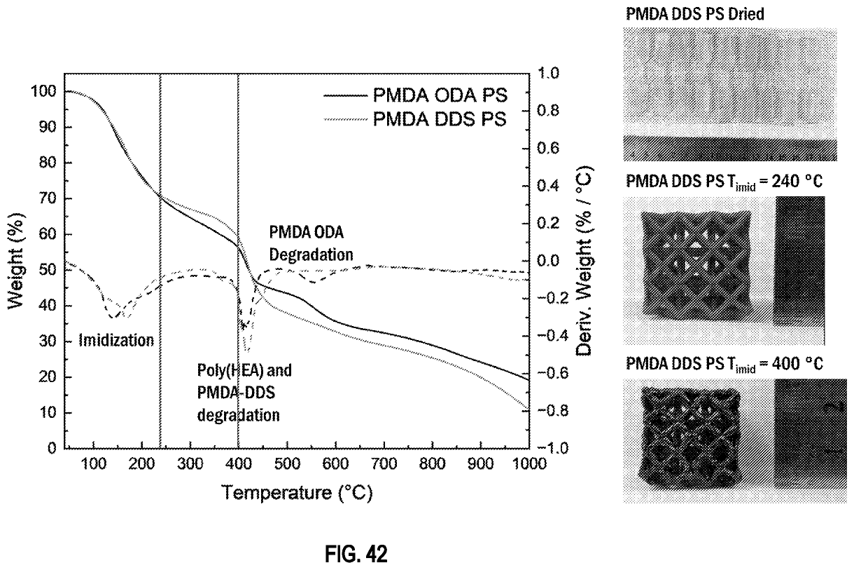

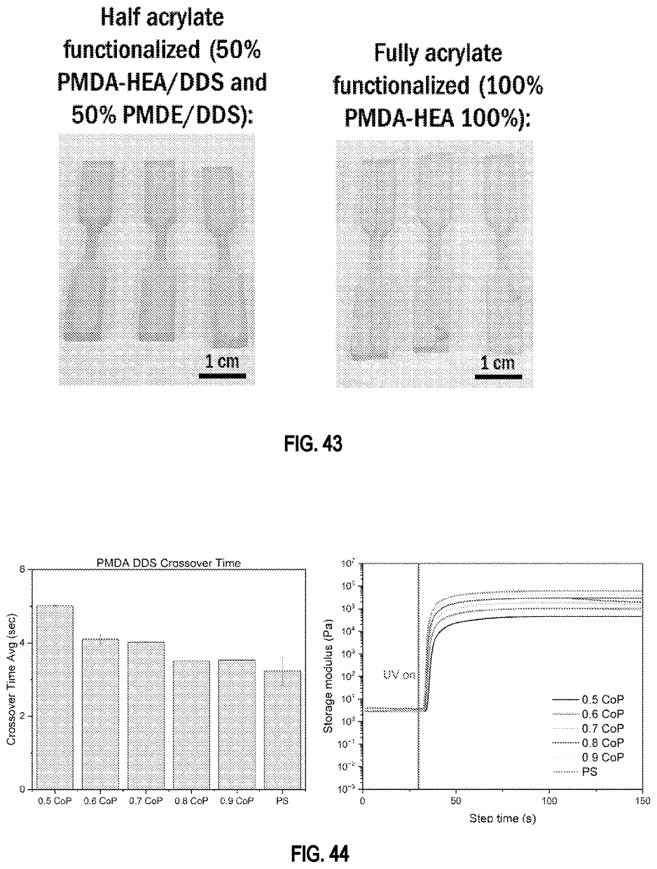

Drying under N₂ at elevated temp expedites drying and can limit oxidation
Asiga Max X 385, PMDA DDS PS 40 wt % in NMP:
Benchtop drying, imidized to 250 °C in N₂ (FIG. 36 Panel A)
60 °C drying in N₂, imidized to 250 °C in N₂ (FIG. 36 Panel B)
Elevated temperature drying can lead to excessive cracking in large PS parts (FIG. 37)
PMDA DDS PS parts develop significant porosity on imidization to 400 °C (FIG. 38)
NMP and DMSO based PMDA DDS PS resins degrade similarly when imidized to 400 °C (FIG. 39). Samples were imidized to 240 C under vacuum with an isothermal hold for 1 hour followed by further imidization to 400 C under N₂ with an isothermal hold for 1 hour.
50% mixed polysalt gels do not crack when dried like polysalt gels were prone to (FIG. 40)
Decreasing acrylate content can lead to higher char yield for PMDA DDS parts (FIG. 41) (Note: TGA 500, 10 °C/min; “CoP”=mixed polysalt in this example)
Trend is higher char yield with decreasing acrylate content
Non-limiting Polysalt Cure Stress and Thermal Stability (FIG. 42)
PMDA DDS Polysalt: too much cure stress to produce thick parts, begins to breakdown when imidized to 400 °C.
Reducing acrylate functionalization decreases gel stiffness and cure stress eliminating thick part cracking (FIG. 43)
Curing speed and gel stiffness are reduced with the reduction of acrylate for PMDA (FIG. 44)

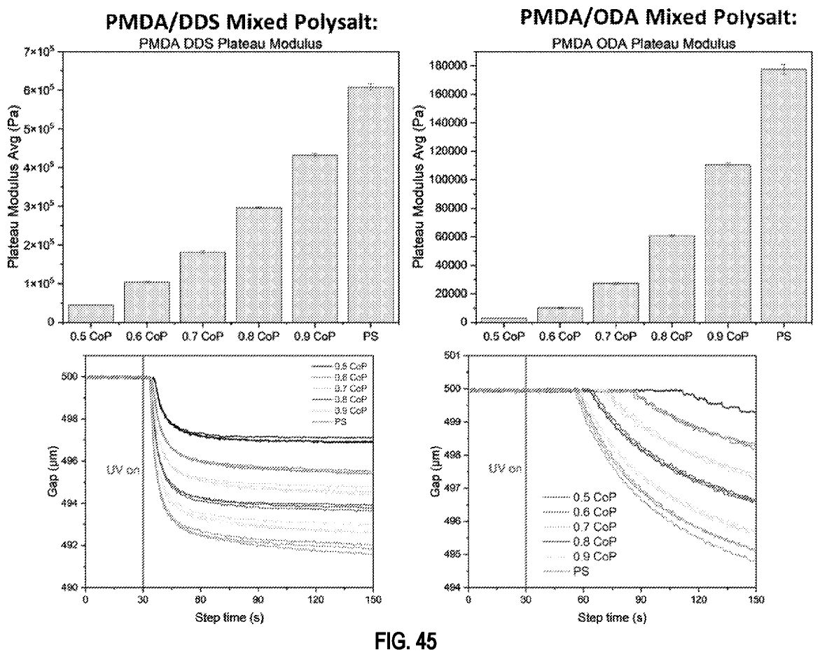

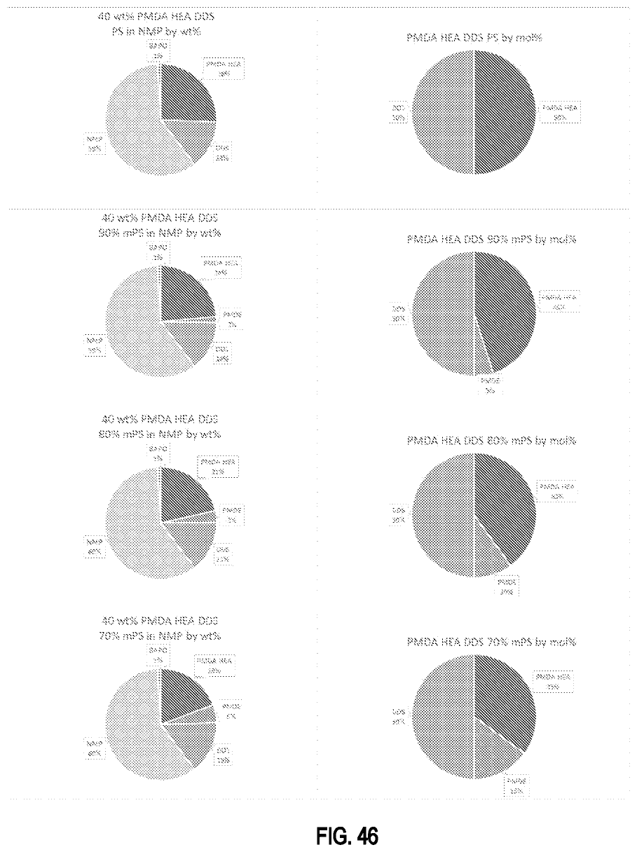

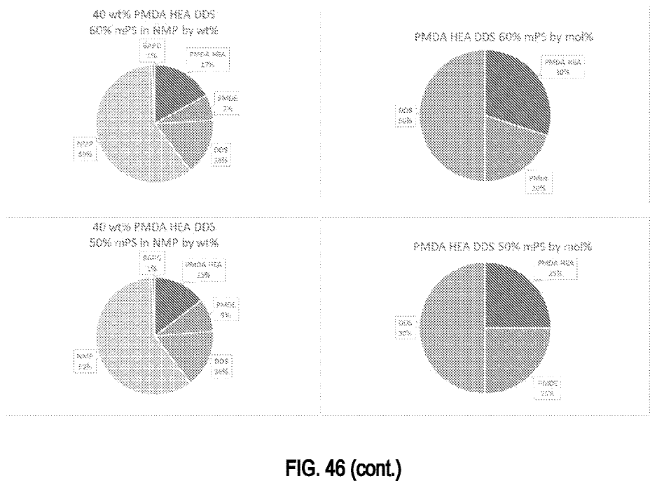

Mixed polysalts can have printable plateau modulus and cure stress (FIG. 45)
PMDA/DDS 50% Mixed Polysalt
can be printed and dried without cracking
0.6% shrinkage during curing
4.5×10⁴ Pa gel modulus

PMDA/ODA 80% Mixed Polysalt
0.68% shrinkage during during curing
6.1×10⁴ Pa gel modulus
HR30, 1 Hz, 0.1% strain, 20 mW/cm² w/400 nm filter, 500 μm gap, 40 wt % PMDA ODA mixed polysalt in NMP 2.5 wt % TPO

### EQUIVALENTS

Those skilled in the art will recognize, or be able to ascertain, using no more than routine experimentation, numerous equivalents to the specific substances and procedures described herein. Such equivalents are considered to be within the scope of this invention and are covered by the following claims.

1.-64. (canceled)

65. A polysalt selected from the group consisting of:
a polysalt comprising a dicarboxylic acid neutralized with an aromatic diamine according to Formula I: 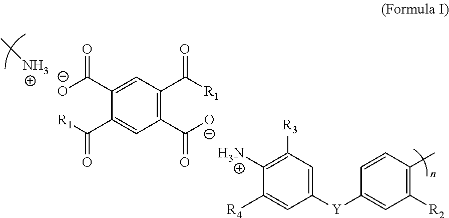
wherein, Y is an electron withdrawing group;
R₁ is an acrylate, a methacrylate, —O-alkenyl, —S-alkyl, S-alkenyl, —S-alkynyl, or —O-alkynyl;
R₂ is selected from the group consisting of H, F₃C, 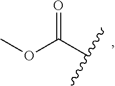 [SMILES: *C(=O)OC]
Br, F, and Cl;
R₃ is selected from the group consisting of H, F₃C, 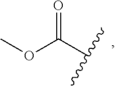 [SMILES: *C(=O)OC]
Br, F, and Cl; and
R₄ is selected from the group consisting of H, F₃C, 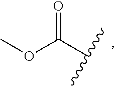 [SMILES: *C(=O)OC]
Br, F, and Cl;
a mixed polysalt comprising a dicarboxylic acid and a dicarboxylic acid-dialkyl ester neutralized with an aromatic diamine according to Formula II: 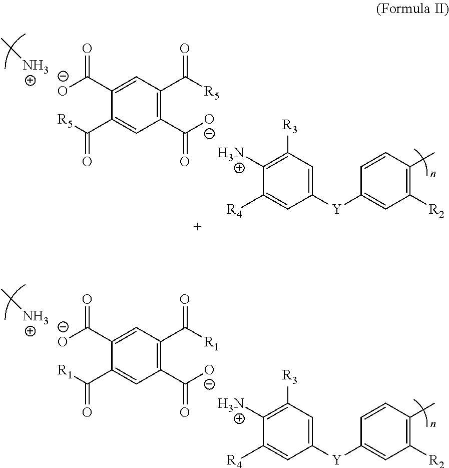
wherein, Y is an electron withdrawing group;
R₁ is an acrylate, a methacrylate, —O-alkenyl, —S-alkyl, S-alkenyl, —S-alkynyl, or —O-alkynyl;
R₂ is selected from the group consisting of H, F₃C, 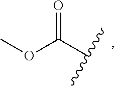 [SMILES: *C(=O)OC]
Br, F, and Cl;
R₃ is selected from the group consisting of H, F₃C, 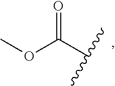 [SMILES: *C(=O)OC]
Br, F, and Cl;
R₄ is selected from the group consisting of H, F₃C, 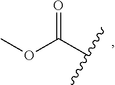 [SMILES: *C(=O)OC]
Br, F, and Cl; and
R₅ is an alkyl ester, a thioalkyl, or non-photoreactive functional group; or
a copolysalt comprising a dicarboxylic acid and at least two aromatic diamines, wherein the first aromatic diamine comprises an electron withdrawing group para to the amine and the second diamine comprises an electron donating group para to the amine according to Formula III: 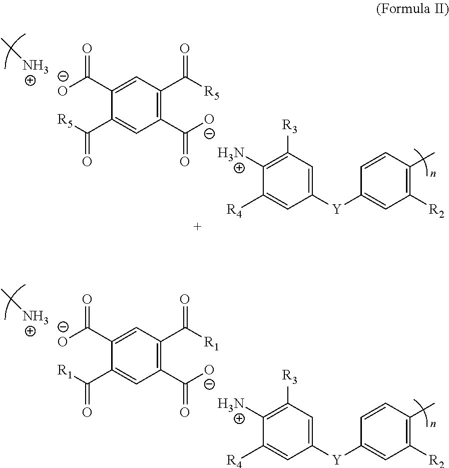
wherein, Y is an electron withdrawing group;
R₁ is an acrylate, a methacrylate, —O-alkenyl, —S-alkyl, S-alkenyl, —S-alkynyl, or —O-alkynyl;
R₂ is selected from the group consisting of H, F₃C, 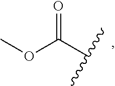 [SMILES: *C(=O)OC]
Br, F, and Cl;
R₃ is selected from the group consisting of H, F₃C, 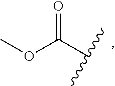 [SMILES: *C(=O)OC]
Br, F, and Cl;
R₄ is selected from the group consisting of H, F₃C, 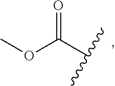 [SMILES: *C(=O)OC]
Br, F, and Cl; and
R₅ is an alkyl ester, a thioalkyl, or non-photoreactive functional group.

66. The polysalt of claim 65, wherein the polysalt is the polysalt according to Formula I wherein:
Y is SO₂, PHO, a phosphine oxide, a ketone, C(CX₃)₂, CX₂, or a nitro group;
X is Cl, F, or Br;
R₁ is 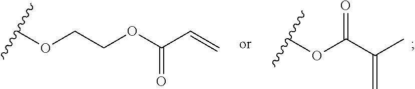
the dicarboxylic acid is 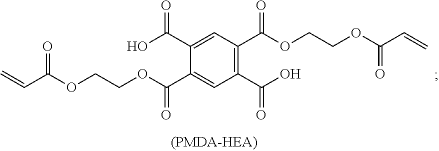 [SMILES: C=CC(=O)OCCOC(=O)c1cc(C(=O)O)c(C(=O)OCCOC(=O)C=C)cc1C(=O)O]
the aromatic diamine is 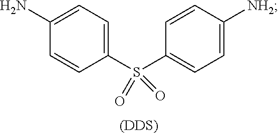
the polysalt is 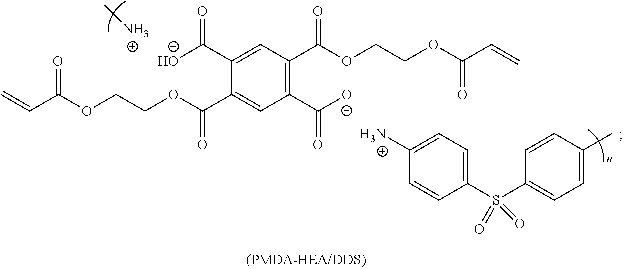
the polysalt does not undergo an acrylate-amine step-growth polymerization;
or any combination thereof.

67. The polysalt of claim 65, wherein the polysalt is the mixed polysalt according to Formula II wherein:
Y is SO₂, O, a ketone, a phosphine oxide, C(CX₃)₂, CX₂, or a nitro group, wherein X is Cl, F, or Br;
R₁ is 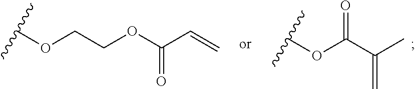
the alkyl ester is selected from the group consisting of a methyl ester, an ethyl ester, a propyl ester, or an isopropyl ester;
the dicarboxylic acid-dialkyl ester is 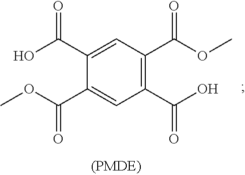
the dicarboxylic acid is 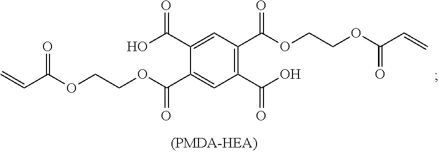 [SMILES: C=CC(=O)OCCOC(=O)c1cc(C(=O)O)c(C(=O)OCCOC(=O)C=C)cc1C(=O)O]
the aromatic diamine is 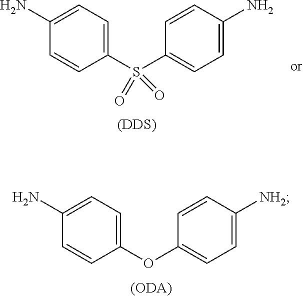
the mixed polysalt is 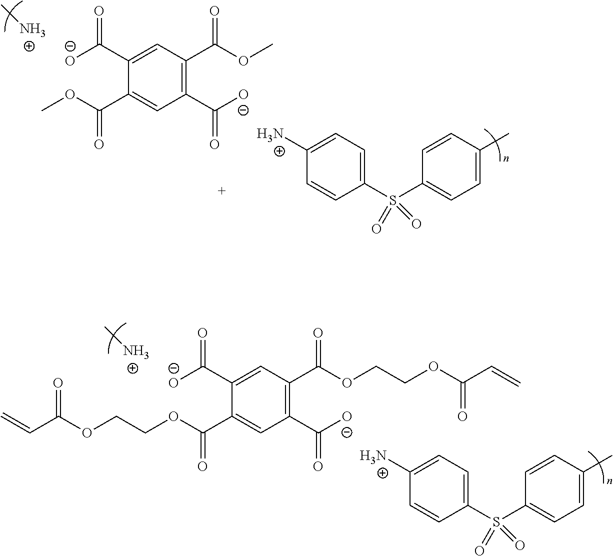
(XX % PMDA-HEA/DDS, wherein XX % comprises about 1%, about 5%, about 10%, about 20%, about 30%, about 40%, about 50%, about 60%, about 70%, about 80%, about 90%, about 95%, or about 99%);
the mixed polysalt is about 20% PMDA-HEA/DDS, about 30% PMDA-HEA/DDS, about 40% PMDA-HEA/DDS, about 50% PMDA-HEA/DDS, about 60% PMDA-HEA/DDS, about 70% PMDA-HEA/DDS, or about 80% PMDA-HEA/DDS;
the mixed polysalt is 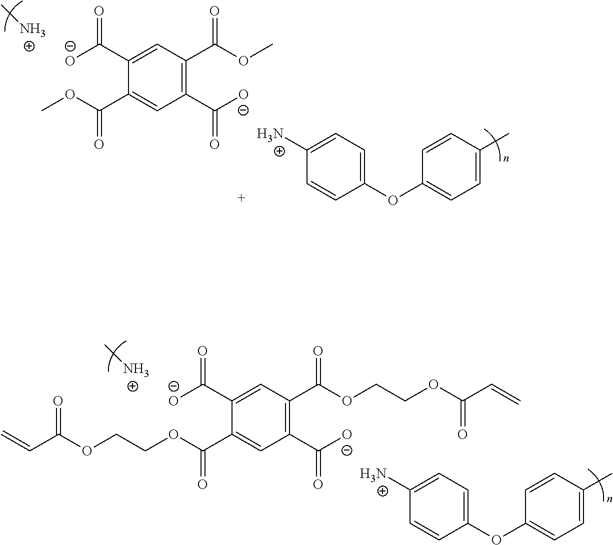
(XX % PMDA-HEA/ODA, wherein XX % comprises 1%, about 5%, about 10%, about 20%, about 30%, about 40%, about 50%, about 60%, about 70%, about 80%, about 90%, about 95%, or about 99%);
the mixed polysalt is about 20% PMDA-HEA/ODA, about 30% PMDA-HEA/ODA, about 50% PMDA-HEA/ODA, about 60% PMDA-HEA/ODA, about 70% PMDA-HEA/ODA, or about 80% PMDA-HEA/ODA;
the mixed polysalt does not undergo an acrylate-amine step-growth polymerization;
or any combination thereof.

68. The polysalt of claim 65, wherein the polysalt is the copolysalt according to Formula III wherein:
R₁ is 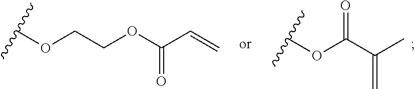
the electron withdrawing group is SO₂ or a phosphine oxide;
the electron donating group is O;
the dicarboxylic acid is 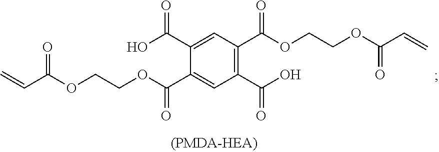 [SMILES: C=CC(=O)OCCOC(=O)c1cc(C(=O)O)c(C(=O)OCCOC(=O)C=C)cc1C(=O)O]
the aromatic diamine comprising an electron withdrawing group para to the amine is 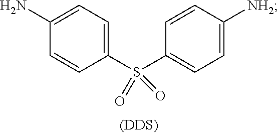
the aromatic diamine comprising an electron donating group para to the amine is 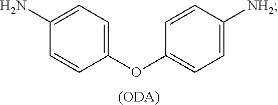
the copolysalt is 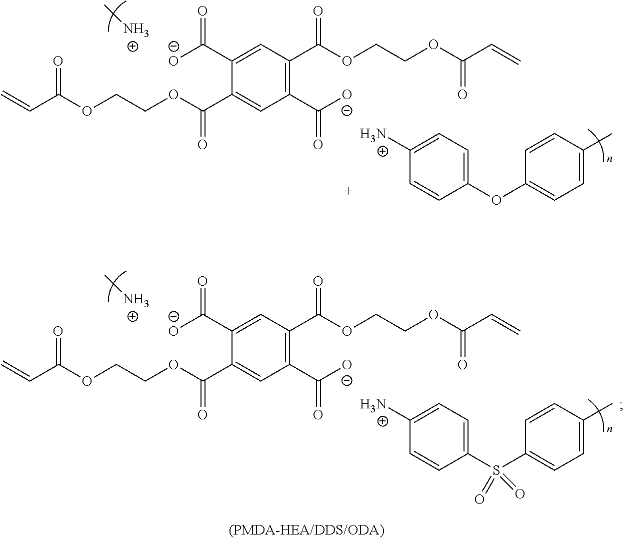
or any combination thereof.

69. A polymer resin comprising:
a photoinitiator;
a solvent; and
a polysalt selected from the group consisting of:
a polysalt comprising a dicarboxylic acid neutralized with an aromatic diamine according to Formula I: 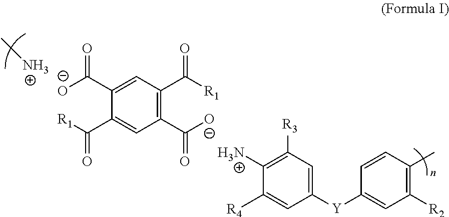
wherein, Y is an electron withdrawing group;
R₁ is an acrylate, a methacrylate, —O-alkenyl, —S-alkyl, S-alkenyl, —S-alkynyl, or —O-alkynyl;
R₂ is selected from the group consisting of H, F₃C, 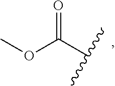 [SMILES: *C(=O)OC]
Br, F, and Cl;
R₃ is selected from the group consisting of H, F₃C, 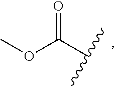 [SMILES: *C(=O)OC]
Br, F, and Cl; and
R₄ is selected from the group consisting of H, F₃C, 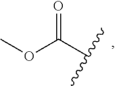 [SMILES: *C(=O)OC]
Br, F, and Cl;
a mixed polysalt comprising a dicarboxylic acid and a dicarboxylic acid-dialkyl ester neutralized with an aromatic diamine according to Formula II: 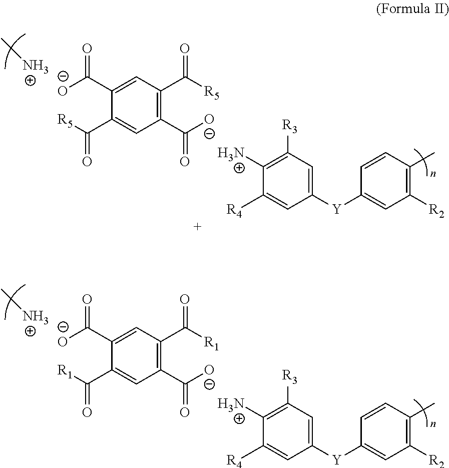
wherein, Y is an electron withdrawing group;
R₁ is an acrylate, a methacrylate, —O-alkenyl, —S-alkyl, S-alkenyl, —S-alkynyl, or —O-alkynyl;
R₂ is selected from the group consisting of H, F₃C, 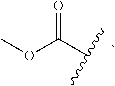 [SMILES: *C(=O)OC]
Br, F, and Cl;
R₃ is selected from the group consisting of H, F₃C, 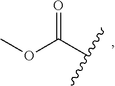 [SMILES: *C(=O)OC]
Br, F, and Cl;
R₄ is selected from the group consisting of H, F₃C, 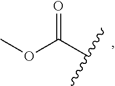 [SMILES: *C(=O)OC]
Br, F, and Cl; and
R₅ is an alkyl ester, a thioalkyl, or non-photoreactive functional group; or
a copolysalt comprising a dicarboxylic acid and at least two aromatic diamines, wherein the first aromatic diamine comprises an electron withdrawing group para to the amine and the second diamine comprises an electron donating group para to the amine according to Formula III: 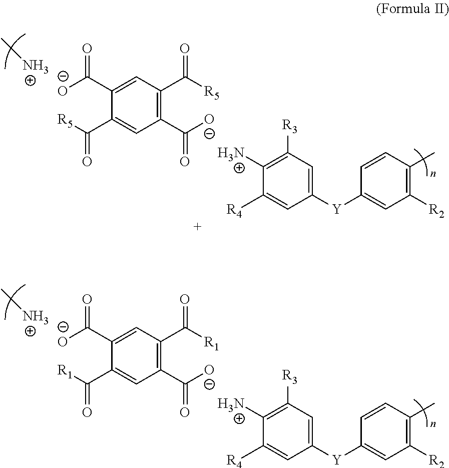
wherein, Y is an electron withdrawing group;
R₁ is an acrylate, a methacrylate, —O-alkenyl, —S-alkyl, S-alkenyl, —S-alkynyl, or —O-alkynyl;
R₂ is selected from the group consisting of H, F₃C, 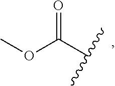 [SMILES: *C(=O)OC]
Br, F, and Cl;
R₃ is selected from the group consisting of H, F₃C, 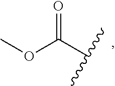 [SMILES: *C(=O)OC]
Br, F, and Cl;
R₄ is selected from the group consisting of H, F₃C, 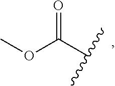 [SMILES: *C(=O)OC]
Br, F, and Cl; and
R₅ is an alkyl ester, a thioalkyl, or non-photoreactive functional group.

70. The polymer resin of claim 69, wherein the polysalt is the polysalt according to Formula I wherein:
Y is SO₂, PHO, a phosphine oxide, a ketone, C(CX₃)₂, CX₂, or a nitro group;
X is Cl, F, or Br;
R₁ is 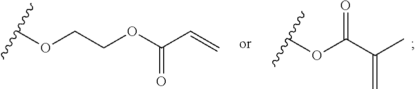
the dicarboxylic acid is 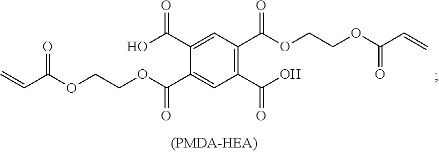 [SMILES: C=CC(=O)OCCOC(=O)c1cc(C(=O)O)c(C(=O)OCCOC(=O)C=C)cc1C(=O)O]
the aromatic diamine is 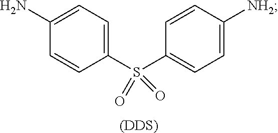
the polysalt is 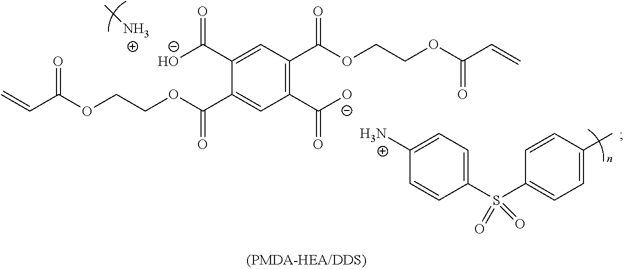
the polysalt does not undergo an acrylate-amine step-growth polymerization;
or any combination thereof.

71. The polymer resin of claim 69, wherein the polysalt is the mixed polysalt according to Formula II wherein:
Y is SO₂, O, a ketone, a phosphine oxide, C(CX₃)₂, CX₂, or a nitro group, wherein X is Cl, F, or Br;
R₁ is 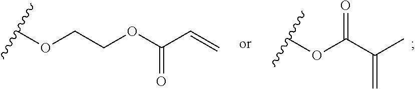
the alkyl ester is selected from the group consisting of a methyl ester, an ethyl ester, a propyl ester, or an isopropyl ester;
the dicarboxylic acid-dialkyl ester is 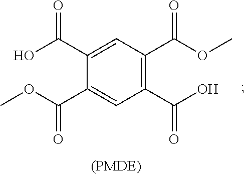
the dicarboxylic acid is 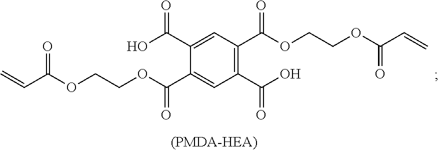 [SMILES: C=CC(=O)OCCOC(=O)c1cc(C(=O)O)c(C(=O)OCCOC(=O)C=C)cc1C(=O)O]
the aromatic diamine is 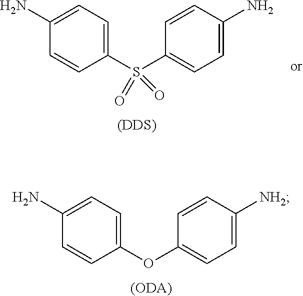
the mixed polysalt is 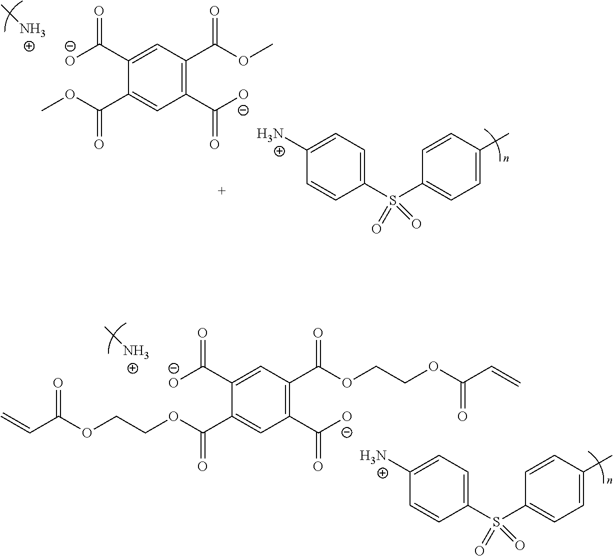
(XX % PMDA-HEA/DDS, wherein XX % comprises about 1%, about 5%, about 10%, about 20%, about 30%, about 40%, about 50%, about 60%, about 70%, about 80%, about 90%, about 95%, or about 99%);
the mixed polysalt is about 20% PMDA-HEA/DDS, about 30% PMDA-HEA/DDS, about 40% PMDA-HEA/DDS, about 50% PMDA-HEA/DDS, about 60% PMDA-HEA/DDS, about 70% PMDA-HEA/DDS, or about 80% PMDA-HEA/DDS;
the mixed polysalt is 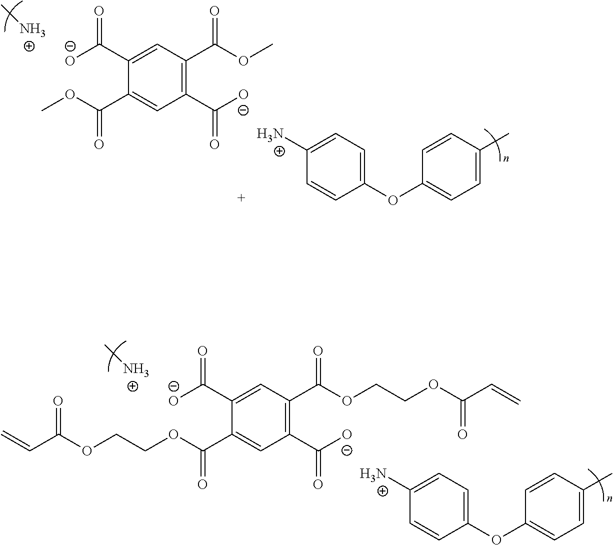
(XX % PMDA-HEA/ODA, wherein XX % comprises 1%, about 5%, about 10%, about 20%, about 30%, about 40%, about 50%, about 60%, about 70%, about 80%, about 90%, about 95%, or about 99%);
the mixed polysalt is about 20% PMDA-HEA/ODA, about 30% PMDA-HEA/ODA, about 50% PMDA-HEA/ODA, about 60% PMDA-HEA/ODA, about 70% PMDA-HEA/ODA, or about 80% PMDA-HEA/ODA;
the mixed polysalt does not undergo an acrylate-amine step-growth polymerization;
or any combination thereof.

72. The polymer resin claim 69, wherein the polysalt is the copolysalt according to Formula III wherein:
R₁ is 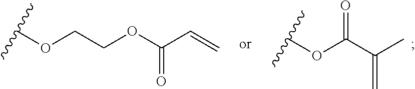
the electron withdrawing group is SO₂ or a phosphine oxide;
the electron donating group is O;
the dicarboxylic acid is 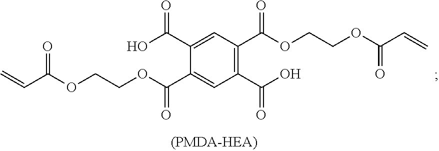 [SMILES: C=CC(=O)OCCOC(=O)c1cc(C(=O)O)c(C(=O)OCCOC(=O)C=C)cc1C(=O)O]
the aromatic diamine comprising an electron withdrawing group para to the amine is 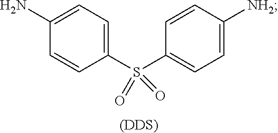
the aromatic diamine comprising an electron donating group para to the amine is 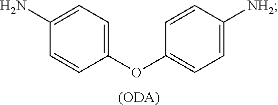
the copolysalt is 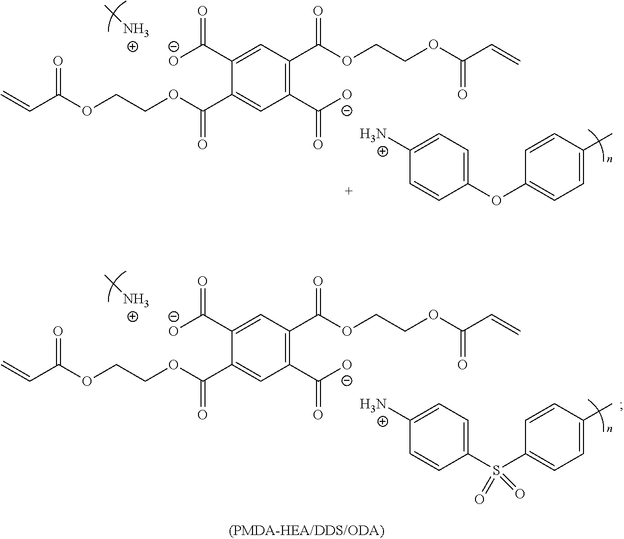
or any combination thereof.

73. The polymer resin of claim 69, wherein the photoinitiator comprises a radical photoinitiator.

74. The polymer resin of claim 73, wherein the radical photoinitiator comprises 2, 4, 6-trimethylbenzoyldiphenyl phosphine oxide (TPO) or phenylbis(2,4,6-trimethylbenzyol)-phosphine oxide (BAPO).

75. The polymer resin of claim 69, wherein the polysalt, the mixed polysalt, or the copolysalt is present in an amount of about 10 weight % to about 80 weight %.

76. The polymer resin of claim 69, wherein the photoinitiator is present in an amount from about 0.5% to about 5% by weight based upon the total weight of the polymer resin.

77. The polymer resin of claim 69, wherein the solvent comprises a polar aprotic solvent.

78. The polymer resin of claim 77, wherein the polar aprotic solvent comprises dimethyl sulfoxide, dimethylformamide, dimethylacetamide, N-methyl-2-pyrrolidone, or a combination thereof.

79. The polymer resin of claim 69, wherein the polysalt is 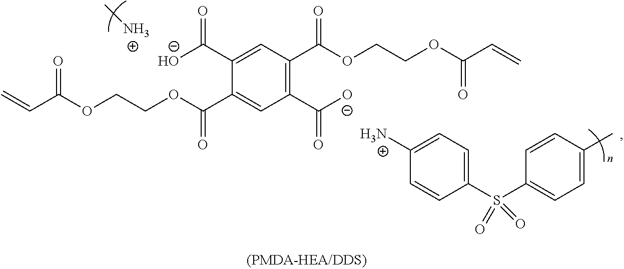
and wherein the polymer resin achieves a plateau storage modulus over about G′=1×10⁶ Pa at about 21 °C for at least 120 hours.

80. The polymer resin of claim 69, wherein the mixed polysalt is 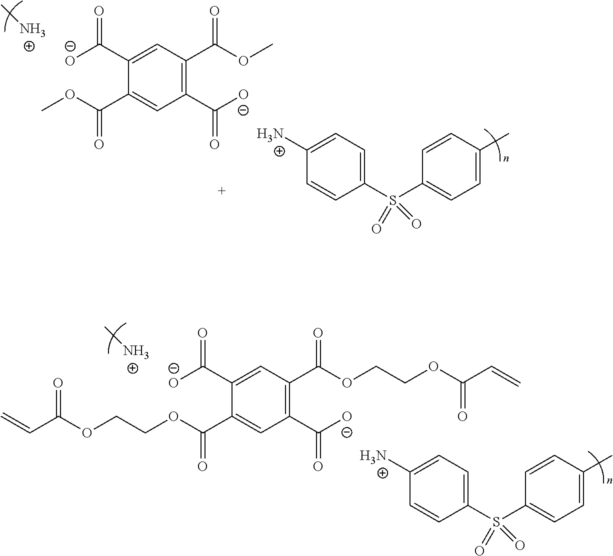
(XX % PMDA-HEA/DDS, wherein XX % is about 10%, about 20%, about 30% about 40%, about 50%, about 60%, about 70%, about 80%, about 90%, or about 99%); or 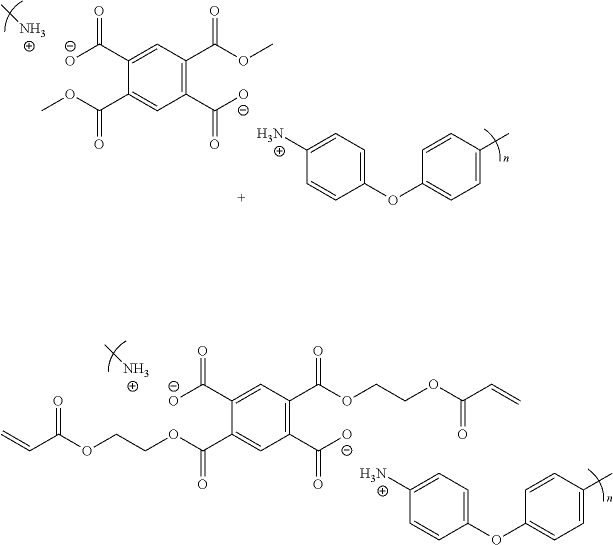
(XX % PMDA-HEA/ODA, wherein XX % is about 10%, about 20%, about 30% about 40%, about 50%, about 60%, about 70%, about 80%, about 90%, or about 99%).

81. The polymer resin of claim 69, wherein the copolysalt comprises

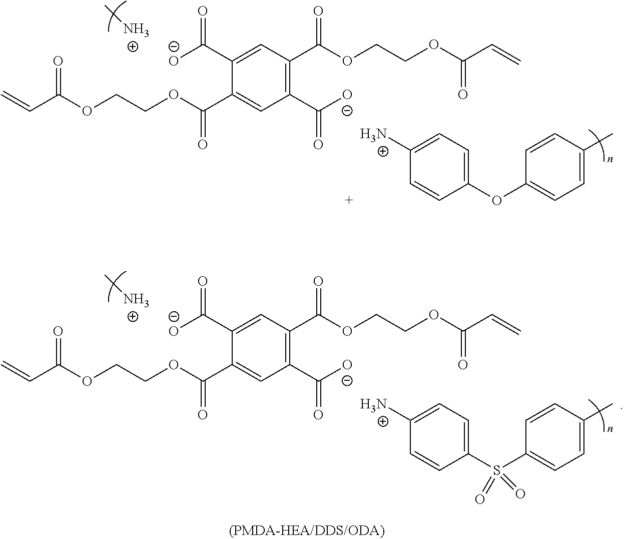

82. The polymer resin of claim 81, wherein the copolysalt is PMDA-HEA/50DDS/50ODA.

83. The polymer resin of claim 69, wherein the resin comprises about 60 wt. % solids and maintains a solution viscosity of <10 Pa·s.

84. A method of manufacturing a fully aromatic polyimide material, the method comprising:
mixing a polymer resin of claim 69;
printing the polymer resin to produce a polymer material; and
subjecting the polymer material to post-processing to produce a fully aromatic polyimide material.
